(19) United States
(12) Patent Application Publication
(10) Pub. No.: US 2008/0255280 A1
(43) Pub. Date: Oct. 16, 2008

(54) Oxygen-scavenging polymer blends suitable for use in packaging

(76) Inventors: Susan Sims, Kingsport, TN (US); Mark Edward Stewart, Kingsport, TN (US); Jason Christopher Jenkins, Kingsport, TN (US); Rodney Scott Armentrout, Kingsport, TN (US); Richard Dalton Peters, Kingsport, TN (US); Michael Duane Cliffton, Kingsport, TN (US); Frederick Leslie Colhoun, Kingsport, TN (US); Stephen Weinhold, Kingsport, TN (US)

Correspondence Address: MICHAEL K. CARRIER, EASTMAN CHEMICAL COMPANY, 100 NORTH EASTMAN ROAD, KINGSPORT, TN, 37660-5075, US

(21) Appl. No.: 11/786,395

(22) Filed: Apr. 11, 2007

(51) Int. Cl. C08K 3/08; C07F 7/00

(52) U.S. Cl. 524/176; 524/174; 524/413; 524/414; 524/437; 524/440

(57) ABSTRACT

Polymer blends suitable for packaging are disclosed that include a transition metal; one or more polyamide homopolymers or copolymers; and one or more polyethylene terephthalate homopolymers or copolymers obtained by a melt phase polymerization using a catalyst system comprising aluminum atoms in an amount, for example, from about 3 ppm to about 60 ppm and one or more alkaline earth metal atoms, alkali metal atoms, or alkali compound residues in an amount, for example, from about 1 ppm to about 25 ppm, in each case based on the weight of the one or more polyethylene terephthalate homopolymers or copolymers The polymer blends disclosed exhibit improved oxygen-scavenging activity compared with blends made using polymers prepared with conventional catalyst systems.

### FIELD OF THE INVENTION

The invention relates generally to polymer blends, and in particular, to polymer blends having oxygen-scavenging properties making them suitable for use in the packaging of oxygen-sensitive products.

### BACKGROUND OF THE INVENTION

Certain foods, beverages, and other packaged goods—such as beer and fruit juices, certain cosmetics and medicines, and the like—are sensitive to oxygen exposure, and require packages having high oxygen barrier to preserve the freshness of the contents and avoid changes in flavor, texture, or color. For many applications, the oxygen barrier properties of conventional PET homopolymers and copolymers are satisfactory. However, for very oxygen-sensitive products, the oxygen barrier properties of such polymers do not provide adequate protection for the product.

A variety of approaches have been used to enhance the passive barrier properties of PET, including blends with high barrier polymers or additives that decrease the permeability of the resin, incorporation of impermeable fillers, the use of coated or multilayer structures, and copolymerization with comonomers that produce a lower permeability polymer than unmodified PET.

To further reduce the entry of oxygen into the contents of the package, oxygen-scavenging technologies have been developed for PET packages. These may include oxidizable moieties, such as polyamides, polydienes, or polyethers, blended or reacted into PET. Typically, small amounts of transition metal salts, such as cobalt salts of organic acids, are also incorporated to catalyze and actively promote the oxidation of the oxidizable moiety. The use of such active oxygen scavengers, which chemically remove oxygen migrating through the walls of the package, can be a very effective method to reduce the oxygen transmission rates of plastics used in packaging.

U.S. Pat. No. 5,211,875 discloses a method of initiating oxygen scavenging by compositions that contain oxidizable organic compounds and transition metal catalysts. The method comprises initiating scavenging by exposing the composition to radiation. The method can be used for initiating scavenging in packaging layers or articles for oxygen sensitive products such as foods and beverages.

U.S. Pat. No. 6,083,585 discloses compositions for scavenging oxygen that comprise condensation copolymers comprising predominantly polyester segments and an oxygen-scavenging amount of polyolefin oligomer segments. The polyester segments comprise segments derived from typical bottling and packaging polyesters such as PET and PEN. The copolymers are preferably formed by transesterification during reactive extrusion and typically comprise about 0.5 to about 12 wt % of polyolefin oligomer segments. Use of these oxygen-scavenging compositions in bottles is said to provide a clear and rigid bottle similar in appearance to unmodified polyester bottles.

U.S. Pat. Nos. 5,021,515 and 5,955,527 disclose a wall for a package which comprises a polymer, and which is capable of scavenging oxygen through the metal-catalyzed oxidation of an oxidizable organic component. The oxidizable organic component may itself be a polymer, and preferred compositions are said to include a blend of 96% polyethylene terephthalate and 4% poly(m-xylyleneadipamide) containing 200 ppm cobalt as catalyst.

U.S. Pat. No. 6,544,611 discloses an oxygen-scavenging PET-based copolymer comprising from about 10 to about 120 ppm cobalt based on the PET polymer, and from about 15 to about 150 ppm zinc based on the PET polymer.

U.S. Pat. Appln. Publn. No. 20050222345 discloses a polyester composition obtained by blending a partially aromatic polyamide with a thermoplastic polyester. The polyester composition contains an alkali metal atom in an amount of 0.1 to 300 ppm and phosphorus atoms in an amount of 5 to 200 ppm. The preferred partially aromatic polyamide is a m-xylylene group-containing polyamide.

U.S. Pat. Appln. Publn. No. 20060148957, filed Dec. 5, 2005, discloses a method for forming an article by combining a polyester polymer and an oxygen-scavenging composition comprising a polyamide in the presence of zinc and cobalt in a melt processing zone to form a melt; and forming an article such as a sheet or preform from the melt. Also provided are molten formulated polyester polymer compositions containing a blend of a polyethylene terephthalate polymer and a polyamide polymer along with zinc and cobalt.

WO 2006138636 discloses compositions capable of scavenging oxygen which contain poly(ethylene terephthalate) base polymer and a nylon polymer. The compositions are formulated to provide improved clarity.

U.S. patent application Ser. No. 11/495,431 filed Jul. 28, 2006 and having common assignee herewith, discloses polyester compositions that include aluminum atoms in an amount of at least 3 ppm, based on the weight of the polymer, and that further include alkaline earth metal atoms or alkali metal atoms or alkali compound residues, the polymers having an lt.V. of at least 0.72 dL/g obtained through a melt phase polymerization.

U.S. patent application Ser. No. 11/229,238, filed Sep. 16, 2005 and having common assignee herewith, discloses polyester compositions comprising polyester polymers, aluminum atoms, alkaline earth atoms or alkali metal atoms or alkali compound residues, and particles that improve the reheat rate of the compositions.

While polyester/polyamide blends such as those described are effective oxygen scavengers, we have found that performance may vary significantly depending upon the nature of the polyester and the polyamide.

There remains a need in the art for polymer blends, suitable for use in packaging, that upon blending retain significant oxygen-scavenging properties while maintaining the properties that make the blends suitable for use in the packaging of oxygen-sensitive products, including transparency, miscibility, rigidity, good barrier properties, recyclability, and reasonable cost.

### SUMMARY OF THE INVENTION

In one aspect, the invention relates to polymer blends having oxygen-scavenging effect, that include one or more polyamide homopolymers or copolymers, and especially those having for example, at least 50 mole percent monomers containing a benzylic hydrogen, based on the total amount of amine residues in the one or more polyamide homopolymer or copolymers comprising 100 mole percent; and one or more polyethylene terephthalate homopolymers or copolymers having an lt.V. of, for example, at least 0.65 dL/g and obtained through a melt phase polymerization, using a catalyst system that includes aluminum atoms in an amount, for example, from about 3 ppm to about 60 ppm, and one or more alkaline earth metal atoms, alkali metal atoms, or alkali compound residues in an amount, for example, from about 1 ppm to about 25 ppm; and further comprising one or more transition metals in an amount, for example, from about 10 ppm to about 1,000 ppm, in each case based on the weight of the one or more polyethylene terephthalate homopolymers or copolymers.

In another aspect, the invention relates to polymer blends comprising one or more polyamide homopolymers or copolymers present in an amount, for example, from about 0.02 weight percent to about 10 weight percent, or from 0.20 to 10 weight percent, or from 0.5 to 5 weight percent, or from 1 to 3 weight percent, in each case based on the total weight of the polymer blend.

In yet another aspect, the one or more polyamide homopolymers or copolymers may comprise, for example, at least 80 percent amide linkages, or at least 90 percent amide linkages, or at least 95 percent amide linkages, in each case based on the total number of condensation linkages of the one or more polyamide homopolymers or copolymers comprising 100 percent, and may further comprise, for example, at least 60 mole percent amine residues having a benzylic hydrogen group, based on the total amount of amine residues comprising 100 mole percent.

In another aspect, the one or more polyamide homopolymers or copolymers may comprise, for example, repeating units of m-xylylene residues, in an amount, for example, of at least 60 mole percent, or at least 75 mole percent, or at least 90 mole percent, or at least 95 mole percent, in each case based on the total moles of amine residues in the one or more polyamide homopolymers or copolymers comprising 100 mole percent.

In still another aspect, the one or more polyamide homopolymers or copolymers may comprise, for example, repeating units of m-xylylene adipamide, in an amount, for example, of at least 60 mole percent, or at least 85 mole percent, or at least 96 mole percent, or at least 100 mole percent, in each case based on the total moles of acid/amine units in the one or more polyamide homopolymers or copolymers comprising 100 mole percent.

In another aspect, the one or more polyamide homopolymers or copolymers may be provided as a polyamide concentrate, in which the polyamide is present in an amount, for example, from about 1 weight percent to about 25 weight percent, based on the total weight of the concentrate.

In another aspect, the one or more polyamide homopolymers or copolymers may have an Mn, for example, from about 200 to about 25,000, or from 2,500 to 12,000, or from 2,500 to 7,000.

In another aspect, the one or more transition metals may be present, for example, in an amount from about 10 ppm to about 1,000 ppm metal, or from 20 ppm to 750 ppm, or from 25 ppm to 500 ppm, in each case based on the total weight of the polymer blend. The one or more transition metals may comprise one or more transition metal salts, for example, and/or may be provided in one or more of the following oxidation states: manganese II or III, iron II or III, cobalt II or III, nickel II or III, copper I or II, rhodium II, III or IV, or ruthenium I, II or IV.

In another aspect, the one or more transition metals may be provided as a salt of one or more of a chloride, an acetate, an acetylacetonate, an octoate, a stearate, a palmitate, a 2-ethylhexanoate, a neodecanoate, or a naphthenate.

In another aspect, the one or more transition metals may be present, for example, in an amount from about 10 ppm to about 1,000 ppm metal, or from 20 ppm to 750 ppm, or from 25 ppm to 500 ppm, in each case based on the total weight of the polymer blend. The one or more transition metals may comprise one or more transition metal salts, for example, and/or may be provided in one or more of the following oxidation states: manganese II or III, iron II or III, cobalt II or III, nickel II or III, copper I or II, rhodium II, III or IV, or ruthenium I, II or IV.

In another aspect, the one or more transition metals comprise cobalt, that may be provided as cobalt neodecanoate, in an amount, for example, to provide cobalt atoms from 50 ppm to 150 ppm, based on the weight of the cobalt with respect to the weight of the polymer blend.

In another aspect, the aluminum atoms may be present in the one or more polyethylene terephthalate homopolymers or copolymers in an amount from about 1 ppm to about 35 ppm, or from 5 ppm to 35 ppm, or from 5 ppm to 25 ppm, in each case based on the weight of the one or more PET homopolymers or copolymers, and may further comprise one or more alkaline earth metal or alkali metal atoms present in an amount, for example, from 1 ppm to 25 ppm based on the weight of the one or more PET homopolymers or copolymers.

In another aspect, the one or more alkaline earth metal or alkali metal atoms may be present in a molar ratio of the alkaline earth metal or alkali metal atoms to the aluminum atoms of, for example, from 0.1 to 75.

In another aspect, the one or more polyethylene terephthalate homopolymers or copolymers may comprise one or more of lithium atoms, sodium atoms, or potassium atoms in an amount, for example, from 5 ppm to 18 ppm, based on the weight of the one or more PET homopolymers or copolymers.

In another aspect, the aluminum atoms may be present, for example, as one or more aluminum carboxylates, glycolates, basic aluminum carboxylates, or aluminum alkoxides.

In still another aspect, the one or more polyethylene terephthalate homopolymers or copolymers may comprise phosphorus atoms in an amount, for example, from about 10 ppm to about 300 ppm, or from 10 ppm to 150 ppm, or from 10 ppm to 70 ppm, in each case based on the weight of the one or more polyethylene terephthalate homopolymers or copolymers.

In another aspect, the one or more polyethylene terephthalate homopolymers or copolymers may further comprise phosphorus atoms such that the ratio of moles of phosphorus atoms to the total moles of aluminum atoms, alkaline earth metal atoms, and alkali metal atoms is from, for example, 0.1 to 3, or from 0.5 to 1.5.

In another aspect, the one or more polyethylene terephthalate homopolymers or copolymers of the invention may have an intrinsic viscosity, for example, of at least 0.65 dL/g, or at least 0.68 dL, or at least 70 dl/g, or at least 0.72 dL/g, or at least 0.75 dL/g, or at least 0.80 dL/g, or at least 0.84 dL/g.

In another aspect, the one or more polyethylene homopolymers or copolymers of the invention may comprise, for example, a carboxylic acid component comprising, for example, at least 80 mole %, or at least 90 mole %, or at least 92 mole %, or at least 96 mole % residues of terephthalic acid, and a hydroxyl component comprising, for example, at least 80 mole %, or at least 90 mole %, or at least 92 mole %, or at least 96 mole % residues of ethylene glycol, based on the total amount of carboxylic acid residues in the one or more polyethylene homopolymers or copolymers comprising 100 mole percent, and the total amount of residues of hydroxyl component in the one or more polyethylene homopolymers or copolymers comprising 100 mole percent.

The polymer blends of the invention may be in a variety of forms, for example in the form of a blow-molded bottle, or in the form of a bottle preform.

Further aspects of the invention are as set out below.

### BRIEF DESCRIPTION OF THE DRAWINGS

FIG. 1A is a plot of the oxygen transmission rate (OTR) as a function of time for three bottles made from Polymer Blend 1 (Comparative). The average OTR for the three bottles made from Polymer Blend 1 is also presented.

FIG. 1B is a plot of the oxygen transmission rate (OTR) as a function of time for three bottles made from Polymer Blend 2 (Comparative). The average OTR for the three bottles made from Polymer Blend 2 is also presented.

FIG. 1C is a plot of the oxygen transmission rate as a function of time for three bottles made from Polymer Blend 3 (Inventive). The average OTR for the three bottles made from Polymer Blend 3 is also presented.

FIG. 1D is a plot of the oxygen transmission rate as a function of time for three bottles made from Polymer Blend 4 (Inventive). The average OTR for the three bottles made from Polymer Blend 4 is also presented.

FIG. 1E is a plot of the average oxygen transmission rate as a function of time for Polymer Blends 1 through 4.

FIG. 2A is a plot of the oxygen transmission rate (OTR) as a function of time for three bottles made from Polymer Blend 5 (Comparative). The average OTR for the three bottles made from Polymer Blend 5 is also presented.

FIG. 2B is a plot of the oxygen transmission rate (OTR) as a function of time for three bottles made from Polymer Blend 6 (Comparative). The average OTR for the three bottles made from Polymer Blend 6 is also presented.

FIG. 2C is a plot of the oxygen transmission rate (OTR) as a function of time for three bottles made from Polymer Blend 7 (Inventive). The average OTR for the three bottles made from Polymer Blend 7 is also presented.

FIG. 2D is a plot of the oxygen transmission rate (OTR) as a function of time for three bottles made from Polymer Blend 8 (Inventive). The average OTR for the three bottles made from Polymer Blend 8 is also presented.

FIG. 2E is a plot of the average oxygen transmission rate as a function of time for Polymer Blends 5 through 8.

FIG. 3A is a plot of oxygen depletion over time due to uptake by Polymer Blends 9 through 16.

FIG. 4A is a plot of the oxygen transmission rate (OTR) as a function of time for three bottles made from Polymer Blend 17 (Comparative). The average OTR for the three bottles made from Polymer Blend 17 is also presented.

FIG. 4B is a plot of the oxygen transmission rate (OTR) as a function of time for three bottles made from Polymer Blend 18 (Comparative). The average OTR for the three bottles made from Polymer Blend 18 is also presented.

FIG. 4C is a plot of the oxygen transmission rate (OTR) as a function of time for three bottles made from Polymer Blend 19 (Inventive). The average OTR for the three bottles made from Polymer Blend 19 is also presented.

FIG. 4D is a plot of the oxygen transmission rate (OTR) as a function of time for three bottles made from Polymer Blend 20 (Inventive). The average OTR for the three bottles made from Polymer Blend 20 is also presented.

FIG. 4E is a plot of the average oxygen transmission rate (OTR) as a function of time for Polymer Blends 17 through 20.

FIG. 5A is a plot of oxygen depletion versus time due to uptake by Polymer Blends 21 through 24.

### DETAILED DESCRIPTION OF THE INVENTION

The present invention may be understood more readily by reference to the following detailed description of the invention.

As used in the specification and the appended claims, the singular forms “a,” “an” and “the” include plural referents unless the context clearly dictates otherwise. For example, reference to processing or making a “polymer,” a “preform,” “article,” “container,” or “bottle” is intended to include the processing or making of a plurality of polymers, preforms, articles, containers or bottles.

Specifically, when a “polymer” is referred to in the specification and the claims, the term should be construed to include not just the reaction product of a single polymerization, but also to blends or physical mixtures of more than one polymer, since the thermoplastic polymers described herein may be satisfactorily blended with one another so that it may be difficult to afterward identify the source. Thus, the phrase “a PET homopolymer or copolymer” should be construed, for example, to include both the product of a single polymerization as well as mixtures of more than one PET homopolymer or copolymer, and the phrase a “polyamide homopolymer or copolymer” should be construed, for example, to include both the reaction product of a single polymerization as well as mixtures of more than one polyamide homopolymer or copolymer reaction product.

References to a composition containing “an” ingredient or “a” polymer is intended to include other ingredients or other polymers, respectively, in addition to the one named. For example, when we refer to “a” transition metal, the phrase is intended to include the use or presence of more than one transition metal. Similarly, when we refer to a PET homopolymer or copolymer, or to a poly(m-xylylene adipamide) homopolymer or copolymer, the phrases are intended to include the use or presence of more than one of the polymers.

By “comprising” or “containing” or “having” we mean that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

When we say that the polyamide homopolymer or copolymer, sometimes hereinafter described simply as the “polyamide,” is added to or blended with the PET homopolymers or copolymers, the polyamide may either be added neat or as a concentrate, unless the context indicates otherwise.

It is also to be understood that the mention of one or more method steps does not preclude the presence of additional method steps before or after the combined recited steps or intervening method steps between those steps expressly identified, unless otherwise indicated.

Expressing a range includes all integers and fractions thereof within the range. Expressing a temperature or a temperature range in a process, or of a reaction mixture, or of a melt or applied to a melt, or of a polymer or applied to a polymer means in all cases that the limitation is satisfied if either the applied temperature, the actual temperature of the melt or polymer, or both are at the specified temperature or within the specified range.

As used throughout the specification, “ppm” is by weight.

By “atoms” of a metal we mean the metal atom occupying any oxidation state, any morphological state, any structural state, and any chemical state, whether as added to or as present in the polymer or composition of matter.

By the term “residue(s)” we mean the portion of a monomer(s) which remains after the monomer(s) is condensed to form a polymer or oligomer chain, regardless of length.

When we use the term acid/amine units, we mean a unit comprising a single acid and a single amine condensed together, typically also condensed with one or more additional monomers on one or both ends of the unit. This is simply a convenient means of describing the repeating units of a polyamide comprised of amine and acid monomers.

The intrinsic viscosity values described throughout the description are set forth in dL/g units as calculated from the inherent viscosity measured at 25° C. in 60/40 wt/wt phenol/tetrachloroethane.

When we say that the polymer blends of the invention have “oxygen-scavenging effect,” we mean that the blends react with oxygen within the blends or permeating through the blends, or that the blends exhibit a lower rate of transmission of oxygen through the blends than known polymers or blends. Thus, blends having “oxygen-scavenging activity” absorb or react with oxygen within or permeating through the polymer blend, or exhibit reduced transmission through the blend. When we use the term “oxygen-scavenging capacity,” we refer to the total amount of oxygen the polymer blend is capable of absorbing before the polymer blend is no longer effective to absorb, or react with, oxygen.

We have surprisingly discovered that polymer blends that include: a transition metal; one or more PET homopolymers or copolymers prepared in the melt phase using a catalyst system comprising aluminum and one or more alkaline earth atoms, alkali metal atoms, or alkali compound residues, for example lithium; and one or more polyamide homopolymers or copolymers described elsewhere herein, exhibit improved oxygen-scavenging activity compared with PET polymers prepared using conventional catalyst systems. For example, the comparative polymer blends of the examples which include PET copolymers prepared via conventional melt-phase polycondensation using antimony catalysts, followed by solid-state polymerization to achieve the final lt.V, exhibit relatively poor oxygen-scavenging performance compared with the inventive blends described herein.

In one aspect, the invention relates to polymer blends that comprise one or more polyethylene terephthalate (PET) homopolymers or copolymers prepared in the melt phase using aluminum and one or more alkaline earth metal atoms, alkali metal atoms, or alkali compound residues as a catalyst system. The polymer blends of the invention further comprise one or more polyamide homopolymers or copolymers having oxygen-scavenging properties.

In one aspect, the polyamide homopolymer or copolymer may be provided as a concentrate comprising a blend of a PET homopolymer or copolymer with the polyamide. In another aspect, the polyamide may be provided neat, and melt-blended with the one or more polyethylene terephthalate (PET) homopolymers or copolymers.

In yet another aspect, the polymer blends of the invention may further comprise one or more transition metal atoms, provided, for example, as a transition metal salt such as a cobalt salt, that increase the oxygen-scavenging properties of the polyamide.

In one aspect, the polymer blend comprises one or more polyamide homopolymers or copolymers (“polyamides”), such as those described in U.S. Pat. No. 5,021,515 and U.S. Pat. Appln. Publn. No. 2006/0148957, incorporated herein by reference in their entirety and further elaborated upon below. The polyamides, for example poly(m-xylylene adipamide) homopolymers or copolymers, may be provided to the polymer blend as a concentrate or neat. The concentrate may be comprised, for example, predominantly of a PET homopolymer or copolymer, but with a relatively large amount of the polyamide, for example one or more poly(m-xylylene adipamide) homopolymers or copolymers, for example in an amount from about 0.5 wt % to about 40 wt % polyamide, or from 5 wt % to 30 wt % polyamide, or from 10 wt % to 25 wt % polyamide, in each case based on the total weight of the concentrate. When provided as such concentrates, the amounts of the concentrate provided to the polymer blends of the invention may vary, for example, from about 1.5 to about 25 wt % concentrate, or from 2 wt % to 15 wt % concentrate, or from 3.5 wt % to 10 wt % concentrate, or from 1 wt % to 3 wt % concentrate, in each case based on the total weight of the polymer blends of the invention. The polymer blends of the invention retain significant oxygen-scavenging properties of the one or more polyamide homopolymers or copolymers upon blending, including melt-blending and extrusion blending, while retaining the properties of the one or more polyethylene terephthalate (PET) homopolymers or copolymers that make them suitable for use in packaging.

The polymer blends according to the invention may be prepared, for example, by adding the one or more polyamides to the one or more PET homopolymers during polycondensation. Likewise, the polyamides may be incorporated into the blend by melt-blending with the one or more PET homopolymers or copolymers, for example by heating the components to obtain melt homogenization in an extruder.

If one desires, a concentrate of the polyamide in a polyester can be made and let down into an extruder or injection molding machine at a desired rate to yield a blend containing the desired amount of polyamide in the polymer blend of the invention. The concentrate would thus contain a concentration of polyamide which is higher than that desired in the polymer blend, which may be in the form of a container. Thus, the polyamide of the polymer blends of the invention may be provided as a concentrate, in which the polyamide is present in an amount, for example, of at least 10.0 wt %, or at least 15.0 wt. %, or at least 20 wt. %, and up to about 40 wt. %, or up to about 50 wt %, in each case based on the total weight of the concentrate. A remainder of the concentrate may comprise, for example, a PET polymer or another thermoplastic polymer compatible with the polyamide and the PET homopolymer or copolymer of the inventive blends.

The polymer blends of the invention may be prepared by a variety of methods. For example, the PET polymer and the polyamide may be separately, or in combination, dried in an atmosphere of dried air or dried nitrogen, and/or processed under reduced pressure. In one method, the PET polymer and the polyamide are melt compounded, for example, in a single or twin screw extruder. After completion of the melt compounding, the extrudate is withdrawn in strand form, and recovered such as by cutting. Alternatively, the PET polymer and polyamide may be dry-blended. A separate stream of PET polymer particles may be fed to a melt processing zone for making an article, and the concentrate let down into the melt processing zone in an amount to provide the desired level of polyamide in the finished article. Alternatively, a stream of PET polymer particles may be fed separately, or in combination as a dry pellet blend, with a stream of polyamide neat or in a liquid carrier to the melt processing zone for making the finished article.

The polyamide can be added to the PET polymer particles or melt as a neat stream of polyamide, or in a suitable carrier. Suitable liquid carriers include those which are the same as one of the reactants used to make the PET polymer in the melt phase (e.g., ethylene glycol). Alternatively, increasing the molecular weight of the polymer may not be desired, in which case a non-reactive carrier may be used.

In addition to directly forming the polymer blends of the invention with application-specific loadings of the polyamides, either of the former methods (i.e., direct polycondensation or melt-blending) can be used to produce concentrates that can subsequently be introduced to the PET homopolymer or copolymer, for example via the direct polymerization reactor, a melt-blending extruder, or secondary processing equipment (e.g., film extrusion line or bottle-preform molding machine).

Generally, when prepared in advance of use, it may be necessary or helpful to maintain the polyamide concentrates, the blends of the invention, and the articles produced from the blends of the invention, in an inert environment. In some instances, the oxygen-scavenging ability of the polyamides, especially when incorporated into the polymer blend of the invention with an oxidation catalyst, is present as soon as the blend is formed, or after an oxygen exposure induction period has elapsed. The potential for scavenging oxygen may be significantly diminished if left exposed to oxygen (or air) for lengthy periods. Furthermore, lengthy exposure to high temperature in the presence of oxygen can further reduce the oxygen absorption capacity of the concentrates and the polymer blends when made into a packaging article and introduce the possibility of thermal decomposition and degradation if overly excessive. Premature loss of oxygen-scavenging capacity prior to conversion of the concentrates and the polymer blends into a packaging article, as well as loss of oxygen-scavenging capacity of the packaging article prior to their intended use, can be controlled by storing in an inert environment or by addition of suitable stabilizing agents.

Thus, in one aspect, the polymer blends of the invention, or the concentrates from which the inventive blends are produced, may be prepared by any suitable process, including those yet to be invented, perhaps the simplest being by melt-extrusion. In such a process, either alone or in combination with a fabrication step, at least a portion of the one or more PET homopolymers or copolymers is fed into an extruder. The polyamide may be separately conveyed to the extruder and introduced into the extruder mixing zone. The residence time may be, for example, from about 1 to about 5 minutes at a temperature range, for example, from about 250° C. to about 310° C. The polyamide may be introduced into the extruder and the rate of introduction adjusted to provide the amount of polyamide necessary to achieve the desired oxygen-scavenging capacity in the concentrate or the inventive polymer blend.

A typical range for the polyamide in such concentrates might be, for example, from about 0.5 wt. % to about 40 wt. %, or from 5 wt. % to 30 wt. %, or from 10 wt. % to 25 wt. %, in each case based on the total weight of the concentrate, which may correspond, for example, to from about 0.2 wt. % to about 10 wt. %, or from 0.5 wt. % to 5 wt. %, or from 1 wt. % to 3 wt. % polyamide, in each case based on the total weight of the inventive polymer blends of the application.

According to the invention, the polyamides used according to the invention need only be present in the polymer blends of the invention in an amount to provide the degree of oxygen-scavenging capacity desired for the particular application. Since the polymer blends of the invention are comprised mainly of the PET homopolymers or copolymers, the properties of the inventive blends are similar to those of the polyester.

In one aspect, at least a portion of the one or more PET homopolymers or copolymers (“PET polymer”) is melt blended with the polyamide so as to form concentrates comprising predominantly PET polymer and polyamide. The concentrate may be melt blended with additional PET polymer to provide sufficient polyamide to impart the needed oxygen-scavenging capacity in a final blend.

In another aspect, the PET polymer may be melt blended with the polyamide to produce the inventive polymer blend, for example by feeding the polyamide directly into a secondary fabrication machine, such as a film extrusion extruder or an injection molding machine used to mold bottle preforms.

In yet another aspect, the PET polymer may be blended with the polyamide to produce the inventive blend, for example, by feeding the polyamide directly into the polymerization reactor that produces the one or more PET homopolymers or copolymers.

The polyamide may be added, either neat or as a concentrate, at locations including, but not limited to, at the commencement of the esterification, proximate the outlet of an esterification reactor (i.e., where there is greater than 50% conversion), proximate the inlet to a prepolymer reactor, proximate the outlet to a prepolymer reactor, at a point between the inlet and the outlet of a prepolymer reactor, proximate the inlet to a polycondensation reactor, or at a point between the inlet and the outlet of a polycondensation reactor, or at a point between the outlet of a polycondensation reactor and a die for forming pellets, sheets, fibers, bottle preforms, or the like.

In still another aspect, the polyamide may be introduced, either neat or as a concentrate, into the final polycondensation reactor producing the one or more PET homopolymers or copolymers near the end of the polymerization process, for example at any of the following points:
a. if the polyester melt is present in a melt phase polymerization process, adding the one or more polyamide homopolymers or copolymers within a final reactor for making the polyester polymer, near its discharge point, or between the final reactor and before a cutter for cutting the polyester melt; or
b. after the lt.V. of the polymer has risen to at least 0.5 dL/g, or
c. after vacuum applied to the polyester melt, if any, is released, at least partially; or
d. if the polyester melt is present in a melt phase polymerization process, following at least 75% of the polycondensation time;
e. to the polyester melt in the melt phase process at a point within +/−0.15 dL/g, of the lt.V. obtained upon solidification; or
f. at a point at most 30 minutes before solidifying the melt, or at most 20 minutes before solidifying the melt.

In one aspect, the polyamide may be added to the polyester melt, either neat or as a concentrate, after the polyester melt obtains an lt.V. of at least 0.50 dL/g, or at least 0.55 dL/g, or at least 0.60 dL/g, or at least 0.65 dL/g, or at least 0.68 dL/g, or at least 0.70 dL/g, or at least 0.72 dL/g or at least 0.76 dL/g, or at least 0.78 dL/g. When a melt-phase-only process is used to prepare the polyester, the polymer exiting the melt phase manufacture typically has an lt.V. of at least 0.68 dL/g, or at least 0.72 dL/g, or at least 0.76 dL/g.

In another aspect, the polyamide homopolymers or copolymers may be added, either neat or as a concentrate, to the polyester melt during or after releasing the vacuum from the polyester melt undergoing polycondensation reactions, or after bringing the pressure in a polycondensation zone or reactor from a lower level of 10 mm Hg or less or from a lower level of 3 mm Hg or less to a level of 300 mm Hg or greater, or 450 mm Hg or greater, or 600 mm Hg or greater, or to atmospheric pressure or greater, and preferably before the polyester melt is solidified.

In another aspect, the polyamide may be added, either neat or as a concentrate, at a location near or at the end of a final reactor or between the final reactor and before a cutter. For example, the polyamide may be added to the last polycondensation reactor at a location proximal to the outlet of the last polycondensation reactor, or to a pipe connecting directly or indirectly the last polycondensation reactor and a gear pump or extruder providing the motive force to drive the melt through a die plate for cutting wherein said pipe is directed back to or proximal to the outlet or the bottom of the last polycondensation reactor, or to a pipe inlet to the last polycondensation reactor that is proximal to its outlet.

By proximal to the outlet of the last polycondensation reactor, we mean that the addition location is within the last 25% or less of said reactor or within the last 15% or less of said reactor or preferably in the last 10% or less of said reactor. The percentage can be by length or height or volume of the last polycondensation reactor. Preferably the percentage is by length or height.

The last percentages of lengths, heights or volumes are measured starting from the last polycondensation reactor's outlet.

In yet another aspect, the polyamide, either neat or as a concentrate, is added to the polyester melt following at least 85%, or at least 90%, or at least 95%, or at least 98%, or about 100% of the average polycondensation time. The average polycondensation time is a measure of the average time elapsed between when a given portion of melt enters the start of polycondensation zone to when that given portion of melt reaches the exit of the polyester melt from the last polycondensation reactor. The average polycondensation time or average residence time in the polycondensation zone can be measured by tracer studies or modeling.

In a further aspect, the polyamide, either neat or as a concentrate, may be added to the polyester melt when the lt.V. of the polyester melt is within 0.15 dL/g, or within 0.10 dL/g, or within 0.05 dl/g, or within 0.030 dL/g, or within 0.02 of the lt.V. obtained upon solidification. For example, the polyester melt could have an lt.V. that is 0.10 dL/g below the lt.V. obtained upon solidification, or it could have an lt.V. that is 0.10 dL/g above the lt.V. obtained upon solidification.

In yet another aspect, the polyamide may be added, either neat or as a concentrate, to the polyester melt at a point within 30 minutes or less, within 20 minutes or less, or within 10 minutes or less, or 5 minutes or less, or 3 minutes or less, of solidifying the polyester melt. The solidification of the polyester melt typically occurs when the melt is forced through a die plate into a water bath and cut into pellets, or in a melt-to-mold process when the melt is injection molded into a molded article. In the broadest sense, solidification occurs when the temperature of the polymer melt is cooled below the crystalline melting temperature of the polymer.

When a portion of the one or more PET homopolymers or copolymers is blended with the one or more polyamide homopolymers or copolymers so as to form such concentrates, the amount of polyamide in such concentrates may vary, for example, from about 0.5 wt. % to about 40 wt. %, or from 5 wt. % to 30 wt. %, or from 10 wt. % to 25 wt. %, in each case based on the total weight of the copolycondensate. These concentrates may then be further blended with additional amounts of one or more PET homopolymers or copolymers to obtain the amounts of polyamide ultimately present in the polymer blends of the invention. The one or more polyamide homopolymers or copolymers and their amounts are as further described elsewhere herein.

The total amount of the polyamide in the inventive blends of the invention may vary widely, and will depend in part on the degree of oxygen-scavenging that is desired for the particular application. Typically, the total amount of the one or more polyamide homopolymers or copolymers in the blends of the invention will be, for example, from about 0.05 to about 10 wt. %, or from 0.1 wt % to about 5 wt %, or from 1 wt % to 3 wt %, in each case based on the total weight of the PET polymer and the polyamide. In choosing the amount of desired polyamide, consideration is given for factors such as color, the effective reduction in oxygen transmission, and costs, which are each impacted by the amount and type of polyamide used.

In general, suitable amounts of polyamide for bottle applications containing water, beer, and fruit juices ranges from about 1.0 wt. %, or from about 1.25 wt. %, up to about 7 wt. %, or up to about 6 wt. %, or up to 5.0 wt. %, or up to 3.0 wt. %, or up to 2.5 wt. %. Greater amounts can be used, especially when the package volume is relatively small, because the relative amount of surface area is larger. However, for economic reasons, and to control haze and color, it is desirable to use the least amount of oxygen-scavenging composition effective to impart the desired level of oxygen scavenging and freshness to the package contents. Amounts of polyamide as low as 1.3 wt. % have proven effective. Accordingly, in a particularly suitable embodiment, the amount of polyamide polymer ranges from about 1.0 wt. %, or from 1.20 wt. %, up to about 3.0 wt. %, or up to 2.5 wt. %, or up to 2.0 wt. %.

The formulated polymer blend may contain, in addition to the polyamide, other types of oxygen-scavenging polymers. For example copolymers of α-olefins with polyamines and aromatic compounds having benzylic hydrogen atoms may be used in addition to the polyamide oxygen scavenger. The amount of oxygen scavengers other than polyamide polymers is desirably less than 30 wt. %, or less than 20 wt. %, or less than 10 wt. %, or less than 5 wt. %, or less than 2 wt. %, or less than 1 wt. %, or less than 0.5 wt. %, or less than 0.1 wt. %, in each case based on the total weight of the inventive blends of the invention.

In various aspects, compositions comprising a melt-phase-only PET polymer prepared with an alkali metal/Al catalyst package and an oxygen scavenger may yield oxygen transmission rates (in a 500 ml bottle at 23° C.) of less than 5 microliters (STP) O₂/day (where STP designates Standard Temperature [273.2 K] and Pressure [1 atm]) for at least 40 days, or greater than 60 days, or greater than 90 days, after blowing. Blends comprising a melt-phase-only PET polymer may be prepared with an alkali metal/Al catalyst package and 4 wt % or less of a polyamide that yield oxygen transmission rates (in a 500 ml bottle at 23° C.) of less than 5 microliters (STP) O2/day for >40 days after blowing.

As further described below, the term “melt-phase only PET polymer” describes a polyethylene terephthalate homopolymer or copolymer which is polycondensed entirely in the melt phase, and is distinguished from a polymer prepared in the melt phase and afterward further polymerized in the solid state, as evidenced by an increase in IV after solidification, typically by heating. Other polyethylene terephthalate homopolymers or copolymers useful according to the invention include those polycondensed in the melt phase to a desired minimum intrinsic viscosity, whether or not the polymer is afterward further polycondensed in the solid state.

The form of the inventive polymer blends is not limited and can include a composition in the melt phase, an amorphous pellet, a semi-crystalline particle, a composition of matter in a melt processing zone, a bottle, or other articles.

The polymer blends of the invention comprise one or more polyamide homopolymers or copolymers including those described, for example, in U.S. Pat. No. 5,021,515, U.S. Pat. Appln. Publication No. 2006/0148957, and U.S. Pat. Appln. Publication No. 2006/0180790, incorporated herein by reference in their entirety. Such one or more polyamide homopolymers or copolymers may be described herein simply as “polyamides.”

A variety of polyamide homopolymers or copolymers may be suitable for use according to the invention, so long as the polyamide homopolymers or copolymers are selected to provide the polymer blends of the invention with the necessary properties, for example suitable transparency and mechanical properties, as well as the appropriate processing characteristics, in addition to the requisite oxygen-scavenging effect. The polyamides need be present only in an amount necessary to provide the degree of oxygen-scavenging capacity needed for the particular application.

The term “polyamide” is used herein generally, and includes those that are homopolymers, copolymers, and terpolymers, and may be prepared by reacting a carboxylic acid functionalized monomer (e.g., a dicarboxylic acid compound) with an amine functionalized monomer (e.g., a diamine compound), or by any other known method, such as through lactams, using amino acids, or acid chlorides reacted with diamines, to form a polymer comprising predominantly amide linkages between the monomer residues. The polyamide is typically a random polymer such that the monomer units in the polymer chain are randomly arranged rather than arranged in a block fashion. “Polyamide” as used herein also includes low molecular weight polyamides and oligomers, and may comprise, for example, a dicarboxylic acid monomer condensed or end-capped with two monofunctional amine monomers. Similarly, the term “polyamide” may also describe low molecular weight polyamides comprising a diamine monomer condensed, or end-capped, with two monofunctional carboxylic acid monomers.

As used herein, the “carboxylic acid monomer” is typically a dicarboxylic acid monomer, but may also be monomers of other degrees of functionality. For example, the carboxylic acid monomers may include, in addition to or instead of the dicarboxylic acid monomers, monofunctional carboxylic acid monomers used, for example, to end-cap the polyamide, thereby affecting properties of the polyamide, such as the molecular weight and dispersion in the polymer blend. Monomers functionalized with more than two carboxylic acid groups my also be condensed into the polyamide.

Likewise, the “amine monomer” is typically a diamine monomer, but may also be monomers of other degrees of functionality. For example, the amine component may include, in addition to or instead of diamine monomers, monofunctional amine monomers used, for example, to end-cap the polyamide, thereby affecting properties of the polyamide, such as the molecular weight and dispersion in the polymer blend. Monomers functionalized with more than two amine groups may also be condensed into the polyamide to impart cross-linking.

In one aspect, the polyamide is a reaction product containing amide moieties, preferably in an amount of at least 50%, or at least 70%, or at least 80% of the linkages, represented by the general formula:

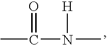

based on the total number of condensation linkages between the monomer residues comprising 100 percent. In another aspect, at least 80%, or at least 90%, or at least 95%, or at least 98% of the linkages between different monomer residues in the polyamide polymer are amide linkages, based on the total number of linkages comprising 100 percent. The number of such amide linkages present in the polymer may range, for example, from about 1 to about 200, or from about 50 to about 150.

In another aspect, the polyamide contains active methylene groups, such as may be found when a methylene group is resonance stabilized by an adjacent sp² type carbon atom. Active methylene groups include, for example, allylic group hydrogens and benzylic group hydrogens, including those present in the following structure linked to the carbon illustrated in bold:

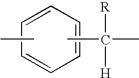

wherein R is a hydrogen or an alkyl group. The benzylic position is thus a carbon directly attached to an aryl ring. This carbon is especially reactive due to resonance stabilization of a benzylic radical or cation by the adjacent sp² carbon in the aryl ring. The aryl ring may be, for example, a phenyl ring or another polycyclic aromatic ring such as naphthyl. Preferably, at least 50% of the amine residues contain an active methylene group, such as an allylic group, an oxyalkylene hydrogen, or more preferably at least 50% of the amine residues contain a benzylic hydrogen group.

In yet another aspect, the polyamides comprise residues of adipic acid and m-xylylene diamine. In one aspect, the polyamides useful according to the invention may comprise adipic acid residues in amounts, for example, of at least about 50 mole %, or at least 60 mole %, or at least 70 mole %, or at least 80 mole %, up to about 85 mole %, or up to 90 mole %, or up to 95 mole %, or up to 98 mole %, or up to 100 mole %, based on the total carboxylic acid residues in the polyamide summing to 100 mole.

In another aspect, polyamides of the invention comprise m-xylylene diamine residues in amounts, for example, of at least about 50 mole %, or at least 60 mole %, or at least 70 mole %, or at least 80 mole %, up to about 85 mole %, or up to 90 mole %, or up to 95 mole %, or up to 98 mole %, or up to 100 mole %, in each case based on the total amine residues in the polyamide comprising 100 mole %, with the remainder of the amine residues comprising residues from one or more other amines, such as p-xylylenediamine.

In yet another aspect, the polyamides useful according to the present invention may include a copolymer comprising from about 80 to 100 mol percent adipic acid residues and from about 80 to 100 mole percent m-xylylenediamine residues, based on the total amount of carboxylic acid residues and the total amount of amine residues in the polyamide each comprising 100 mole percent. In still another aspect, the polyamide comprises from about 95 to 100 mole percent adipic acid residues and from about 90 to 100 mole percent m-xylylenediamine residues, based on the total amount of carboxylic acid residues and the total amount of amine residues in the polyamide each comprising 100 mole percent. In another aspect, the polyamide may comprise repeating units of poly(m-xylylene adipamide) in an amount of at least 60 mole percent, or at least 75 mole percent, or at least 80 mole percent, or at least 85 mole percent, or at least 90 mole percent, or at least 95 mole percent, or at least 96 mole percent, in each case based on the total moles of acid/amine units in the polyamide comprising 100 mole percent.

In addition to adipic acid residues, the carboxylic acid residues of the polyamide may comprise, for example, up to 20 mole percent, or up to 10 mole percent, or up to 5 mole percent, or up to 2 mole percent, one or more additional carboxylic acid residues having, for example, from 2 to 20 carbon atoms, for example one or more aliphatic carboxylic acid residues having from 7-12 carbon atoms, such as residues of pimelic acid, suberic acid, azelaic acid, sebacic acid, undecandioic acid, dodecandioic acid, or 1,4-cyclohexanedicarboxylic acid. In other aspects, the carboxylic acid residues may comprise isophthalic acid, or terephthalic acid residues.

As used herein, the carboxylic acid residues may be provided as the free carboxylic acids, or the corresponding carboxylic acid derivative, for example dicarboxylic acid esters of alcohols having from 1 to 4 carbon atoms, or dicarboxylic anhydrides, or dicarboxylic acid chlorides.

The amine residues of the polyamide may include up to 20 mole percent, or up to 10 mole percent, or up to 5 mole percent, of one or more additional amine residues having from 2 to 16 carbon atoms. Examples include p-xylylene diamine, 1,2-bisaminomethylcyclohexane, hexamethylene diamine, and mixtures thereof.

It is to be understood that the amine monomer used to prepare the polyamides may not be 100% pure, and may contain reaction by-products with the identified amine monomer being the predominant monomer. The same can be said for the carboxylic acid monomer.

The polyamides of the invention may further comprise additional linkages, for example imides and amidines.

Polyamides useful in the polymer blends of the invention include, for example,
(a) a dicarboxylic acid residues of adipic acid in an amount of at least about 50 mole %, or at least 60 mole %, or at least 70 mole %, or at least 80 mole %, up to about 85 mole %, or up to 90 mole %, or up to 95 mole %, or up to 98 mole %, or up to 100 mole % with the remainder of the dicarboxylic acid residues comprising residues of, for example, isophthalic acid or terephthalic acid up to 5 mole %, or up to 40 mole %, or up to 30 mole %, or up to 20 mole %, or up to 10 mole %, or up to 5 mole %, and mixtures thereof, in each case based on the total dicarboxylic acid residues in the polyamide summing to 100 mole, and
(b) a diamine residue comprising residues of m-xylylene diamine in amounts, for example, of at least about 50 mole %, or at least 60 mole %, or at least 70 mole %, or at least 80 mole %, up to about 85 mole %, or up to 90 mole %, or up to 95 mole %, or up to 98 mole %, or up to 100 mole %, with the remainder of the diamine residues comprising residues from one or more other diamines, such as p-xylylenediamine or hexamethylene diamine residues in an amount up to 50 mole %, or up to 40 mole %, or up to 30 mole %, or up to 20 mole %, or up to 10 mole %, or up to 5 mole %, in each case based on the total diamine residues in the polyamide comprising 100 mole %. Examples include, but are not limited to: poly(m-xylylene adipamide) (which may be described herein as “MXD6”), poly(m-xylylene adipamide-co-isophthalamide), poly(hexamethylene isophthalamide), poly(hexamethylene isophthalamide-co-terephthalamide), poly(hexamethylene adipamide-co-isophthalamide), poly(hexamethylene adipamide-co-terephthalamide), poly(hexamethylene isophthalamide-co-terephthalamide), and the like, or mixtures thereof. Especially suitable polyamides include those having residues with a benzylic hydrogen, for example polyamides such as poly(m-xylylene adipamide), poly(m-xylylene isophthalamide-co-terephthalamide), poly(m-xylylene adipamide-co-isophthalamide), and mixtures thereof. We have found poly(m-xylylene adipamide), available from Mitsubishi Gas and Chemical Company, Chiyodaku, Tokyo, Japan, to be especially suitable for use according to the invention.

The number average molecular weight of the polyamide polymer is not particularly limited. The number average molecular weight (Mn) may be, for example, at least about 1,000, up to, for example, about 45,000. Alternatively, the Mn of the polyamide polymer may be at least 2,500, or at least 3,500, or at least 5000, up to about 7,000, or up to about 12,000, or up to about 25,000. If desired, low molecular weight polyamides may be used in the range from about 200, or from 300, or from 500, or from 1,000 up to about 12,000, or from 2,000 to 10,000, or from 2,500 to 7,000. If optical clarity of the polymer blend is important, we believe that the use of low molecular weight polyamides may interfere less with light transmission.

In another aspect, the polyamides useful according to the invention include those described in U.S. Pat. Appln. Publn. No. 2006/0180790, incorporated herein by reference in its entirety. For example, the polyamides may comprise adipic acid condensed with two monofunctional or difunctional amines, for example having a benzylic hydrogen, such as from a benzyl amine. The monomers may be the same or different. Alternatively, the low molecular weight polyamides may comprise m-xylylenediamine condensed with two monofunctional or difunctional monomers such as carboxylic acids (e.g., formic, acetic, propionic, butyric, valeric acid, benzoic) or an acid chloride. The monomers can be the same or different. The molecular weight of such molecules will depend in part upon whether the monomers are monofunctional or difunctional, that is, whether the monomers include linking groups to further react with additional monomers.

The polyamides of the invention may be prepared, for example, by melt phase polymerization of a diacid-diamine complex formed by combining a diamine and a dicarboxylic acid in stoichiometric amounts. The diacid-diamine complex may be prepared either in situ during polycondensation or in a separate step, for example by combining and heating an aqueous solution of the diamine and the dicarboxylic acid while carefully controlling the pH of the aqueous solution. In either method, the diacid and diamine are used as starting materials and heated to a polymerization temperature from about 240° C. to about 260° C. at a pressure of about 0.3 MPa. Alternatively, an ester form of the diacid may be used, for example the dimethyl ester. If the ester is used, the reaction will be carried out at a relatively low temperature, generally from 80° C. to 120° C., until the ester is converted to an amide. The mixture is then heated to the polymerization temperature. Conventional catalysts may be used to prepare the polyamides of the invention. Such catalysts are described in Principles of Polymerization” 4th ed by George Odian 2004; “Seymour/Carraher's Polymer Chemistry” 6th ed rev and expanded 2003; and “Polymer Synthesis: Theory and Practice” 3rd ed by D. Braun 2001.

The polymer blends of the invention may further comprise a transition metal as an oxidation catalyst. Although we use the term “catalyst,” the transition metal may or may not be consumed in the oxidation reaction, or if consumed, may only be consumed temporarily by converting back to a catalytically active state.

The amount of transition metal used in the inventive blends is an amount effective to actively scavenge oxygen. This amount may vary depending on the transition metal used, and will also depend upon the degree of scavenging desired or needed in the application. For example, one or more transition metals, such as cobalt provided as a cobalt salt, may be present in the polymer blends of the invention in amounts, for example, from about 10 ppm to about 1,000 ppm, or from 20 ppm to 750 ppm, or from 25 ppm to 500 ppm, in each case expressed as the weight of the metal atoms based on the total weight of the polymer blends. Alternatively, the transition metal may be present in the blends of the invention in an amount of at least 10 ppm, or at least 15 ppm, or at least 25 ppm, or at least 50 ppm, up to 500 ppm, or up to 750 ppm, or up to 800 ppm, or up to 1,000 ppm, in each case expressed as the weight of the metal atoms based on the total weight of the blend. If present in the inventive blends, the transition metal may be present in amounts, for example, from about 35 ppm to about 5,000 ppm or more, or from 100 ppm to 3,000 ppm, or from 500 ppm to 2,500 ppm, based on the total weight of the blends.

Suitable transition metals include those which can readily interconvert between at least two oxidation states. The transition metal may be provided in the form of a transition metal salt, with the metal selected from the first, second, or third transition series of the Periodic Table. Suitable metals and oxidation states include manganese II or III, iron II or III, cobalt II or III, nickel II or III, copper I or II, rhodium II, III or IV, and ruthenium I, II or IV. Suitable counterions for the metal include, but are not limited to, chloride, acetate, acetylacetonate, stearate, palmitate, 2-ethylhexanoate, neodecanoate, octanoate, or naphthenate, and mixtures thereof. The metal salt may also be an ionomer, in which case a polymeric counterion is employed. An amount of catalyst which is effective in catalyzing oxygen scavenging may be used. Typical amounts in the blends of the invention are at least about 10 ppm, or at least 25 ppm, or at least 50 ppm, or at least 100 ppm, up to about 750 ppm, or up to about 1,000 ppm, or from 50 ppm up to 500 ppm. For example, cobalt neodecanoate is found to effectively induce oxygen scavenging in the inventive blends in amounts from about 50 ppm up to about 250 ppm, based on the weight of cobalt to the weight of the inventive polymer blend.

Typical amounts of transition metal catalysts, if provided in the polyamide concentrates, may be even higher, for example at least about 50 ppm, or at least 250 ppm, or at least 500 ppm, up to about 1,000 ppm, or up to about 2,500 ppm, or up to about 5,000 ppm, or up to about 10,000 ppm or more. These polyamide concentrates, when provided to the blends of the invention in additive amounts, may thus serve also as transition metal catalyst concentrates. It may be an advantage, however, to add the transition metal shortly before blending rather than adding the metal to the concentrate, in order to retain the desired oxygen-scavenging effect upon blending.

We have found cobalt salts to be especially suitable for use according to the invention.

When the inventive blends are intended for packaging compositions, one or more transition metal catalysts in amounts ranging from about 10 ppm to about 1,000 ppm are suitable for most applications, or in amounts of at least 10 ppm or at least 30 ppm, or at least 50 ppm, or at least 60 ppm, or at least 75 ppm, or at least 100 ppm, or at least 200 ppm. Alternatively, the transition metal catalyst may be present in an amount up to about 300, or up to 200, or up to 100 ppm, or up to 75 ppm, or up to 50 ppm, or up to 25 ppm, or up to 10 ppm, based on the weight of the inventive blend.

The amounts given are based on the weight of the polymer blends and measured as the metal, not the compound weight as added to the composition. In the case of cobalt as the transition metal, suitable amounts may be at least 20 ppm, or at least 30 ppm, or at least 50 ppm, or at least 60 ppm, or at least 100 ppm, or at least 125 ppm, or at least 250 ppm. Alternatively, the cobalt may be present in an amount up to about 200, or up to 100 ppm, or up to 75 ppm, or up to 50 ppm, or up to 25 ppm, or up to 10 ppm, based on the weight of the inventive blend.

In those cases in which the transition metal is added during polymerization of one or more of the polymers, it may be necessary or helpful to add the transition metal near the end of the polymerization process, or even during blending, in order to retain the desired catalytic activity of the transition metal. For example, the transition metal can be added neat or in a carrier (such as a liquid or wax) to an extruder or other device for making an article comprising the polyester blends of the invention, or it can be added in a concentrate with an additional polyester or other thermoplastic polymer, or in a concentrate with a PET/polyamide blend. The carrier may either be reactive or non-reactive with the polyesters and either volatile or non-volatile carrier liquids may be employed.

Analogous to the blending protocols described above for introducing the polyamide into the PET polymer, it is evident that the transition metal catalyst may be added at a variety of points and via a variety of blending protocols during the preparation of the oxygen-scavenging polymer blends of the invention. A particularly useful approach is to bring the inventive blends and the transition metal together late in the preparation of the blends. In some instances, such as when cobalt is provided as a transition metal, it may be preferred to add the cobalt during blending of the PET polymer and the polyamide or concentrate (e.g., during a secondary fabrication process such as bottle preform molding), rather than earlier, for example during the PET polymerization process.

The PET homopolymers or copolymers of which the inventive blends are comprised, sometimes hereinafter described simply as the “PET polymers,” are thermoplastic and include a catalyst system comprising aluminum atoms, for example in an amount of at least 3 ppm based on the weight of the polymer, as well as one or more alkaline earth metal atoms, alkali metal atoms, or alkali compound residues, for example lithium. Such polymers typically have an lt.V. of at least 0.72 dL/g, obtained during melt phase polymerization.

The PET homopolymers or copolymers of which the inventive blends are comprised include those disclosed and claimed in U.S. patent application Ser. No. 11/495,431, filed Jul. 28, 2006 and having common assignee herewith, the disclosure of which is incorporated herein by reference in its entirety.

In another aspect, the PET polymers comprise aluminum atoms, as well as one or more alkaline earth metal atoms, alkali metal atoms, or alkali compound residues, provided as a catalyst system, and further comprise a catalyst deactivator effective to at least partially deactivate the catalytic activity of the combination of the aluminum atoms and the alkaline earth metal atoms, alkali metal atoms, or alkali compound residues.

In one aspect, the PET polymers are made by a process comprising polycondensing a polyester polymer melt in the presence of aluminum atoms and one or more alkaline earth metal atoms, alkali metal atoms, or alkali compounds.

The polymer blends of the invention, containing one or more PET homopolymers or copolymers prepared using the catalyst systems just described and further elaborated upon below, blended with the one or more polyamide homopolymers or copolymers described elsewhere herein, possess improved oxygen-scavenging activity compared with PET polymers prepared using conventional catalyst systems.

In yet another aspect of the invention, the PET polymers suitable for use according to the invention may be produced by a process that includes a step of adding phosphorus atoms to a polyester melt containing aluminum atoms and alkaline earth metal atoms or alkali metal atoms or alkali compound residues, for example lithium atoms.

In another aspect, the PET homopolymers or copolymers useful according to the invention comprise aluminum atoms and one or more alkaline earth atoms, alkali metal atoms, or alkali compound residues, and further comprise particles of one or more of: titanium, zirconium, vanadium, niobium, hafnium, tantalum, chromium, tungsten, molybdenum, iron, nickel, or nitrides or carbides of the foregoing, for example titanium nitride, titanium carbide, or mixtures thereof, the particles improving the reheat rate of the polyester compositions.

The particles may comprise, for example, transition metal compounds containing the atoms of boron, carbon, and nitrogen; transition elemental metals, and transition metal alloys, wherein the transition atom comprises titanium, zirconium, vanadium, niobium, hafnium, tantalum, chromium, tungsten, molybdenum, iron, or nickel atoms or combinations thereof.

In another aspect, the PET polymers may be prepared by a process comprising polycondensing a polyester polymer melt in the presence of aluminum atoms and one or more alkaline earth metal atoms, alkali metal atoms, or alkali compounds, and before, during, or after polycondensation, adding particles comprising titanium, zirconium, vanadium, niobium, hafnium, tantalum, chromium, tungsten, molybdenum, iron, or nickel atoms or combinations thereof.

The particles preferably comprise transition metal compounds containing the atoms of boron, carbon, and nitrogen; transition elemental metals, and transition metal alloys, wherein the transition atom comprises titanium, zirconium, vanadium, niobium, hafnium, tantalum, chromium, tungsten, molybdenum, iron, or nickel atoms or combinations thereof, for example titanium nitride, or titanium carbide, or mixtures thereof.

Thus, the PET homopolymers or copolymers useful according to the invention comprise, as a catalyst system, aluminum atoms and one or more alkaline earth atoms, alkali metal atoms, or alkali compound residues, optionally deactivated with one or more catalyst deactivators.

The aluminum atoms may be present, for example, in an amount from about 1 ppm to about 35 ppm, or from 5 ppm to 25 ppm, or from 10 ppm to 20 ppm, in each case based on the total weight of the PET polymers.

The one or more alkaline earth atoms (e.g., lithium, sodium, or potassium), alkali metal atoms (e.g., magnesium or calcium), or alkali compound residues may be present, for example, in a total amount from about 1 ppm to about 25 ppm, or from 1 ppm to 20 ppm, or from 5 ppm to 18 ppm, or from 8 ppm to 15 ppm, in each case based on the total weight of the one or more PET homopolymers or copolymers.

In one aspect, the one or more alkaline earth atoms, alkali metal atoms, or alkali compound residues comprises lithium. In this aspect, the amount of lithium may be, for example, from about 1 ppm to about 25 ppm, or from 5 ppm to 20 ppm, or from 8 ppm to 15 ppm, in each case based on the total weight of the PET polymers.

In the processes by which the PET polymers are prepared, the catalyst systems used may be deactivated by one or more catalyst deactivators, for example phosphorus atoms. If present, the amount of phosphorus atoms may range, for example, up to about 150 ppm, or up to about 115 ppm, or up to about 70 ppm.

In one aspect, the PET polymers may have intrinsic viscosities (lt.V.) in the range, for example, of about 0.50 to about 1.1, or inherent viscosities (lh.V) in the range of 0.70 to 0.85.

In the processes by which the PET polymers are produced, the final lt.V. of the polyester polymer is typically attained entirely in the melt phase polymerization process. This is in contrast with conventional processes, in which the molecular weight of the polyester polymer is increased to a moderate lt.V., solidified, and then followed by solid-phase polymerization to continue the molecular weight increase to the final desired higher lt.V. The conventional process does not permit appreciable catalyst deactivation in the melt phase, because the subsequent solid-phase polymerization requires catalysis. Since the process is capable of building the molecular weight to the desired final lt.V. entirely in the melt phase, the catalyst may be at least partially deactivated to thereby avoid at least some of the catalytic activity upon subsequent melting of particles, which is a common contributor to the generation of additional acetaldehyde.

Thus, in one aspect, the PET polymers comprise aluminum atoms, present in an amount of at least 3 ppm based on the weight of the polymer, said polymer having an lt.V. of at least 0.72 dL/g obtained through a melt phase polymerization.

In another aspect, the PET polymers comprise: (i) aluminum atoms, (ii) alkaline earth metal atoms or alkali metal atoms or alkali compound residues, and (iii) a catalyst deactivator in an amount effective to at least partially deactivate the catalytic activity of the combination of the (i) aluminum atoms and (ii) the alkaline earth metal atoms or alkali metal atoms or alkali compound residues.

The PET polymers useful according to the invention preferably comprise:
(i) a carboxylic acid component comprising at least 80 mole % of the residues of terephthalic acid, and
(ii) a hydroxyl component comprising at least 80 mole % of the residues of ethylene glycol or 1,3-propanediol,
   based on 100 mole percent of carboxylic acid component residues and 100 mole percent of hydroxyl component residues in the PET polymer(s).

Typically, the PET polymers are made by reacting diols comprising ethylene glycol with dicarboxylic acids comprising terephthalic acid (as the free acid or its C₁-C₄ dialkyl ester) to produce an ester monomer and/or oligomers, which are then polycondensed to produce the polyester. More than one compound containing carboxylic acid group(s) or derivative(s) thereof can be reacted during the process. All the compounds that enter the process containing carboxylic acid group(s) or derivative(s) thereof that become part of the polyester product comprise the “carboxylic acid component.” The mole % of all the compounds containing carboxylic acid group(s) or derivative(s) thereof that are in the product add up to 100. The “residues” of compound(s) containing carboxylic acid group(s) or derivative(s) thereof that are in the PET polymers refers to the portion of the compound(s) which remains in the PET polymers after the compound(s) is condensed with a compound(s) containing hydroxyl group(s) and further polycondensed to form PET polymer chains of varying length.

More than one compound containing hydroxyl group(s) or derivatives thereof can become part of the PET polymers. All the compounds that enter the process containing hydroxyl group(s) or derivatives thereof that become part of the PET polymers comprise the hydroxyl component. The mole % of all the compounds containing hydroxyl group(s) or derivatives thereof that become part of the PET polymers add up to 100. The “residues” of hydroxyl functional compound(s) or derivatives thereof that become part of the PET polymers refers to the portion of the compound(s) which remains in the PET polymers after the compound(s) is condensed with a compound(s) containing carboxylic acid group(s) or derivative(s) thereof and further polycondensed to form PET polymer chains of varying length.

The mole % of the hydroxyl residues and carboxylic acid residues in the PET polymers can be determined, for example, by proton NMR.

In other aspects, the one or more PET homopolymers or copolymers comprise:
(a) a carboxylic acid component comprising at least 90 mole %, or at least 92 mole %, or at least 96 mole % of the residues of terephthalic acid, or derivates of terephthalic acid, and
(b) a hydroxyl component comprising at least 90 mole %, or at least 92 mole %, or at least 96 mole % of the residues of ethylene glycol or 1,3-propanediol, more preferably ethylene glycol,
   based on 100 mole percent of the carboxylic acid component residues and 100 mole percent of the hydroxyl component residues in the PET polymers.

Modifiers can be present in amount of up to 40 mole %, or up to 20 mole %, or up to 10 mole %, or up to 8 mole %, or up to 5 mole %, based on the 100 mole percent of their respective component, carboxylic acid or hydroxyl, in the polymer. Mono-, tri-, and higher-functional modifiers are typically present and/or added in amounts of only up to about 8 mole %, or up to 4 mole %, or up to about 2 mole %, based on the 100 mole percent of their respective component, carboxylic acid or hydroxyl, in the polymer.

Derivatives of terephthalic acid and naphthalene dicarboxylic acid suitable for ®inclusion include C₁-C₄ dialkylterephthalates and C₁-C₄ dialkylnaphthalates, such as dimethylterephthalate and dimethylnaphthalate.

In addition to a diacid component of terephthalic acid or derivatives of terephthalic acid, the carboxylic acid component(s) of the present PET polymers may include one or more additional modifier carboxylic acid compounds, such as naphthalene-2,6-dicarboxylic acid, derivatives of naphthalene-2,6-dicarboxylic acid, or mixtures thereof, mono-carboxylic acid compounds, other dicarboxylic acid compounds, and compounds with a higher number of carboxylic acid groups. Examples include aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. More specific examples of modifier dicarboxylic acids useful as part of an acid component(s) are phthalic acid, isophthalic acid, naphthalene-2,6-dicarboxylic acid, cyclohexane-1,4-dicarboxylic acid, cyclohexanediacetic acid, diphenyl-4,4′-dicarboxylic acid, succinic acid, glutaric acid, adipic acid, azelaic acid, sebacic acid, and the like, with isophthalic acid, and naphthalene-2,6-dicarboxylic acid being most preferable. It should be understood that use of the corresponding acid anhydrides, esters, and acid chlorides of these acids is included in the term “carboxylic acid”. It is also possible for tricarboxyl compound branching agents and compounds with a higher number of carboxylic acid groups to modify the PET polymers, along with monocarboxylic acid chain terminators.

In addition to a hydroxyl component comprising ethylene glycol, the hydroxyl component of the present PET polymers may include additional modifier mono-ols, diols, or compounds with a higher number of hydroxyl groups. Examples of modifier hydroxyl compounds include cycloaliphatic diols preferably having 6 to 20 carbon atoms and/or aliphatic diols preferably having 3 to 20 carbon atoms. More specific examples of such diols include diethylene glycol; triethylene glycol; 1,4-cyclohexanedimethanol; propane-1,3-diol; butane-1,4-diol; pentane-1,5-diol; hexane-1,6-diol; 3-methylpentanediol-(2,4); 2-methylpentanediol-(1,4); 2,2,4-trimethylpentane-diol-(1,3); 2,5-ethylhexanediol-(1,3); 2,2-diethyl propane-diol-(1,3); hexanediol-(1,3); 1,4-di-(hydroxyethoxy)-benzene; 2,2-bis-(4-hydroxycyclohexyl)-propane; 2,4-dihydroxy-1,1,3,3-tetramethyl-cyclobutane; 2,2-bis-(3-hydroxyethoxyphenyl)-propane; and 2,2-bis-(4-hydroxypropoxyphenyl)-propane. As hydroxyl component modifiers, the PET polymers may preferably contain such comonomers as 1,4-cyclohexanedimethanol and diethylene glycol.

The PET polymers may be blended with polyalkylene naphthalates or other thermoplastic polymers such as polycarbonate (PC) and polyamides. It is preferred, however, that the PET polymers are comprised predominantly of repeating polyethylene terephthalate polymers, for example in an amount of at least 80 wt. %, or at least 90 wt. %, or at least 95 wt. %, based on the total weight of the PET homopolymers or copolymers.

In one aspect, the composition contains less than 60 wt %, or less than 40 wt %, or less than 20 wt. %, or less than 10 wt. %, or less than 5 wt. %, or no post-consumer recycled polyester polymer (“PCR”) present in the composition, based on the total weight of all polyester polymers. In another embodiment, the composition contains PCR in an amount of greater than zero and up to 60 wt. %, or up to 40 wt. %, or up to 20 wt %, or up to 10 wt. %, based on the total weight of all polyester polymers.

The PET polymers useful according to the invention thus include aluminum atoms that comprise an aluminum residue, that is the moiety remaining in a polymer melt upon addition of aluminum atoms to the melt phase process for making the PET polymers, without regard to the oxidation state, morphological state, structural state, or chemical state of the aluminum compound as added or of the residue present in the composition. The aluminum residue may be in a form identical to the aluminum compound as added to the melt phase reaction, but typically will be altered since the aluminum is believed to participate in accelerating the rate of polycondensation. By the term “aluminum atoms” or “aluminum” we mean the presence of aluminum in the polyester polymer detected through any suitable analytical technique regardless of the oxidation state of the aluminum. Suitable detection methods for the presence of aluminum include inductively coupled plasma optical emission spectroscopy (ICP). The concentration of aluminum is reported as the parts per million of metal atoms based on the weight of the PET polymers. The term “metal” does not imply a particular oxidation state.

Suitable examples of aluminum compounds include the carboxylic acid salts of aluminum such as aluminum acetate, aluminum benzoate, aluminum lactate, aluminum laurate, aluminum stearate, aluminum alcoholates such as aluminum ethylate, aluminum isopropylate, aluminum tri n-butyrate, aluminum tri-tert-butyrate, mono-sec-butoxyaluminum diisopropylate, aluminum glycolates such as aluminum ethylene glycolate, and aluminum chelates in which the alkoxy group of an aluminum alcoholate is partially or wholly substituted by a chelating agents such as an alkyl acetoacetate or acetylacetone such as ethyl acetoacetate aluminum diisopropylate, aluminum tris(ethyl acetoacetate), alkyl acetoacetate aluminum diisopropylate, aluminum monoacetylacetate bis(ethyl acetoacetate), aluminum tris(acetyl acetate), aluminum acetylacetonate.

Preferred among the aluminum compounds are the basic carboxylic acid salts of aluminum and aluminum alcoholates. Basic carboxylic acid salts of aluminum include monobasic and dibasic compounds. The basic aluminum acetate used can be either the diacetate monohydroxy compound or the monoacetate dihydroxy compound or a mixture thereof. In particular, basic aluminum acetate and aluminum isopropoxide are preferred aluminum compounds. Stabilizing basic aluminum acetate with boric acid may in some instances increases its solubility. Aluminum isopropoxide is most desirable.

The amount of aluminum present in the PET polymer generally ranges from at least 3 ppm, or at least 5 ppm, or at least 8 ppm, or at least 10 ppm, or at least 15 ppm, or at least 20 ppm, or at least 30 ppm, and up to about 150 ppm, or up to about 100 ppm, or up to about 75 ppm, or up to about 60 ppm aluminum based on the weight of the polymer. The preferred range of aluminum is from 5 ppm to 60 ppm. Other suitable amounts include from 7, or from 10 ppm and up to 60 ppm, or up to 40 ppm, or up to 30 ppm aluminum atoms.

An alkali metal residue or an alkaline earth metal residue is the alkali metal atoms or alkaline earth metal atoms present in the PET polymer in any form or oxidation state, or if an alkali compound is used, then the residual remainder of the alkali compound present within the polymer melt or the finished polymer or article, without regard to the oxidation states or ultimate physical, morphological, structural, or chemical states. The word “alkali metal” or “alkaline earth metal” or “metal” includes the atom in its elemental state or in an oxidation state corresponding to its allowable valences in its Periodic group. The chemical state of the alkali upon addition is also not limited. The alkali may be added as a metal compound, organometallic compound, or as a compound without a metal. Likewise, the chemical state of the alkaline earth metal compound or alkali metal compound upon addition is not limited.

The alkali metals and alkaline earth metals include the metals in Group IA and Group IIA of the periodic table, including Li, Na, K, Rb, Cs, Mg, Ca, Sr, and especially Li, Na or K. If rapid rates and clarity are the primary concern, Li may be preferred. If color is the primary concern, Na may be preferred. The metals may be added to the melt phase as metal compounds (which includes a complex or a salt) having counterions, among which the preferred ones are hydroxides, carbonates, and carboxylic acids.

Other suitable alkali compounds are those mentioned in U.S. Pat. No. 6,156,867, the relevant disclosure of which is incorporated herein by reference. They include the tertiary amine compounds and the quaternary ammonium compounds. The particular amine compounds selected are desirably those which do not impart more yellow color to the polymer.

The ratio of the moles of alkali metal or moles of alkaline earth metal or moles of alkali to the moles of aluminum (M:Al mole ratio, M:Al MR) generally ranges from at least 0.1, or at least 0.25, or at least 0.5, or at least 0.75, or at least 1, or at least 2, and up to about 75, up to about 50, up to about 25, up to about 20, up to about 15, up to about 10, or up to about 8, or up to about 6, or up to about 5.

The weight of aluminum and alkaline earth metal or alkali metal can be measured by analytical techniques for detecting the amount in the finished PET polymer or article. Suitable detection methods for the presence of aluminum and alkali metals or alkaline earth metals include inductively coupled plasma optical emission spectroscopy (ICP). While X-ray fluorescence spectroscopy (XRF) is a suitable detection method for some alkaline earth metals and some alkali metals, it may not be suitable for detecting aluminum at lower levels, like those found in PET polymer. As used herein, the concentration of an alkaline earth metal or an alkali metal is reported as the parts per million of metal atoms based on the weight of the PET polymer.

The aluminum and alkali or alkaline earth metals may be added as a solution, fine dispersion, a paste, a slurry, or neat. They are preferably added as a liquid, a melt, or a free flowing solid which can be metered. Most preferably they are added as a liquid, and in particular as a liquid solution or dispersion.

To avoid potential undesirable side reactions between aluminum catalyst and water generated in the esterification zone which may inhibit or deactivate the aluminum catalyst and thereby slow down the rate of polycondensation, it is desirable to add the aluminum compounds after substantial completion of the esterification reaction or at the beginning of or during polycondensation. In a further embodiment, at least 75%, or at least 85%, or at least 95% of the esterification reaction (in terms of conversion) is conducted in the absence of added aluminum compounds. It is desirable to add the aluminum compound and the alkali metal or alkaline earth metal compound at or near the same addition point. It is most desirable to premix and heat the aluminum compound and the alkali metal or alkaline earth metal compound, like in a catalyst mix tank, prior to addition to the melt phase manufacturing line for PET polymers.

Other catalyst metals may be present, if desired. For example, Mn, Zn, Sb, Co, Ti, and/or Ge catalysts may be used in conjunction with aluminum and alkaline earth metals or alkali catalysts. Titanium catalysts can be used, particularly if melt phase manufacture involves ester exchange reactions, or the reactions may be carried out in the substantial absence of titanium. Suitable titanium catalysts include those compounds added in amounts which increase the lt.V. of the PET polymer melt by at least 0.3 dL/g, if not deactivated, under the operating conditions used to make the polyester polymer.

In one aspect, the amount of antimony may be limited, or antimony may be absent from the reaction mixture. Thus, the amount of antimony present may be, for example, 0 ppm, that is, the reactions may be carried out in the absence of antimony. Alternatively, the amount of antimony present may be no more than 10 ppm, or no more than 20 ppm, or no more than 40 ppm, or no more than 60 ppm, in each case based on the weight of the one or more polyethylene terephthalate homopolymers or copolymers. Without wishing to be bound by any theory, we believe that the presence of antimony may interfere with the oxygen-scavenging results of the inventive blends, and that polyesters made using the catalyst systems described herein may have substantially improved oxygen-scavenging effect when compared with polyesters or blends containing substantial amounts of antimony.

In another aspect, antimony may be used as a catalyst, or as a reheat additive, or both, in amounts for example, from about 5 ppm to about 30 ppm, or from about 10 ppm to about 20 ppm.

Typically, the titanium catalyst added during ester exchange will be deactivated prior to polycondensing the resulting oligomer mixture since, left untreated before polycondensing, the titanium catalyst may discolor the polymer due to its high activity, which includes side reactions. However, if desired, small quantities of active titanium catalysts may be present with the catalyst system of the invention. The amount of titanium catalyst, if used, generally ranges from 2 ppm to 15 ppm, based on the weight of the PET polymer. Antimony catalysts can also be used in combination with the catalyst system of the invention. The amount of antimony can range, for example, from 20 ppm to 250 ppm.

Preferably, the PET polymers of the inventive polymer blends are made without the addition of titanium, cobalt, or antimony to the melt phase reaction, or even without the addition of any catalytically active metal or metal compounds to the melt phase reaction other than the aluminum/alkali metal or alkaline earth or alkali system (e.g., for measurement purposes compounds are catalytically active if they increase the reaction rate or increase the lt.V. by at least 0.1 dL/g from a starting point of 0.2 to 0.4 dL/g after 1 hour at 280° C. and 0.8 mm Hg with agitation). It is to be recognized, however, that one or more of metals such as cobalt or manganese will most likely be present at low levels in the melt because they come as impurities with the terephthalic acid composition made from a metal-catalyzed, liquid-phase oxidation process. Of course, the inventive blends of the invention may contain a transition metal provided to the blend as an oxidation catalyst. It may be best to add such transition metal either late in the polymerization process, or even during the blending to produce the inventive blends.

The PET polymers suitable for use in the inventive blends may also contain a catalyst deactivator. By a catalyst deactivator we mean a compound effective to at least partially deactivate or inhibit the activity of the catalyst system. A compound is effective to at least partially deactivate the catalyst system when by its addition at a given level, and solely for testing the effectiveness of a compound at a given level, when either or both a) the rate of solid-stating under actual operating conditions is reduced relative to the same polymer without the deactivator (“no additive case”) and/or b) when added earlier, the rate of melt-phase polycondensation under actual operating conditions to a constant lt.V. target is reduced, that is, it takes more time to reach the lt.V. target, or the lt.V. of the polymer is reduced at constant time relative to the no additive case. The catalyst deactivator may also reduce the rate of AA generation upon melting particles relative to the no additive case to lower the contribution of AA generation on AA levels in a molded article, such as a preform, relative to a no additive case, and preferably upon melting particles having an lt.V. of at least 0.72 dL/g obtained from a melt phase polymerization.

The catalyst deactivator is typically added late during the process of manufacturing the PET polymer melt in order to limit the activity of catalyst system during subsequent melt processing steps, in which the catalyst system would otherwise catalyze the conversion of acetaldehyde precursors present in the PET polymer particles to acetaldehyde and/or catalyze the formation of more AA precursors and their subsequent conversion to AA. Left untreated, the PET polymer would have a high acetaldehyde generation rate during extrusion or injection molding, thereby contributing to an increase in the AA levels in articles made from the polymer melt. The stabilizer or deactivator can also help thermally stabilize the PET polymer melt near the end of melt phase polycondensation and during remelting which occurs, for example, during melt blending and processing the inventive polymer blends into articles, without which more reactions would occur to cleave the polymer chains in the highly viscous melt, a route to forming more AA precursors and ultimately, more AA. The catalyst deactivator is not added along with the addition of aluminum compounds or alkali metal compounds or alkaline earth metal compounds or alkali compounds, nor is it added at the commencement of polycondensation because it would inhibit the catalytic activity of the metal catalysts and hence, the rate of polycondensation. It should be noted, however, that not all types or forms of phosphorus compounds are deactivators, and if they are not, they may, if desired, be added along with the catalyst or at the commencement of polycondensation.

Suitable deactivating compounds are preferably phosphorus-containing compounds, for example phosphate triesters, acidic phosphorus compounds or their ester derivatives, and amine salts of acidic phosphorus containing compounds. Acidic phosphorus compounds have at least one oxyacid group, that is, at least one phosphorus atom double-bonded to oxygen and single-bonded to at least one hydroxyl or OH group. The number of acidic groups increases as the number of hydroxyl groups, bound to the phosphorus atom that is double-bonded to oxygen, increases. Specific examples of phosphorus compounds include phosphoric acid, pyrophosphoric acid, phosphorous acid, polyphosphoric acid, carboxyphosphonic acids, alkylphosphonic acids, phosphonic acid derivatives, and each of their acidic salts and acidic esters and derivatives, including acidic phosphate esters such as phosphate mono- and di-esters and non-acidic phosphate esters (e.g., phosphate tri-esters) such as trimethyl phosphate, triethyl phosphate, tributyl phosphate, tributoxyethyl phosphate, tris(2-ethylhexyl)phosphate, oligomeric phosphate tri-esters, trioctyl phosphate, triphenyl phosphate, tritolyl phosphate, (tris)ethylene glycol phosphate, triethyl phosphonoacetate, dimethyl methyl phosphonate, tetraisopropyl methylenediphosphonate, mono-, di-, and tri-esters of phosphoric acid with ethylene glycol, diethylene glycol, or 2-ethylhexanol, or mixtures of each. Other examples include distearylpentaerythritol diphosphite, mono- and di-hydrogen phosphate compounds, phosphite compounds, certain inorganic phosphorus compounds that are preferably soluble in the polymer melt, poly(ethylene)hydrogen phosphate, and silyl phosphates. Haze in solutions of particles or in molded parts is one indication of the lack of solubility or limited solubility of an additive in the polymer melt. Soluble additives are more likely to deactivate/stabilize the catalyst system.

Other phosphorus compounds which may be added include the amine salts of acidic phosphorus compounds. The amines may be cyclic or acyclic, may be monomeric, oligomeric, or polymeric, and should be selected so as to minimize haze and/or maximize solubility when these are issues. The organic constituents of the amine may in principle be any organic group. Ammonia and related compounds like ammonium hydroxide are suitable.

Suitable organic groups on the amine include linear and branched alkyl, cycloalkyl, aryl, aralkyl, alkaryl, heteroaryl, etc. Each of these types of organic groups may be substituted or unsubstituted (e.g., with hydroxy, carboxy, alkoxy, halo, and like groups). The organic groups may also contain carbonate, keto, ether, and thioether linkages, as well as amide, ester, sulfoxide, sulfone, epoxy, and the like. This list is illustrative and not limiting.

Preferred amines are cyclic amines having a 5 to 7 membered ring, preferably a six membered ring. These rings may constitute a single “monomeric” species, or may be part of a larger oligomer or polymer.

Preferred cyclic amines are hindered amines which have organic groups substituted at ring positions adjacent to the ring nitrogen. The ring nitrogen itself may also be substituted (e.g., by alkyl, aryl, aralkyl, alkaryl, and other groups). The hindered amines may also comprise a portion of an oligomeric moiety or polymeric moiety.

Another type of preferred amines are amino acids. Amino acids with decomposition points at or above polymerization temperatures are especially preferred. The L-enantiomer, the D-enantiomer or any mixture thereof, including racemic mixtures, may be used. The amine group and the carboxylic acid group do not have to be attached to the same carbon. The amino acids may be alpha, beta or gamma. Substituted amino acids may be used. Amino acids with some solubility in water are especially preferred as this allows the synthesis of the salt to be done in water, that is, without VOC's (volatile organic compounds).

The quantity of phosphorus compound or other catalyst deactivator used in this process is effective to reduce the amount of AA generated upon remelting the polymer produced in the melt phase by partially or fully deactivating the catalytic activity of the combination of the (i) aluminum atoms and (ii) the alkaline earth metal atoms or alkali metal atoms or alkali compound residues. Typical amounts of phosphorus atoms will be at least 15 ppm, or at least 50 ppm, or at least 100 ppm.

The cumulative amount of aluminum, alkali or alkaline earth metals, and any other catalyst metals present in the melt should be considered. The ratio of the moles of phosphorus to the total moles of aluminum and alkaline earth metal and/or alkali metal (P:M MR where M is deemed to be the sum of the moles of aluminum, the moles of alkaline earth metals, if present and the moles of alkali metals, if present, and where MR stands for mole ratio) is generally at least 0.1:1, or at least 0.3:1, or at least 0.5:1, or at least 0.7:1, or at least 1:1, and up to about 5:1, or more preferably up to about 3:1, or up to 2:1, or up to 1.8:1, or up to 1.5:1. Large quantities of phosphorus compounds should be avoided to minimize the loss in polymer lt.V. upon addition of the phosphorus compound to the polyester melt. A suitable range for P:M MR is 0.5 to 1.5.

Compounds of metals other than aluminum, alkali metals and alkaline earth metals also react with phosphorus compounds. If, in addition to compounds of aluminum, alkali metals and/or alkaline earth metals, other metal compounds that react with phosphorus compounds are present, then the amount of phosphorus compound added late is desirably in excess of that required to achieve the targeted P:M MR to ensure that the phosphorus compounds react or combine with all reactive metals present.

The polyester polymers useful for the inventive polymer blends contain aluminum atoms within a range of 5 ppm to 100 ppm, or 7 to 60 ppm, or 10 ppm to 30 ppm, based on the weight of the polyester polymer, and the molar ratio of all alkaline earth metal and alkali metal atoms to the moles of aluminum atoms may be within a range of 0.5:1 to 6:1, or 1:1 to 5:1, or 2:1 to 4:1, and the P:M ratio ranges from 0.1:1 to 3:1, or 0.3:1 to 2:1, or 0.5:1 to 1.5:1.

If desired, a partial amount of phosphorus compound may be added early in the melt phase manufacturing process, such as at the initiation of polycondensation, and a final amount added late in the course of polycondensation or thereafter but before solidification as explained further below. To maximize polycondensation and/or production rates, the majority, or the bulk, or the whole of the phosphorus compound is added late to the melt phase manufacturing process.

The PET polymers may be made in a melt phase reaction comprising forming a polyester polymer melt in the presence of an aluminum compound and an alkali metal or an alkaline earth metal compound or alkali compound. At least a portion of the polycondensation reaction proceeds in the presence of the combination of an aluminum compound, and an alkali metal compound, alkaline earth metal compound, or alkali compound. The various ways in which aluminum compound, the alkali metal compound, the alkaline earth metal compound or alkali compound can be added, their order of addition, and their points of addition are described in U.S. patent application Ser. No. 11/495,431, incorporated herein by reference in its entirety and further elaborated upon below.

Polyester precursor reactants may be fed to an esterification reaction vessel where the first stage of the melt phase process is conducted. The esterification process proceeds by direct esterification or by ester exchange reactions, also known as transesterification. In the second stage of the melt phase process, the oligomer mixture formed during esterification is polycondensed to form a polyester melt. The molecular weight of the melt continues to be increased in the melt phase process to the desired lt.V.

To further illustrate, a mixture of one or more dicarboxylic acids, preferably aromatic dicarboxylic acids, or ester forming derivatives thereof, and one or more diols, such as ethylene glycol, are continuously fed to an esterification reactor operated at a temperature of between about 200° C. and 300° C., and at a super-atmospheric pressure of between about 1 psig up to about 70 psig. The residence time of the reactants typically ranges from about one to about five hours. Normally, the dicarboxylic acid(s) is directly esterified with diol(s) at elevated pressure and at a temperature of about 240° C. to about 285° C. The esterification reaction is continued until an acid or ester group conversion of at least 70% is achieved, but more typically until an acid or ester group conversion of at least 85% is achieved to make the desired oligomeric mixture (or otherwise also known as the “monomer”).

The resulting oligomeric mixture formed in the esterification zone (which includes direct esterification and ester exchange processes) includes bis(2-hydroxyethyl)terephthalate (BHET) monomer, low molecular weight oligomers, DEG, and trace amounts of condensation by-product not totally removed in the esterification zone, along with other trace impurities from the raw materials and/or possibly formed by catalyzed side reactions, and other optionally added compounds such as toners and stabilizers. The relative amounts of BHET and oligomeric species will vary depending on whether the process is a direct esterification process in which case the amount of oligomeric species are significant and even present as the major species, or an ester exchange process in which case the relative quantity of BHET predominates over the oligomeric species. Water is removed as the esterification reaction proceeds in order to drive the equilibrium toward the desired products. Methanol is removed as the ester exchange reaction of a dimethyl ester of a dicarboxylic acid proceeds in order to drive the equilibrium toward the desired products. The esterification zone typically produces the monomer and oligomer species, if any, continuously in a series of one or more reactors. Alternately, the monomer and oligomer species in the oligomeric mixture could be produced in one or more batch reactors. At this stage, the lt.V. is usually not measurable or is less than 0.1 dL/g. The average degree of polymerization of the molten oligomeric mixture is typically less than 15, and often less than 7.0.

The reaction to make the oligomeric mixture is otherwise preferably uncatalyzed in the direct esterification process and additionally catalyzed in ester exchange processes. Typical ester exchange catalysts which may be used in an ester exchange reaction include titanium compounds and tin compounds, zinc compounds, and manganese compounds, each used singly or in combination with each other. Alkali metal compounds, such as those of lithium or sodium, or alkaline earth compounds, such as those of magnesium or calcium, may also be used as ester exchange catalysts. Any other catalyst materials well known to those skilled in the art are suitable.

Titanium based catalysts present during the polycondensation reaction may negatively impact the b* by making the melt more yellow. While it is possible to deactivate the titanium based catalyst with a stabilizer after completing the ester exchange reaction and prior to commencing polycondensation, it is desirable to eliminate the potential for the negative influence of the titanium based catalyst on the b* color of the melt by conducting the direct esterification or ester exchange reactions in the absence of any added titanium containing compounds. Thus, in one aspect, the direct esterification or ester exchange reactions are carried out in the absence of titanium, or titanium is present in an amount, for example, of no more than 1 ppm, or no more than 3 ppm, or no more than 5 ppm, or no more than 10 ppm, in each case with respect to the weight of the melt. Suitable alternative ester exchange catalysts include zinc compounds, manganese compounds, or mixtures thereof.

Once the oligomeric mixture is made to the desired percent conversion of the acid or ester groups, it is transported from the esterification zone or reactors to the polycondensation zone. The commencement of the polycondensation reaction is generally marked by either a higher actual operating temperature than the operating temperature in the esterification zone, or a marked reduction in pressure (usually sub-atmospheric) compared to the esterification zone, or both. Typical polycondensation reactions occur at temperatures ranging from about 260° C. to 300° C., and at sub-atmospheric pressure of about 350 mmHg to 0.2 mm Hg. The residence time of the reactants typically ranges from about 2 to about 6 hours. In the polycondensation reaction, a significant amount of glycol is evolved by the condensation of the oligomeric ester species and during the course of molecular weight build-up.

In some processes, polycondensation reactions are initiated and continued in the melt phase in a prepolymerization zone and finished in the melt phase in a finishing zone, after which the melt is solidified to form the polyester polymer melt phase product, generally in the form of chips, pellets, or any other shape. Each zone may comprise a series of one or more distinct reaction vessels operating at different conditions, or the zones may be combined into one reaction vessel using one or more sub-stages operating at different conditions in a single reactor. That is, the prepolymer stage can involve the use of one or more reactors operated continuously, one or more batch reactors, or even one or more reaction steps or sub-stages performed in a single reactor vessel. The residence time of the melt in the finishing zone relative to the residence time of the melt in the prepolymerization zone is not limited. For example, in some reactor designs, the prepolymerization zone represents the first half of polycondensation in terms of reaction time, while the finishing zone represents the second half of polycondensation. Other reactor designs may adjust the residence time between the finishing zone to the prepolymerization zone at about a 1.5:1 ratio or higher. A common distinction between the prepolymerization zone and the finishing zone in many designs is that the latter zone frequently operates at a higher temperature and/or lower pressure than the operating conditions in the prepolymerization zone. Generally, each of the prepolymerization and the finishing zones comprise one or a series of more than one reaction vessel, and the prepolymerization and finishing reactors are sequenced in a series as part of a continuous process for the manufacture of the polyester polymer.

The temperature applied to the polymer melt or of the polymer melt in at least a portion of the polycondensation zone is greater than 280° and up to about 290° C. Temperatures in the finishing zone may be, contrary to conventional practice, lower than 280° C. in order to avoid rapid increases in the rate of AA precursor formation. The pressure in the finishing zone may be within the range of about 0.2 to 20 mm Hg, or 0.2 to 10 mm Hg, or 0.2 to 2 mm Hg.

The alkaline earth metal or alkali compounds may, if desired, be added to the esterification zone before, during, or after completion of esterification, or between the esterification zone and polycondensation zone, or at a point when polycondensation starts. In one embodiment, the alkaline earth metal or alkali compounds are added before 50% conversion of the esterification reaction mixture. For example, the alkaline earth metal or alkali may be added between the esterification zone and inception of or during polycondensation or at the inception or during prepolymerization. Since the alkali metal or alkaline earth metal or alkali operates as part of the polycondensation catalyst system, it is desirable to add the alkali metal or alkaline earth metal or alkali compound to the polyester melt early in the polycondensation reaction to provide the benefit of shorter reaction time or a higher molecular weight build-up.

In the polymerization process, the polyester melt is formed by polycondensing the oligomer mixture in the presence of an aluminum compound. An aluminum compound may be added late to the esterification zone, to the oligomer mixture exiting the esterification zone, or at the start of polycondensation, or to the polyester melt during polycondensation, and preferably as noted above after at least about 75% conversion in the esterification zone. However, since aluminum operates as part of the polycondensation catalyst system, it is desirable to add aluminum to the polyester melt early in the polycondensation reaction to provide the benefit of shorter reaction time or a higher molecular weight build-up. An aluminum compound is added preferably when the percent conversion of the acid end groups is at least 75%, more preferably when the % conversion of the acid end groups is at least 85%, and most preferably when the % conversion of the acid end groups from esterification is at least 93%.

An aluminum compound may be added to the oligomer mixture upon or after completion of esterification or to a polyester melt no later than when the lt.V. of the melt reaches 0.3 dL/g, or no later than when the lt.V. of the melt reaches 0.2 dL/g, and more preferably to the oligomer mixture exiting the esterification zone or prior to commencing or at the start of polycondensation.

When the phosphorus compound is added to a melt phase polymerization process, the catalyst stabilizer is added to the polyester melt late during the course of polycondensation and before solidification. The deactivator is added to the polyester melt late in the course of the polycondensation reaction when one or more of the following conditions are satisfied or thereafter and before solidification of the polyester melt:
a) the polyester melt reaches an lt.V. of at least 0.50 dL/g or
b) vacuum applied to the polyester melt, if any, is released, at least partially, or
c) if the polyester melt is present in a melt phase polymerization process, adding the phosphorus compound within a final reactor for making the polyester polymer, near its discharge point, or between the final reactor and before a cutter for cutting the polyester melt, or
d) if the polyester melt is present in a melt phase polymerization process, following at least 85% of the time for polycondensing the polyester melt; or
e) the lt.V. of the polyester melt is within +/−0.15 dl/g of the lt.V. obtained upon solidification; or
f) at a point within 30 minutes or less, or 20 minutes or less of solidifying the polyester melt.

The deactivator may be added to the polyester melt after the polyester melt obtains an lt.V. of at least 0.50 dL/g, or at least 0.55 dL/g, or at least 0.60 dL/g, or at least 0.65 dL/g, or at least 0.68 dL/g, or at least 0.70 dL/g, or at least 0.72 dL/g or at least 0.76 dL/g, or at least 0.78 dL/g, and most preferably, regardless of when the deactivator is added, the resulting polymer exiting the melt phase manufacture has an lt.V. of at least 0.68 dL/g or at least 0.72 dL/g or at least 0.76 dL/g.

The deactivator may be added to the polyester melt when the lt.V. of the polyester melt is within 0.15 dL/g, or within 0.10 dL/g, or within 0.05 dl/g, or within 0.030 dL/g, or within 0.02 of the lt.V. obtained upon solidification. For example, the polyester melt could have an lt.V. that is 0.10 dL/g below the lt.V. obtained upon solidification, or it could have an lt.V. that is 0.10 dL/g above the lt.V. obtained upon solidification.

The deactivator may be added to the polyester melt at a point within 30 minutes or less, within 20 minutes or less, or within 10 minutes or less, or 5 minutes or less, or 3 minutes or less of solidifying the polyester melt. The solidification of the polyester melt typically occurs when the melt is forced through a die plate into a water bath and cut into pellets, or in a melt-to-mold process when the melt is injection molded into a molded article. In the broadest sense, solidification occurs when the temperature of the polymer melt is cooled below the crystalline melting temperature of the polymer.

The reaction time of the melt from an lt.V. of 0.40 dL/g through and up to an lt.V. in the range of at least 0.68 dL/g to 0.94 dL/g is preferably 240 minutes or less, 210 minutes or less, 180 minutes or less, 150 minutes or less, or 120 minutes or less, or 90 minutes or less, or 50 minutes or less. During the times stated, the vacuum applied is preferably between 0.5 and 1.0 mm Hg, the temperature is preferably between 275° C. to 295° C. The target lt.V. is preferably between 0.82 and 0.92 dL/g prior to deactivation/stabilization.

Once the polymer molecular weight is built to the desired degree, it is discharged from the final polycondensation reactor, in this case a finisher, to be pelletized. A gear pump may be utilized to facilitate funneling an amount of bulk polymer through a conduit to exit from the finishing vessel. Prior to cutting the molten polymer, and in another aspect, prior to exiting the melt phase final reactor, it may be desirable to combine the bulk polymer in the melt phase with a second stream that is a liquid (which includes a molten stream, dispersions, emulsions, homogeneous liquids, and heterogeneous slurries). The second stream can be introduced into the melt phase process at any stage prior to solidification, but preferably between the cutter and the entry into the final bulk polymer reactor (such as a finisher). The second stream may be introduced after the last half of the residence time within the final reactor and before the cutter.

The manner in which the second liquid stream is introduced and the source of the second liquid stream is not limited. For example, it may it may be desirable to treat and additionally process a portion of a slip stream. Once treated, the treated portion of a slip stream may be circulated back to the finishing tank. In another example, it may be desirable to introduce a slip stream (second liquid stream) into the finisher through an extruder or a pumping means from a source independent from or other than the bulk polymer produced in the melt phase process.

The catalyst deactivator may be added into a slip stream taken from the stream exiting the final polycondensation reactor and recirculated back into the final reactor or at a point before the slipstream is taken from the melt phase stream exiting the final reactor. In addition, other compounds such as UV inhibitors, colorants, reheat additives, or other additives can be added into a slipstream depending upon the fitness for use requirements of the polymer in its ultimate application. Any one or a mixture of these additives may be contained in the second liquid stream.

Crystallized polymers that are catalyzed by aluminum/alkaline earth metal or alkali metal systems tend to be brighter or have higher L* color values relative to crystallized polymers catalyzed by antimony systems under the same polymerization conditions. Moreover, the late addition of a phosphorus compound to polyester melts catalyzed by aluminum/alkaline earth metal or alkali metal systems produces polymers which when crystallized have even higher L* color values or higher brightness relative to the no phosphorus case, which may have somewhat higher lt.V. For example, the crystallized polyester polymers obtained by the process of the invention have an L* of at least 55, or at least 60, or at least, 65, or at least 70.

Once the desired lt.V. is obtained, the molten polyester polymer in the melt phase reactors may be discharged as a melt phase product and solidified.

The melt phase product is processed to a desired form, such as amorphous particles; however, crystallized pellets are preferred. The shape of the polyester polymer particles is not limited, and can include regular or irregular shaped discrete particles without limitation on their dimensions, including stars, spheres, spheroids, globoids, cylindrically shaped pellets, conventional pellets, pastilles, and any other shape, but particles are distinguished from a sheet, film, preforms, strands or fibers.

The method for solidifying the polyester polymer from the melt phase process is not limited. For example, molten polyester polymer from the melt phase process may be directed through a die, or merely cut, or both directed through a die followed by cutting the molten polymer. A gear pump may be used as the motive force to drive the molten polyester polymer through the die. Instead of using a gear pump, the molten polyester polymer may be fed into a single or twin screw extruder and extruded through a die, optionally at a temperature of 190° C. or more at the extruder nozzle. Once through the die, the polyester polymer can be drawn into strands, contacted with a cool fluid, and cut into pellets, or the polymer can be pelletized at the die head, optionally underwater. The polyester polymer melt is optionally filtered to remove particulates over a designated size before being cut. Any conventional hot pelletization or dicing method and apparatus can be used, including but not limited to dicing, strand pelletizing and strand (forced conveyance) pelletizing, pastillators, water ring pelletizers, hot face pelletizers, underwater pelletizers and centrifuged pelletizers.

The polyester polymer is one which is crystallizable. The method and apparatus used to crystallize the polyester polymer is not limited, and includes thermal crystallization in a gas or liquid. The crystallization may occur in a mechanically agitated vessel; a fluidized bed; a bed agitated by fluid movement; an un-agitated vessel or pipe; crystallized in a liquid medium above the T_{g} of the polyester polymer, preferably at 140° C. to 190° C.; or any other means known in the art. Also, the polymer may be strain crystallized. The polymer may also be fed to a crystallizer at a polymer temperature below its T_{g} (from the glass), or it may be fed to a crystallizer at a polymer temperature above its T_{g}. For example, molten polymer from the melt phase polymerization reactor may be fed through a die plate and cut underwater and then immediately fed to a thermal crystallizer without cooling the bulk temperature of the polymer pellet below its Tg. Alternatively, the molten polymer may be cut, allowed to cool to below its T_{g}, and then fed to an underwater thermal crystallization apparatus or any other suitable crystallization apparatus. Or, the molten polymer may be cut in any conventional manner, allowed to cool to below its T_{g}, optionally stored, and then crystallized.

In addition, certain agents which colorize the polymer can be added to the melt. In one embodiment, a bluing toner is added to the melt in order to reduce the b* of the resulting polyester polymer melt phase product. Such bluing agents include blue inorganic and organic toners. In addition, red toners can also be used to adjust the a* color. Organic toners, e.g., blue and red organic toners, such as those toners described in U.S. Pat. Nos. 5,372,864 and 5,384,377, which are incorporated by reference in their entirety, can be used. The organic toners can be fed as a premix composition. The premix composition may be a neat blend of the red and blue compounds or the composition may be pre-dissolved or slurried in one of the polyester's raw materials, e.g., ethylene glycol.

Examples of reheat additives (a reheat additive is deemed a compound added to the melt in contrast to forming a reheat aid in situ) include activated carbon, carbon black, antimony metal, tin, titanium nitride, titanium, copper, silver, gold, palladium, platinum, black iron oxide, and the like, as well as near infrared absorbing dyes, including, but not limited to those disclosed in U.S. Pat. No. 6,197,851 which is incorporated herein by reference.

Titanium nitride particles may be added as a reheat additive at any point during polymerization of the PET polymers, or afterward, including to the esterification zone, to the polycondensation zone comprised of the prepolymer zone and the finishing zone, to or prior to the pelletizing zone, and at any point between or among these zones. The titanium nitride particles may also be added to solid-stated pellets as they are exiting the solid-stating reactor. Furthermore, the titanium nitride particles may be added to the PET pellets in combination with other feeds to the injection molding machine, or may be fed separately to the injection molding machine. For clarification, the particles may be added in the melt phase or to an injection molding machine without solidifying and isolating the polyester composition into pellets. Thus, the particles can also be added in a melt-to-mold process at any point in the process for making the preforms. In each instance at a point of addition, the particles can be added as a powder neat, or in a liquid, or a polymer concentrate, and can be added to virgin or recycled PET, or added as a polymer concentrate using virgin or recycled PET as the PET polymer carrier.

The titanium nitride particles may have an average particle size, for example, from about 1 nm to about 1,000 nm, or from 1 nm to 300 nm, or from 1 nm to 100 nm, or from 5 nm to 30 nm, and may be present in the polymer blends of the invention in amounts, for example, from about 0.5 ppm to about 1,000 ppm, or from 1 ppm to 200, or from 1 ppm to 50 ppm.

Articles can be formed from the inventive blends by any conventional techniques known to those of skill. For example, the blends are fed to a machine for melt extruding and injection molding the melt into shapes such as preforms suitable for stretch-blow molding into beverage or food containers, or a machine for injection molding, or a machine for merely extruding into other forms such as sheet. Suitable processes for forming the articles are known and include extrusion, extrusion blow molding, melt casting, injection molding, a melt to mold process, stretch-blow molding (SBM), thermoforming, and the like.

Examples of the kinds of shaped articles which can be formed include sheet; film; packaging and containers such as preforms, bottles, jars, and trays; rods; tubes; lids; and filaments and fibers. Beverage bottles made from polyethylene terephthalate suitable for holding water or carbonated beverages, and heat-set beverage bottles suitable for holding beverages which are hot filled into the bottles are examples of the types of bottles which are made from the inventive blends of the invention. Examples of trays are those which are dual ovenable and other CPET trays.

Suitable methods for making articles comprise introducing the inventive blends or components of the inventive blends into a melt processing zone and melting the particles to form a molten polyester polymer composition; and forming an article comprising a sheet, strand, fiber, or a molded part from the molten polymer composition.

This invention can be further illustrated by the additional examples of embodiments thereof, although it will be understood that these examples are included merely for purposes of illustration and are not intended to limit the scope of the invention.

### EXAMPLES

### Example 1

In this example, four polymer blends were prepared (Polymer Blends 1-4), using the PET polymers described below. Note that Polymer Blends 3 and 4 differed even though the same PET polymer was used because different quantities of cobalt were added. The metal quantities given were determined by Inductively Coupled Plasma Optical Emission Spectroscopy (ICP) and are set forth in Table 1A.

PET-1 was a PET copolymer containing residues of dimethyl terephthalate, ethylene glycol, and cyclohexane dimethanol, with cyclohexane dimethanol residues representing about 1.7 mole % of the diol residues. The polymer contained about 210 to 240 ppm antimony, about 85 to 95 ppm phosphorus, about 50 to 60 ppm manganese, and about 15 to 25 ppm titanium, all provided as catalysts; and further contained an iron-containing reheat additive, a UV dye, and red and blue toners. PET-1 was prepared by first transesterifying the dicarboxylic acid esters and diols in the presence of the manganese, antimony, and titanium catalysts. After transesterification, the phosphorus and other additives were introduced to the reaction mixture and the reaction mixture polycondensed to an intrinsic viscosity of about 0.625 dL/g. The molten PET was then solidified, pelletized, and the PET pellets were then solid-state polymerized to an intrinsic viscosity of about 0.78 to about 0.82 dl/g.

PET-2 was a PET copolymer containing residues of dimethyl terephthalate, ethylene glycol, and cyclohexane dimethanol, with cyclohexane dimethanol residues representing about 1.8 mole % of the diol residues. The polymer contained about 215 to 245 ppm antimony, about 45 to 55 ppm phosphorus, and about 60 to 70 ppm zinc, all provided as catalysts; and further contained an iron-containing reheat additive, a UV dye, and red and blue toners. PET-2 was prepared by first transesterifying the dicarboxylic acid esters and diols in the presence of zinc and antimony catalysts. After transesterification, the phosphorus and other additives were introduced to the reaction mixture and the reaction mixture polycondensed to an intrinsic viscosity of about 0.625 dL/g. The molten PET was then solidified, pelletized, and then solid-state polymerized to an intrinsic viscosity of about 0.76 to about 0.80 dl/g.

PET-3 was a PET copolymer containing residues of terephthalic acid, ethylene glycol, and isophthalic acid, with isophthalic acid residues representing about 2.9 mole % of the dicarboxylic acid residues. The polymer contained about 11 to 17 ppm Al, about 7 to 12 ppm Li, and about 45 to 55 ppm phosphorus, provided as a catalyst system; and included a reheat additive and red and blue toners. PET-3 was prepared by melt polymerizing the dicarboxylic acids and diol residues in the presence of the aluminum and lithium catalysts, reheat additive, and toners to an intrinsic viscosity of about 0.75 dL/g, after which the phosphorus was added and the molten PET was then solidified and pelletized.

The PET polymers also contained low levels (less than 5 mol %) of DEG residues, present as a natural byproduct of the melt polymerization process, or intentionally added as a modifier, for example to control the amount of DEG present in the final polymer.

The intrinsic viscosity (lt.V.) values described throughout this description are set forth in dL/g unit as calculated from the inherent viscosity (lh.V.) measured at 25° C. in 60/40 wt/wt phenol/tetrachloroethane. The inherent viscosity is calculated from the measured solution viscosity. The following equations describe these solution viscosity measurements, and subsequent calculations to lh.V. and from lh.V. to lt.V:

ηᵢₙₕ=[ln(tₛ/tₒ)]/C
where
   ηᵢₙₕ=Inherent viscosity at 25° C. at a polymer concentration of 0.50 g/100 mL of 60% phenol and 40% 1,1,2,2-tetrachloroethane
   ln=Natural logarithm
   tₛ=Sample flow time through a capillary tube
   tₒ=Solvent-blank flow time through a capillary tube
   C=Concentration of polymer in grams per 100 mL of solvent (0.50%)

The intrinsic viscosity is the limiting value at infinite dilution of the specific viscosity of a polymer. It is defined by the following equation:

ηᵢₙₜ=lim_{C→0}(ηₛₚ/C)=lim_{C→0}ln(ηᵣ/C)
where
   ηᵢₙₜ=Intrinsic viscosity
   ηᵣ=Relative viscosity=ts/to
   ηₛₚ=Specific viscosity=ηᵣ−1

Instrument calibration involves replicate testing of a standard reference material and then applying appropriate mathematical equations to produce the “accepted” l.V. values.

$$Calibration Factor = \frac{Accepted Ih . V . of Reference Material}{Average of Triplicate Determinations}$$

$$Corrected IhV = Calculated IhV \times Calibration Factor$$

The intrinsic viscosity (lt.V. or ηᵢₙₜ) may be estimated using the Billmeyer equation as follows:

ηᵢₙₜ=0.5[e^{0.5×Corrected lh.V.}−1]+(0.75×Corrected lh.V.)

The cobalt concentrate used was a solid concentrate prepared by melt-blending 1.8 wt percent cobalt neodeconate (sold as “22.5% TEN-CEM cobalt” by OMG Americas, Westlake, Ohio) with 98.2 wt percent polyethylene terephthalate polymer (sold as “PJ003” by Eastman Chemical Company). X-ray analysis confirmed that the cobalt concentrate contained 4200 ppm cobalt metal.

The polyamide used was a poly(m-xylylene adipamide) commercially available as MXD-6™, grade 6007 from Mitsubishi Gas.

### Polymer Blend 1 (Comparative)

Polymer Blend 1 was prepared by separately grinding PET-1 (963 g), MXD-6™ (15 g), and cobalt concentrate (22.5 g) to pass through a 3 mm screen. PET-1 was dried in a desiccant dryer at 150° C. for 15 hours and the MXD-6™ and cobalt concentrate were dried at 60° C. for 3 days in a vacuum oven with nitrogen purge. Solid pellets of the respective materials and their amounts as identified in Table 1B were combined, dry-mixed, introduced into the feed hopper of a BOY 22D molding machine (Boy Machines Inc.; Exton, Pa.), and molded into preforms using a single-cavity, 25.7 gram preform mold. Processing conditions are given in Table 1C.

Preforms molded from Polymer Blend 1 were biaxially stretch-blown into 500 ml. round-bottom bottles using a custom-built reheat stretch-blow-molding machine. Bottle blowing conditions were adjusted to produce bottles exhibiting good clarity (i.e., absent haze and pearl due to preform stretch temperatures being too high or low, respectively) with similar material distribution as measured by sidewall thickness.

### Polymer Blend 2 (Comparative)

Polymer Blend 2 was prepared using PET-2 (963 g), MXD-6™ (15 g), and cobalt concentrate (22.5 g) as described above for Polymer Blend 1 (Table 1B). Polymer Blend 2 was injection-molded into performs and blown into bottles as described for Polymer Blend 1.

### Polymer Blend 3 (Inventive)

Polymer Blend 3 was prepared using PET-3 (974 g), MXD-6™ (15 g), and cobalt concentrate (11.25 g) as described above in Polymer Blend 1 (Table 1B). Polymer Blend 3 was injection-molded into preforms and blown into bottles as described for Polymer Blend 1.

### Polymer Blend 4 (Inventive)

Polymer Blend 4 was prepared using PET-3 (963 g), MXD-6™ (15 g), and cobalt concentrate (22.5 g) as described above in Polymer Blend 1 (Table 1B). Polymer Blend 3 was injection-molded into preforms and blown into bottles as described for Polymer Blend 1.

The ability of Polymer Blends 1 through 4 to scavenge oxygen was evaluated using two different test protocols: (1) the OxySense Test, and (2) by measuring the oxygen transmission rate as a function of time (i.e., OTR vs days since blowing bottle) of a sealed bottle blown from the respective Polymer Blends. The OxySense Test was used as a screening test conducted at a temperature of 75° C., which is much higher than typical bottle storage temperatures, in order to obtain a quick, qualitative assessment of the oxygen-scavenging characteristics of a sample. However, the OxySense Test exhibits a low signal-to-noise ratio and is used as a rough approximation of oxygen-scavenging ability when comparing samples having widely different oxygen-scavenging characteristics. On the other hand, OTR has a significantly higher signal-to-noise ratio and is therefore a better test to assess oxygen-scavenging performance over an extended period of at least 60 days.

Additionally, the OTR test is done on stretch-blown bottles (i.e., the finished article), whereas the OxySense tests evaluate ground samples.

### Oxygen Transmission Rate (OTR) Test

The oxygen transmission rate (OTR) test was performed using three stretch-blow-molded bottles prepared from each of Polymer Blends 1 through 4. The sets of three bottles were conditioned without capping under ambient conditions (i.e., about 22° C. and ambient humidity) for about one week after blow molding, then mounted, purged, and tested for OTR using the following procedure.

The bottles were fitted about one week following stretch-blow molding for oxygen transmission rate testing. Prior to measurement, each bottle was sealed by gluing to a brass plate that was connected to a 4 way valve over the finish. This mounting technique seals the bottle, while allowing for control of test gas access. The mounting was assembled as follows. First a brass plate was prepared by drilling two ⅛ inch holes into the plate. Two lengths of ⅛ soft copper tubing (designated A and B) were passed through the holes in the plate and the gaps between the holes and the tubes were sealed either with epoxy glue or by welding. One end of each of these tubes was attached to the appropriate ports on a 4-way ball valve (such as Whitey model B-43YF2). Tubing (designated C and D) and connections were also attached to the other ports of the ball valve to allow the finished assembly to be connected to an oxygen transmission rate test instrument (the OTR instrument is described below).

This mounting was then glued to the finish of the bottle to be tested so that tubes A and B extend into the interior of the bottle. The open end of one tube was positioned near the top of the package and the open end of the other was positioned near the bottom to ensure good circulation of the test gas within the bottle. Gluing of the bottle to the plate was typically performed in two steps using a quick-setting epoxy to make the initial seal and temporarily hold the assembly together, and then a second coating of a more rugged Metalset epoxy was applied. Optionally, the brass plate was sanded before mounting to clean the surface and improve adhesion. If the 4 tubes were correctly connected to the 4-way valve, then when the valve was in the “Bypass” position, tubes A and B communicated and tubes C and D communicated, but tubes A and B did not communicate with tubes C and D. Thus, the package was sealed. Similarly, when the valve was in its “Insert” position, tubes A and D communicated and tubes B and C communicated, but A and D did not communicate with tubes B and C, except through the interior of the bottle. Thus the bottle could be swept with purge or test gas.

Once the bottle was mounted on the assembly, it was swept with an oxygen-free gas, and the conditioning period begun. After several minutes of purging, the 4-way valve was moved to the Bypass position, sealing the bottle. At that point the entire bottle and mounting assembly could be disconnected from the purge gas supply without introducing oxygen into the interior of the bottle. Three bottles of each Polymer Blends-1 through -4 were mounted for testing.

When the oxygen transmission rate of the bottle was to be tested, the mounting was connected to the oxygen transmission rate instrument via tubes C and D. A custom-built instrument was used to perform the measurements on the samples discussed in the examples. Nitrogen, which is humidified using a bubbler, was supplied to the instrument and the tubing in the environmental chamber. The custom-built instrument used a Delta-F DF-310 process Oxygen analyzer as the oxygen sensor and an Aalborg Mass flow meter GFM17 to measure the ppm oxygen in and flow rate of the purge stream, from which the oxygen transmission rate through the package was calculated. The custom-built instrument has positions for up to 24 bottles to be connected to the instrument at one time. The unit was located in an environmental chamber, which under normal operations controls the external conditions at 23° C., plus or minus 0.5° C., and 50% relative humidity, plus or minus 10%. Once the bottle samples were mounted, the 4-way valve was turned to the Insert position and the system was allowed to recover from the perturbation caused by this process.

After allowing the system to recover, the test was then begun by “inserting” the instrument sensor in-line. The test sequences were controlled by specially written LabView™ software interfaces for the instrument, by means of which the instrument automatically advanced through the test cells using a preset interval that allowed the instrument to stabilize after each cell change as the test gas from the bottle mounted on the cell was routed through the sensor. The oxygen transmission rate into the carrier gas was calculated from the measured ppm oxygen in the gas and the measured flow rate of the carrier gas. Typically, the instrument was allowed to index through each of the cells 3 or more times and the average of the last 3 measurements was used. Once these readings were obtained, the 4-way valves were moved to their Bypass positions and this process was repeated, providing a measure of the leak rate for the cell and assembly. This value was subtracted from the value obtained for the package, cell, and assembly to yield the value for the package and was reported as the oxygen transmission rate (OTR) of the bottle (in cc(STP) or μl(STP) of oxygen/day). At this point, the test was terminated and the bottles were removed from the instrument (with the 4-way valves still in the Bypass position).

Between tests, bottles were stored at ambient (RH, lighting, barometric pressure) conditions in a lab (22° C. plus or minus 4° C.) with the interior isolated from air. After a period of time, the bottles were reconnected to the oxygen transmission rate test instrument and a new set of transmission measurements collected.

In this manner, it was possible to monitor the OTR behavior of the bottles over several weeks or months.

### OxySense Test

The oxygen-scavenging performance of Polymer Blends 1 through 4 were also evaluated using oxygen-uptake measurements obtained by means of an OxySense instrument (OxySense Inc. 1311 North Central Expressway, Suite 440 Dallas, Tex. 75243, USA). General principles of operation of the instrument are described in “An Exciting New Non-Invasive Technology for Measuring Oxygen in Sealed Packages the OxySense™ 101” D. Saini and M Desautel, in the Proceedings of Worldpak 2002, published by CRC Press, Boca Raton, Fla. (2002). The procedure used to evaluate the examples is described below.

Oxygen-sensitive “OxyDots” supplied by OxySense Inc. were glued to the interior of Wheaton prescored 20 ml glass ampoules (Wheaton #176782) using a silicone adhesive. Approximately 1 gram samples of Polymer Blends 1 through 4 were ground and placed into 20 ml ampoules. The stems of the ampoules were then sealed using standard glass-blowing techniques. The oxygen content in the gas phase in the ampoule was measured using the probe on the OxySense instrument to monitor the response of the OxyDot sealed in the ampoule. The instrument converted this reading to oxygen level in contact with the OxyDot. The sealed ampoules were then stored in an oven at 75° C. and the oxygen level in the headspace periodically monitored. OxySense results are reported as mbars O₂.

Along with the data generated for Polymer Blends 1 through 4, two controls were monitored: a 0% oxygen control in which an OxySense ampoule was charged with about 25 grams of Burdick and Jackson water (and about 0.8 grams of sodium sulfite to consume the oxygen present and to prevent bacterial growth), and a 21% oxygen control made by charging 5 grams of B & J water to an OxySense ampoule.

These calibration controls were sealed and calibrated to get a 0% and 21% control. All of the ampoules were measured by OxySense on the initial day, day “zero”, before going into an oven at 75° C. On the days the samples were tested, they were taken out of the oven, allowed to come to room temp, and then tested about 3 hours after removal from the oven.

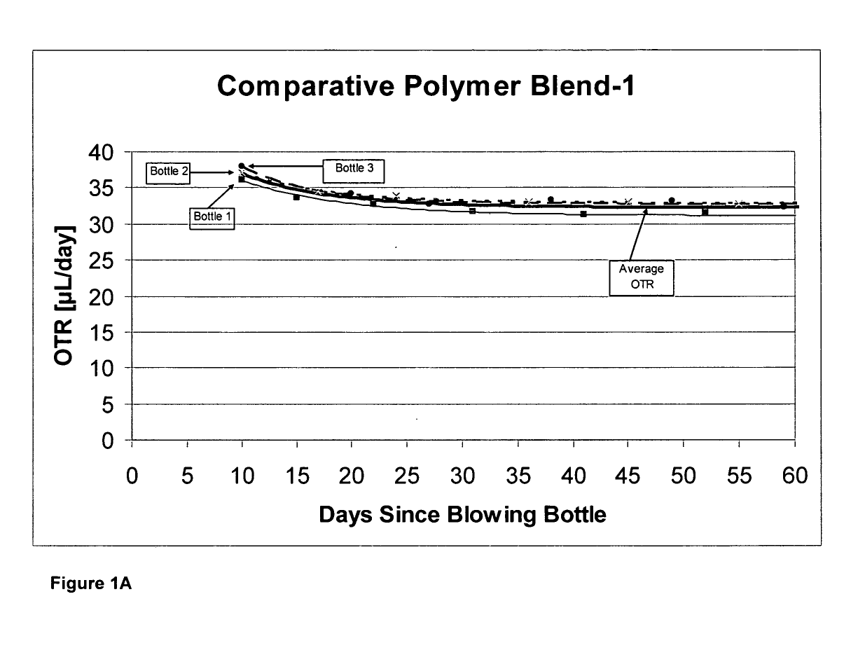

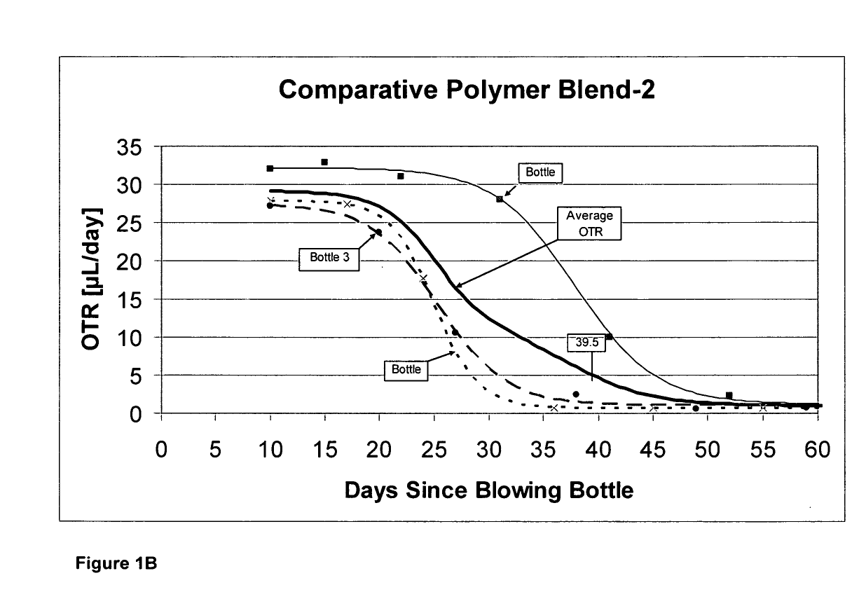

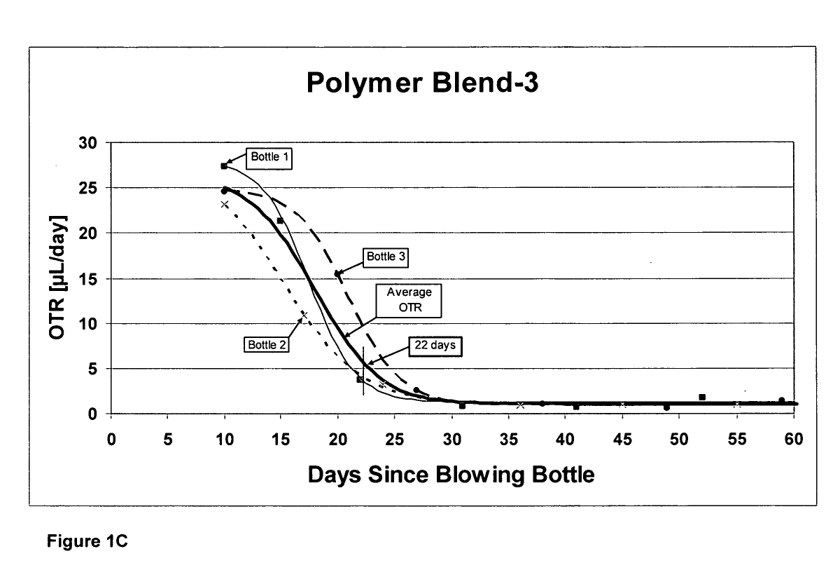

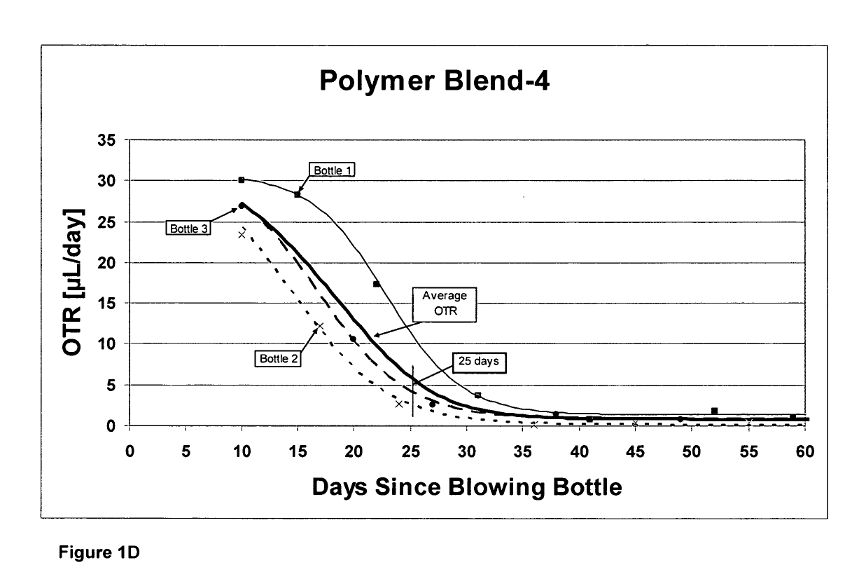

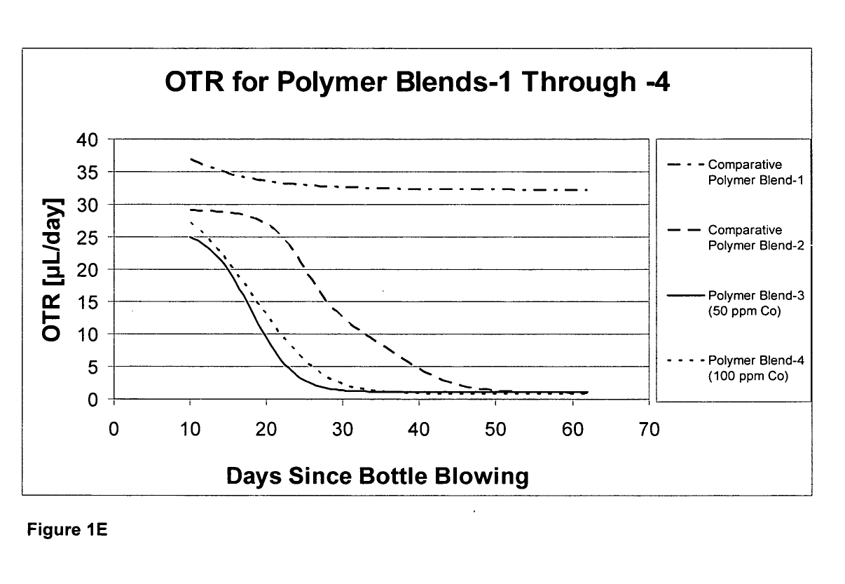

Three stretch-blown bottles prepared using each of the four Polymer Blends 1 through 4 were tested for OTR periodically for approximately 60-days following blow molding (Tables 1D). The OTR results for each set of three bottles are plotted in FIGS. 1A-1D, respectively, and each set of data corresponding to a single bottle has a non-linear curve superimposed over the OTR data. The x- and y-coordinates for the non-linear curves are reported in Tables 1E-1H allowing interpolation of the OTR (i.e., y-coordinates) for all “days-since-blowing” (i.e., x-coordinates) throughout the test period. For example, from Table 1E, the y-coordinates of the non-linear curves at 20 days gives an OTR of 32.76 μL/g, 34.12 μL/g, and 33.96 μL/g for the three respective values of Polymer Blend 2. By mathematically averaging the interpolated OTR values of the three bottles at day 20, an average OTR for Polymer Blend 2 at day 20 is calculated to be 33.62 μL/g. By mathematically averaging the OTR of the three bottles for all days-since-blow-molding (i.e., all x-coordinates) over the entire test period, an average OTR curve can be calculated for each of the Polymer Blends 1 through 4 (Tables 1E-1H and 1I and FIG. 1E).

Oxygen scavenging was also evaluated by the OxySense Test method using samples prepared by grinding five preforms of each of the four Polymer Blends 1 through 4, as described above. Replicate OxySense Test results are reported for each blend in Table 1J.

The oxygen transmission rate for inventive Polymer Blends 3 and 4, prepared using PET-3 (a aluminum- and lithium-catalyzed PET polymer prepared by melt-phase-only polymerization) exhibited shorter induction periods than comparative Polymer Blends 1 and 2 (Table 1K and FIG. 1E). Bottles prepared with the inventive Polymer Blends 3 and 4 reach an OTR of 5 μL/day in 22 and 25 days, respectively, whereas comparative Polymer Blends 1 and 2 require greater than 60 and 34 days, respectively, to achieve the same 5 μL/day (Table 1K and FIG. 1E).

TABLE 1A
Metals analysis of Polymer Blends 1 through 4

| | Metals [ppm] by ICP | | | | | | | | |
|---|---|---|---|---|---|---|---|---|---|
| | Li | Al | Co | Fe | Mn | Ti | Sb | P | Zn |
| Comparative Polymer | <0.2 | <2 | 89.2 | 16 | 59.3 | 21.8 | 248 | 104 | 1.9 |
| Blend-1 | | | | | | | | | |
| Comparative | <0.2 | <2 | 98.1 | 7.7 | <0.2 | 0.2 | 231 | 81.2 | 65.4 |
| Polymer Blend-2 | | | | | | | | | |
| Polymer Blend-3 | 10.0^{†} | 14.4 | 46.6 | 2 | 0.6 | 6.9 | 3.4 | 51.1 | 0.3 |
| Polymer Blend-4 | 9.4^{††} | 16.2 | 77 | <0.2 | <0.2 | 6 | 5.1 | 48 | 1.8 |

^{†}The reported value of lithium for Polymer Blend 3 was and average of replicate test results, 9.4 ppm and 10.6, respectively.
^{††}The reported value of lithium for Polymer Blend 4 was and average of replicate test results, 8.3 ppm and 10.5, respectively.

TABLE 1B
Composition of Polymer Blends 1 through 4

| | | | MXD-6 | Cobalt |
|---|---|---|---|---|
| | PET | PET | 6007 | Concentrate |
| Example | Polymer | [g] | [g] | [g] |
| Comparative Polymer Blend-1 | PET-1 | 963 | 15 | 22.5 |
| Comparative Polymer Blend-2 | PET-2 | 963 | 15 | 22.5 |
| Polymer Blend-3 | PET-3 | 974 | 15 | 11.25 |
| Polymer Blend-4 | PET-3 | 963 | 15 | 22.5 |

TABLE 1C
Boy 22D Setup for Molding Preforms

| Machine Parameter | Setting |
|---|---|
| Zone 1–3 Temperature (° C.) | 275–280 |
| Screw Speed (RPM) | 100 |
| Injection Pressure (PSIG) | 800 |
| Inject and Hold Time (sec) | 12 |
| Cooling Time (sec) | 13 |
| Total Cycle Time (sec) | 33 |

TABLE 1D
Oxygen Transmission Rate (OTR) for Polymer Blends 1 through 4

| | OTR | | | OTR | | | OTR | | | OTR | | |
|---|---|---|---|---|---|---|---|---|---|---|---|---|
| | for Polymer Blend-1 | | | for Polymer Blend-2 | | | for Polymer Blend-3 | | | for Polymer Blend-4 | | |
| Day | Bottle 1 | Bottle 2 | Bottle 3 | Bottle 1 | Bottle 2 | Bottle 3 | Bottle 1 | Bottle 2 | Bottle 3 | Bottle 1 | Bottle 2 | Bottle 3 |
| 10 | 36.02 | 37.13 | 37.9 | 32.04 | 27.92 | 27.16 | 27.28 | 23.11 | 24.59 | 30.01 | 23.48 | 26.82 |
| 15 | 33.57 | | | 32.86 | | | 21.35 | | | 28.26 | | |
| 17 | | 34.42 | | | 27.36 | | | 10.84 | | | 12.27 | |
| 20 | | | 34.16 | | | 23.65 | | | 15.38 | | | 10.61 |
| 22 | 32.71 | | | 31.03 | | | 3.65 | | | 17.35 | | |
| 24 | | 33.93 | | | 17.68 | | | 3.27 | | | 2.64 | |
| 27 | | | 32.7 | | | 10.59 | | | 2.51 | | | 2.51 |
| 31 | 31.69 | | | 28.06 | | | 0.85 | | | 3.64 | | |
| 36 | | 33.08 | | | 0.72 | | | 0.88 | | | 0.19 | |
| 38 | | | 33.31 | | | 2.5 | | | 1.01 | | | 1.37 |
| 41 | 31.27 | | | 9.96 | | | 0.75 | | | 0.73 | | |
| 45 | | 33.02 | | | 0.78 | | | 1.01 | | | 0.41 | |
| 49 | | | 33.11 | | | 0.6 | | | 0.62 | | | 0.77 |
| 52 | 31.55 | | | 2.24 | | | 1.76 | | | 1.79 | | |
| 55 | | 32.73 | | | 0.77 | | | 1.04 | | | 0.43 | |
| 59 | | | 32.29 | | | 0.76 | | | 1.41 | | | 1.07 |
| 62 | 30.74 | | | 0.89 | | | 1.6 | | | 1.57 | | |

TABLE 1E
Interpolated OTR for Polymer Blend 1

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-1 |
| 10 | 35.89 | 37.08 | 37.91 | 36.96 |
| 10.5 | 35.65 | 36.83 | 37.55 | 36.67 |
| 11 | 35.41 | 36.59 | 37.21 | 36.41 |
| 11.5 | 35.19 | 36.37 | 36.90 | 36.15 |
| 12 | 34.98 | 36.17 | 36.61 | 35.92 |
| 12.5 | 34.78 | 35.97 | 36.34 | 35.70 |
| 13 | 34.59 | 35.79 | 36.09 | 35.49 |
| 13.5 | 34.41 | 35.62 | 35.85 | 35.29 |
| 14 | 34.23 | 35.46 | 35.64 | 35.11 |
| 14.5 | 34.07 | 35.30 | 35.43 | 34.94 |
| 15 | 33.92 | 35.16 | 35.25 | 34.78 |
| 15.5 | 33.77 | 35.03 | 35.07 | 34.62 |
| 16 | 33.64 | 34.90 | 34.91 | 34.48 |
| 16.5 | 33.51 | 34.78 | 34.76 | 34.35 |
| 17 | 33.38 | 34.67 | 34.62 | 34.22 |
| 17.5 | 33.27 | 34.56 | 34.49 | 34.11 |
| 18 | 33.15 | 34.46 | 34.37 | 33.99 |
| 18.5 | 33.05 | 34.37 | 34.25 | 33.89 |
| 19 | 32.95 | 34.28 | 34.15 | 33.79 |
| 19.5 | 32.85 | 34.20 | 34.05 | 33.70 |
| 20 | 32.76 | 34.12 | 33.96 | 33.62 |
| 20.5 | 32.68 | 34.05 | 33.88 | 33.54 |
| 21 | 32.60 | 33.98 | 33.80 | 33.46 |
| 21.5 | 32.52 | 33.92 | 33.73 | 33.39 |
| 22 | 32.45 | 33.85 | 33.66 | 33.32 |
| 22.5 | 32.38 | 33.80 | 33.59 | 33.26 |
| 23 | 32.32 | 33.74 | 33.54 | 33.20 |
| 23.5 | 32.26 | 33.69 | 33.48 | 33.14 |
| 24 | 32.20 | 33.65 | 33.43 | 33.09 |
| 24.5 | 32.14 | 33.60 | 33.38 | 33.04 |
| 25 | 32.09 | 33.56 | 33.34 | 33.00 |
| 25.5 | 32.04 | 33.52 | 33.30 | 32.95 |
| 26 | 31.99 | 33.48 | 33.26 | 32.91 |
| 26.5 | 31.95 | 33.45 | 33.23 | 32.87 |
| 27 | 31.90 | 33.41 | 33.20 | 32.84 |
| 27.5 | 31.86 | 33.38 | 33.16 | 32.80 |
| 28 | 31.83 | 33.35 | 33.14 | 32.77 |
| 28.5 | 31.79 | 33.33 | 33.11 | 32.74 |
| 29 | 31.76 | 33.30 | 33.09 | 32.71 |
| 29.5 | 31.72 | 33.28 | 33.06 | 32.69 |
| 30 | 31.69 | 33.25 | 33.04 | 32.66 |
| 30.5 | 31.66 | 33.23 | 33.02 | 32.64 |
| 31 | 31.64 | 33.21 | 33.00 | 32.62 |
| 31.5 | 31.61 | 33.19 | 32.99 | 32.60 |
| 32 | 31.59 | 33.17 | 32.97 | 32.58 |
| 32.5 | 31.56 | 33.16 | 32.96 | 32.56 |
| 33 | 31.54 | 33.14 | 32.94 | 32.54 |
| 33.5 | 31.52 | 33.13 | 32.93 | 32.53 |
| 34 | 31.50 | 33.11 | 32.92 | 32.51 |
| 34.5 | 31.48 | 33.10 | 32.91 | 32.50 |
| 35 | 31.46 | 33.09 | 32.90 | 32.48 |
| 35.5 | 31.44 | 33.08 | 32.89 | 32.47 |
| 36 | 31.43 | 33.06 | 32.88 | 32.46 |
| 36.5 | 31.41 | 33.05 | 32.87 | 32.45 |
| 37 | 31.40 | 33.04 | 32.86 | 32.44 |
| 37.5 | 31.39 | 33.04 | 32.86 | 32.43 |
| 38 | 31.37 | 33.03 | 32.85 | 32.42 |
| 38.5 | 31.36 | 33.02 | 32.84 | 32.41 |
| 39 | 31.35 | 33.01 | 32.84 | 32.40 |
| 39.5 | 31.34 | 33.00 | 32.83 | 32.39 |
| 40 | 31.33 | 33.00 | 32.83 | 32.38 |
| 40.5 | 31.32 | 32.99 | 32.82 | 32.38 |
| 41 | 31.31 | 32.98 | 32.82 | 32.37 |
| 41.5 | 31.30 | 32.98 | 32.82 | 32.36 |
| 42 | 31.29 | 32.97 | 32.81 | 32.36 |
| 42.5 | 31.28 | 32.97 | 32.81 | 32.35 |
| 43 | 31.27 | 32.96 | 32.81 | 32.35 |
| 43.5 | 31.27 | 32.96 | 32.80 | 32.34 |
| 44 | 31.26 | 32.96 | 32.80 | 32.34 |
| 44.5 | 31.25 | 32.95 | 32.80 | 32.33 |
| 45 | 31.25 | 32.95 | 32.80 | 32.33 |
| 45.5 | 31.24 | 32.94 | 32.79 | 32.33 |
| 46 | 31.24 | 32.94 | 32.79 | 32.32 |
| 46.5 | 31.23 | 32.94 | 32.79 | 32.32 |
| 47 | 31.23 | 32.94 | 32.79 | 32.32 |
| 47.5 | 31.22 | 32.93 | 32.79 | 32.31 |
| 48 | 31.22 | 32.93 | 32.78 | 32.31 |
| 48.5 | 31.21 | 32.93 | 32.78 | 32.31 |
| 49 | 31.21 | 32.93 | 32.78 | 32.31 |
| 49.5 | 31.20 | 32.92 | 32.78 | 32.30 |
| 50 | 31.20 | 32.92 | 32.78 | 32.30 |
| 50.5 | 31.20 | 32.92 | 32.78 | 32.30 |
| 51 | 31.19 | 32.92 | 32.78 | 32.30 |
| 51.5 | 31.19 | 32.92 | 32.78 | 32.29 |
| 52 | 31.19 | 32.91 | 32.78 | 32.29 |
| 52.5 | 31.19 | 32.91 | 32.77 | 32.29 |
| 53 | 31.18 | 32.91 | 32.77 | 32.29 |
| 53.5 | 31.18 | 32.91 | 32.77 | 32.29 |
| 54 | 31.18 | 32.91 | 32.77 | 32.29 |
| 54.5 | 31.18 | 32.91 | 32.77 | 32.29 |
| 55 | 31.17 | 32.91 | 32.77 | 32.28 |
| 55.5 | 31.17 | 32.91 | 32.77 | 32.28 |
| 56 | 31.17 | 32.91 | 32.77 | 32.28 |
| 56.5 | 31.17 | 32.90 | 32.77 | 32.28 |
| 57 | 31.17 | 32.90 | 32.77 | 32.28 |
| 57.5 | 31.16 | 32.90 | 32.77 | 32.28 |
| 58 | 31.16 | 32.90 | 32.77 | 32.28 |
| 58.5 | 31.16 | 32.90 | 32.77 | 32.28 |
| 59 | 31.16 | 32.90 | 32.77 | 32.28 |
| 59.5 | 31.16 | 32.90 | 32.77 | 32.28 |
| 60 | 31.16 | 32.90 | 32.77 | 32.28 |
| 60.5 | 31.16 | 32.90 | 32.77 | 32.27 |
| 61 | 31.16 | 32.90 | 32.77 | 32.27 |
| 61.5 | 31.15 | 32.90 | 32.77 | 32.27 |
| 62 | 31.15 | 32.90 | 32.77 | 32.27 |

TABLE 1F
Interpolated OTR for Polymer Blend 2

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-2 |
| 10 | 32.18 | 27.88 | 27.28 | 29.11 |
| 10.5 | 32.18 | 27.87 | 27.25 | 29.10 |
| 11 | 32.17 | 27.87 | 27.21 | 29.08 |
| 11.5 | 32.17 | 27.86 | 27.17 | 29.07 |
| 12 | 32.17 | 27.85 | 27.11 | 29.04 |
| 12.5 | 32.16 | 27.84 | 27.05 | 29.02 |
| 13 | 32.16 | 27.83 | 26.98 | 28.99 |
| 13.5 | 32.15 | 27.81 | 26.90 | 28.95 |
| 14 | 32.15 | 27.78 | 26.80 | 28.91 |
| 14.5 | 32.14 | 27.75 | 26.69 | 28.86 |
| 15 | 32.13 | 27.71 | 26.56 | 28.80 |
| 15.5 | 32.12 | 27.66 | 26.41 | 28.73 |
| 16 | 32.11 | 27.60 | 26.23 | 28.65 |
| 16.5 | 32.10 | 27.51 | 26.02 | 28.55 |
| 17 | 32.09 | 27.41 | 25.79 | 28.43 |
| 17.5 | 32.07 | 27.27 | 25.51 | 28.29 |
| 18 | 32.05 | 27.10 | 25.20 | 28.12 |
| 18.5 | 32.03 | 26.88 | 24.84 | 27.92 |
| 19 | 32.01 | 26.61 | 24.44 | 27.68 |
| 19.5 | 31.98 | 26.27 | 23.97 | 27.41 |
| 20 | 31.95 | 25.84 | 23.45 | 27.08 |
| 20.5 | 31.91 | 25.32 | 22.87 | 26.70 |
| 21 | 31.87 | 24.67 | 22.23 | 26.26 |
| 21.5 | 31.82 | 23.89 | 21.51 | 25.74 |
| 22 | 31.77 | 22.96 | 20.73 | 25.16 |
| 22.5 | 31.71 | 21.87 | 19.89 | 24.49 |
| 23 | 31.64 | 20.62 | 18.99 | 23.75 |
| 23.5 | 31.56 | 19.21 | 18.03 | 22.94 |
| 24 | 31.47 | 17.67 | 17.03 | 22.06 |
| 24.5 | 31.37 | 16.04 | 16.00 | 21.13 |
| 25 | 31.25 | 14.35 | 14.94 | 20.18 |
| 25.5 | 31.12 | 12.66 | 13.87 | 19.22 |
| 26 | 30.96 | 11.02 | 12.81 | 18.27 |
| 26.5 | 30.79 | 9.48 | 11.77 | 17.35 |
| 27 | 30.60 | 8.06 | 10.76 | 16.47 |
| 27.5 | 30.38 | 6.80 | 9.79 | 15.66 |
| 28 | 30.13 | 5.70 | 8.88 | 14.90 |
| 28.5 | 29.85 | 4.77 | 8.02 | 14.21 |
| 29 | 29.53 | 3.98 | 7.23 | 13.58 |
| 29.5 | 29.18 | 3.33 | 6.50 | 13.00 |
| 30 | 28.79 | 2.79 | 5.84 | 12.47 |
| 30.5 | 28.35 | 2.36 | 5.24 | 11.99 |
| 31 | 27.87 | 2.02 | 4.71 | 11.53 |
| 31.5 | 27.33 | 1.74 | 4.24 | 11.10 |
| 32 | 26.75 | 1.52 | 3.82 | 10.69 |
| 32.5 | 26.10 | 1.35 | 3.45 | 10.30 |
| 33 | 25.41 | 1.21 | 3.13 | 9.91 |
| 33.5 | 24.66 | 1.10 | 2.84 | 9.53 |
| 34 | 23.85 | 1.02 | 2.60 | 9.16 |
| 34.5 | 22.99 | 0.95 | 2.39 | 8.78 |
| 35 | 22.08 | 0.90 | 2.20 | 8.40 |
| 35.5 | 21.13 | 0.86 | 2.05 | 8.01 |
| 36 | 20.14 | 0.83 | 1.91 | 7.63 |
| 36.5 | 19.12 | 0.81 | 1.79 | 7.24 |
| 37 | 18.08 | 0.79 | 1.69 | 6.85 |
| 37.5 | 17.02 | 0.77 | 1.61 | 6.47 |
| 38 | 15.96 | 0.76 | 1.53 | 6.09 |
| 38.5 | 14.91 | 0.75 | 1.47 | 5.71 |
| 39 | 13.88 | 0.74 | 1.42 | 5.35 |
| 39.5 | 12.87 | 0.74 | 1.37 | 4.99 |
| 40 | 11.89 | 0.73 | 1.33 | 4.65 |
| 40.5 | 10.96 | 0.73 | 1.30 | 4.33 |
| 41 | 10.07 | 0.73 | 1.27 | 4.02 |
| 41.5 | 9.23 | 0.73 | 1.25 | 3.74 |
| 42 | 8.45 | 0.73 | 1.23 | 3.47 |
| 42.5 | 7.72 | 0.72 | 1.21 | 3.22 |
| 43 | 7.04 | 0.72 | 1.19 | 2.99 |
| 43.5 | 6.42 | 0.72 | 1.18 | 2.78 |
| 44 | 5.86 | 0.72 | 1.17 | 2.58 |
| 44.5 | 5.34 | 0.72 | 1.16 | 2.41 |
| 45 | 4.88 | 0.72 | 1.15 | 2.25 |
| 45.5 | 4.46 | 0.72 | 1.15 | 2.11 |
| 46 | 4.08 | 0.72 | 1.14 | 1.98 |
| 46.5 | 3.74 | 0.72 | 1.14 | 1.87 |
| 47 | 3.44 | 0.72 | 1.13 | 1.77 |
| 47.5 | 3.18 | 0.72 | 1.13 | 1.68 |
| 48 | 2.94 | 0.72 | 1.13 | 1.60 |
| 48.5 | 2.73 | 0.72 | 1.12 | 1.52 |
| 49 | 2.54 | 0.72 | 1.12 | 1.46 |
| 49.5 | 2.38 | 0.72 | 1.12 | 1.41 |
| 50 | 2.24 | 0.72 | 1.12 | 1.36 |
| 50.5 | 2.11 | 0.72 | 1.12 | 1.31 |
| 51 | 2.00 | 0.72 | 1.12 | 1.28 |
| 51.5 | 1.90 | 0.72 | 1.11 | 1.24 |
| 52 | 1.81 | 0.72 | 1.11 | 1.22 |
| 52.5 | 1.74 | 0.72 | 1.11 | 1.19 |
| 53 | 1.67 | 0.72 | 1.11 | 1.17 |
| 53.5 | 1.61 | 0.72 | 1.11 | 1.15 |
| 54 | 1.56 | 0.72 | 1.11 | 1.13 |
| 54.5 | 1.52 | 0.72 | 1.11 | 1.12 |
| 55 | 1.48 | 0.72 | 1.11 | 1.10 |
| 55.5 | 1.44 | 0.72 | 1.11 | 1.09 |
| 56 | 1.41 | 0.72 | 1.11 | 1.08 |
| 56.5 | 1.39 | 0.72 | 1.11 | 1.07 |
| 57 | 1.37 | 0.72 | 1.11 | 1.07 |
| 57.5 | 1.35 | 0.72 | 1.11 | 1.06 |
| 58 | 1.33 | 0.72 | 1.11 | 1.05 |
| 58.5 | 1.31 | 0.72 | 1.11 | 1.05 |
| 59 | 1.30 | 0.72 | 1.11 | 1.04 |
| 59.5 | 1.29 | 0.72 | 1.11 | 1.04 |
| 60 | 1.28 | 0.72 | 1.11 | 1.04 |
| 60.5 | 1.27 | 0.72 | 1.11 | 1.03 |
| 61 | 1.26 | 0.72 | 1.11 | 1.03 |
| 61.5 | 1.26 | 0.72 | 1.11 | 1.03 |
| 62 | 1.25 | 0.72 | 1.11 | 1.03 |

TABLE 1G
Interpolated OTR for Polymer Blend 3

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-3 |
| 10 | 27.28 | 23.10 | 24.75 | 25.04 |
| 10.5 | 27.08 | 22.50 | 24.70 | 24.76 |
| 11 | 26.83 | 21.84 | 24.64 | 24.44 |
| 11.5 | 26.52 | 21.13 | 24.57 | 24.07 |
| 12 | 26.13 | 20.36 | 24.48 | 23.66 |
| 12.5 | 25.65 | 19.54 | 24.37 | 23.19 |
| 13 | 25.06 | 18.68 | 24.23 | 22.66 |
| 13.5 | 24.35 | 17.77 | 24.06 | 22.06 |
| 14 | 23.50 | 16.83 | 23.86 | 21.40 |
| 14.5 | 22.50 | 15.86 | 23.61 | 20.66 |
| 15 | 21.35 | 14.88 | 23.30 | 19.84 |
| 15.5 | 20.05 | 13.89 | 22.93 | 18.96 |
| 16 | 18.62 | 12.91 | 22.49 | 18.01 |
| 16.5 | 17.08 | 11.95 | 21.96 | 16.99 |
| 17 | 15.47 | 11.01 | 21.33 | 15.94 |
| 17.5 | 13.83 | 10.10 | 20.60 | 14.85 |
| 18 | 12.22 | 9.24 | 19.77 | 13.74 |
| 18.5 | 10.68 | 8.42 | 18.82 | 12.64 |
| 19 | 9.24 | 7.66 | 17.76 | 11.55 |
| 19.5 | 7.94 | 6.95 | 16.60 | 10.50 |
| 20 | 6.79 | 6.30 | 15.37 | 9.49 |
| 20.5 | 5.79 | 5.70 | 14.08 | 8.52 |
| 21 | 4.94 | 5.16 | 12.76 | 7.62 |
| 21.5 | 4.23 | 4.67 | 11.45 | 6.78 |
| 22 | 3.64 | 4.23 | 10.18 | 6.01 |
| 22.5 | 3.15 | 3.84 | 8.96 | 5.32 |
| 23 | 2.76 | 3.49 | 7.84 | 4.70 |
| 23.5 | 2.44 | 3.18 | 6.81 | 4.15 |
| 24 | 2.19 | 2.91 | 5.90 | 3.67 |
| 24.5 | 1.99 | 2.67 | 5.10 | 3.25 |
| 25 | 1.83 | 2.46 | 4.40 | 2.90 |
| 25.5 | 1.70 | 2.27 | 3.81 | 2.59 |
| 26 | 1.60 | 2.11 | 3.30 | 2.34 |
| 26.5 | 1.52 | 1.97 | 2.88 | 2.13 |
| 27 | 1.46 | 1.84 | 2.54 | 1.95 |
| 27.5 | 1.41 | 1.74 | 2.25 | 1.80 |
| 28 | 1.37 | 1.64 | 2.01 | 1.68 |
| 28.5 | 1.34 | 1.56 | 1.82 | 1.57 |
| 29 | 1.32 | 1.49 | 1.66 | 1.49 |
| 29.5 | 1.30 | 1.43 | 1.53 | 1.42 |
| 30 | 1.29 | 1.38 | 1.43 | 1.36 |
| 30.5 | 1.28 | 1.33 | 1.35 | 1.32 |
| 31 | 1.27 | 1.29 | 1.28 | 1.28 |
| 31.5 | 1.26 | 1.26 | 1.23 | 1.25 |
| 32 | 1.25 | 1.23 | 1.18 | 1.22 |
| 32.5 | 1.25 | 1.20 | 1.15 | 1.20 |
| 33 | 1.25 | 1.18 | 1.12 | 1.18 |
| 33.5 | 1.24 | 1.16 | 1.09 | 1.17 |
| 34 | 1.24 | 1.14 | 1.08 | 1.15 |
| 34.5 | 1.24 | 1.13 | 1.06 | 1.14 |
| 35 | 1.24 | 1.12 | 1.05 | 1.14 |
| 35.5 | 1.24 | 1.11 | 1.04 | 1.13 |
| 36 | 1.24 | 1.10 | 1.03 | 1.12 |
| 36.5 | 1.24 | 1.09 | 1.03 | 1.12 |
| 37 | 1.24 | 1.08 | 1.02 | 1.11 |
| 37.5 | 1.24 | 1.08 | 1.02 | 1.11 |
| 38 | 1.24 | 1.07 | 1.01 | 1.11 |
| 38.5 | 1.24 | 1.07 | 1.01 | 1.11 |
| 39 | 1.24 | 1.06 | 1.01 | 1.10 |
| 39.5 | 1.24 | 1.06 | 1.01 | 1.10 |
| 40 | 1.24 | 1.06 | 1.01 | 1.10 |
| 40.5 | 1.24 | 1.05 | 1.01 | 1.10 |
| 41 | 1.24 | 1.05 | 1.01 | 1.10 |
| 41.5 | 1.24 | 1.05 | 1.00 | 1.10 |
| 42 | 1.24 | 1.05 | 1.00 | 1.10 |
| 42.5 | 1.24 | 1.05 | 1.00 | 1.10 |
| 43 | 1.24 | 1.05 | 1.00 | 1.10 |
| 43.5 | 1.24 | 1.05 | 1.00 | 1.09 |
| 44 | 1.24 | 1.04 | 1.00 | 1.09 |
| 44.5 | 1.24 | 1.04 | 1.00 | 1.09 |
| 45 | 1.24 | 1.04 | 1.00 | 1.09 |
| 45.5 | 1.24 | 1.04 | 1.00 | 1.09 |
| 46 | 1.24 | 1.04 | 1.00 | 1.09 |
| 46.5 | 1.24 | 1.04 | 1.00 | 1.09 |
| 47 | 1.24 | 1.04 | 1.00 | 1.09 |
| 47.5 | 1.24 | 1.04 | 1.00 | 1.09 |
| 48 | 1.24 | 1.04 | 1.00 | 1.09 |
| 48.5 | 1.24 | 1.04 | 1.00 | 1.09 |
| 49 | 1.24 | 1.04 | 1.00 | 1.09 |
| 49.5 | 1.24 | 1.04 | 1.00 | 1.09 |
| 50 | 1.24 | 1.04 | 1.00 | 1.09 |
| 50.5 | 1.24 | 1.04 | 1.00 | 1.09 |
| 51 | 1.24 | 1.04 | 1.00 | 1.09 |
| 51.5 | 1.24 | 1.04 | 1.00 | 1.09 |
| 52 | 1.24 | 1.04 | 1.00 | 1.09 |
| 52.5 | 1.24 | 1.04 | 1.00 | 1.09 |
| 53 | 1.24 | 1.04 | 1.00 | 1.09 |
| 53.5 | 1.24 | 1.04 | 1.00 | 1.09 |
| 54 | 1.24 | 1.04 | 1.00 | 1.09 |
| 54.5 | 1.24 | 1.04 | 1.00 | 1.09 |
| 55 | 1.24 | 1.04 | 1.00 | 1.09 |
| 55.5 | 1.24 | 1.04 | 1.00 | 1.09 |
| 56 | 1.24 | 1.04 | 1.00 | 1.09 |
| 56.5 | 1.24 | 1.04 | 1.00 | 1.09 |
| 57 | 1.24 | 1.04 | 1.00 | 1.09 |
| 57.5 | 1.24 | 1.04 | 1.00 | 1.09 |
| 58 | 1.24 | 1.04 | 1.00 | 1.09 |
| 58.5 | 1.24 | 1.04 | 1.00 | 1.09 |
| 59 | 1.24 | 1.04 | 1.00 | 1.09 |
| 59.5 | 1.24 | 1.04 | 1.00 | 1.09 |
| 60 | 1.24 | 1.04 | 1.00 | 1.09 |
| 60.5 | 1.24 | 1.04 | 1.00 | 1.09 |
| 61 | 1.24 | 1.04 | 1.00 | 1.09 |
| 61.5 | 1.24 | 1.04 | 1.00 | 1.09 |
| 62 | 1.24 | 1.04 | 1.00 | 1.09 |

TABLE 1H
Interpolated OTR for Polymer Blend 4

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-4 |
| 10 | 30.18 | 24.29 | 27.11 | 27.19 |
| 10.5 | 30.07 | 23.53 | 26.59 | 26.73 |
| 11 | 29.96 | 22.73 | 26.03 | 26.24 |
| 11.5 | 29.82 | 21.89 | 25.42 | 25.71 |
| 12 | 29.67 | 21.02 | 24.76 | 25.15 |
| 12.5 | 29.49 | 20.11 | 24.05 | 24.55 |
| 13 | 29.28 | 19.19 | 23.30 | 23.92 |
| 13.5 | 29.05 | 18.24 | 22.49 | 23.26 |
| 14 | 28.78 | 17.29 | 21.65 | 22.57 |
| 14.5 | 28.47 | 16.32 | 20.76 | 21.85 |
| 15 | 28.12 | 15.36 | 19.85 | 21.11 |
| 15.5 | 27.73 | 14.41 | 18.90 | 20.35 |
| 16 | 27.29 | 13.47 | 17.93 | 19.56 |
| 16.5 | 26.79 | 12.54 | 16.95 | 18.76 |
| 17 | 26.24 | 11.65 | 15.96 | 17.95 |
| 17.5 | 25.62 | 10.79 | 14.98 | 17.13 |
| 18 | 24.94 | 9.96 | 14.00 | 16.30 |
| 18.5 | 24.20 | 9.17 | 13.04 | 15.47 |
| 19 | 23.39 | 8.42 | 12.11 | 14.64 |
| 19.5 | 22.52 | 7.71 | 11.21 | 13.81 |
| 20 | 21.59 | 7.04 | 10.35 | 12.99 |
| 20.5 | 20.60 | 6.42 | 9.53 | 12.19 |
| 21 | 19.57 | 5.85 | 8.76 | 11.39 |
| 21.5 | 18.50 | 5.31 | 8.03 | 10.61 |
| 22 | 17.40 | 4.82 | 7.35 | 9.86 |
| 22.5 | 16.29 | 4.37 | 6.72 | 9.13 |
| 23 | 15.18 | 3.96 | 6.14 | 8.42 |
| 23.5 | 14.08 | 3.58 | 5.60 | 7.75 |
| 24 | 13.00 | 3.23 | 5.11 | 7.11 |
| 24.5 | 11.95 | 2.92 | 4.67 | 6.51 |
| 25 | 10.95 | 2.64 | 4.26 | 5.95 |
| 25.5 | 10.00 | 2.38 | 3.90 | 5.43 |
| 26 | 9.10 | 2.15 | 3.57 | 4.94 |
| 26.5 | 8.27 | 1.94 | 3.27 | 4.50 |
| 27 | 7.50 | 1.75 | 3.01 | 4.09 |
| 27.5 | 6.80 | 1.59 | 2.77 | 3.72 |
| 28 | 6.16 | 1.44 | 2.56 | 3.38 |
| 28.5 | 5.58 | 1.30 | 2.37 | 3.08 |
| 29 | 5.06 | 1.18 | 2.20 | 2.81 |
| 29.5 | 4.60 | 1.07 | 2.05 | 2.57 |
| 30 | 4.19 | 0.97 | 1.92 | 2.36 |
| 30.5 | 3.83 | 0.89 | 1.80 | 2.17 |
| 31 | 3.51 | 0.81 | 1.70 | 2.00 |
| 31.5 | 3.22 | 0.74 | 1.61 | 1.86 |
| 32 | 2.98 | 0.68 | 1.52 | 1.73 |
| 32.5 | 2.76 | 0.62 | 1.45 | 1.61 |
| 33 | 2.57 | 0.57 | 1.39 | 1.51 |
| 33.5 | 2.41 | 0.53 | 1.33 | 1.42 |
| 34 | 2.27 | 0.49 | 1.28 | 1.35 |
| 34.5 | 2.14 | 0.46 | 1.24 | 1.28 |
| 35 | 2.03 | 0.43 | 1.20 | 1.22 |
| 35.5 | 1.94 | 0.40 | 1.17 | 1.17 |
| 36 | 1.86 | 0.37 | 1.14 | 1.12 |
| 36.5 | 1.79 | 0.35 | 1.11 | 1.09 |
| 37 | 1.73 | 0.33 | 1.09 | 1.05 |
| 37.5 | 1.68 | 0.32 | 1.07 | 1.02 |
| 38 | 1.64 | 0.30 | 1.05 | 1.00 |
| 38.5 | 1.60 | 0.29 | 1.03 | 0.97 |
| 39 | 1.57 | 0.28 | 1.02 | 0.95 |
| 39.5 | 1.54 | 0.26 | 1.01 | 0.94 |
| 40 | 1.51 | 0.26 | 1.00 | 0.92 |
| 40.5 | 1.49 | 0.25 | 0.99 | 0.91 |
| 41 | 1.47 | 0.24 | 0.98 | 0.90 |
| 41.5 | 1.46 | 0.23 | 0.97 | 0.89 |
| 42 | 1.44 | 0.23 | 0.97 | 0.88 |
| 42.5 | 1.43 | 0.22 | 0.96 | 0.87 |
| 43 | 1.42 | 0.22 | 0.95 | 0.86 |
| 43.5 | 1.41 | 0.21 | 0.95 | 0.86 |
| 44 | 1.41 | 0.21 | 0.95 | 0.85 |
| 44.5 | 1.40 | 0.21 | 0.94 | 0.85 |
| 45 | 1.39 | 0.20 | 0.94 | 0.85 |
| 45.5 | 1.39 | 0.20 | 0.94 | 0.84 |
| 46 | 1.39 | 0.20 | 0.93 | 0.84 |
| 46.5 | 1.38 | 0.20 | 0.93 | 0.84 |
| 47 | 1.38 | 0.19 | 0.93 | 0.83 |
| 47.5 | 1.38 | 0.19 | 0.93 | 0.83 |
| 48 | 1.38 | 0.19 | 0.93 | 0.83 |
| 48.5 | 1.37 | 0.19 | 0.93 | 0.83 |
| 49 | 1.37 | 0.19 | 0.93 | 0.83 |
| 49.5 | 1.37 | 0.19 | 0.92 | 0.83 |
| 50 | 1.37 | 0.19 | 0.92 | 0.83 |
| 50.5 | 1.37 | 0.19 | 0.92 | 0.83 |
| 51 | 1.37 | 0.18 | 0.92 | 0.82 |
| 51.5 | 1.37 | 0.18 | 0.92 | 0.82 |
| 52 | 1.37 | 0.18 | 0.92 | 0.82 |
| 52.5 | 1.37 | 0.18 | 0.92 | 0.82 |
| 53 | 1.36 | 0.18 | 0.92 | 0.82 |
| 53.5 | 1.36 | 0.18 | 0.92 | 0.82 |
| 54 | 1.36 | 0.18 | 0.92 | 0.82 |
| 54.5 | 1.36 | 0.18 | 0.92 | 0.82 |
| 55 | 1.36 | 0.18 | 0.92 | 0.82 |
| 55.5 | 1.36 | 0.18 | 0.92 | 0.82 |
| 56 | 1.36 | 0.18 | 0.92 | 0.82 |
| 56.5 | 1.36 | 0.18 | 0.92 | 0.82 |
| 57 | 1.36 | 0.18 | 0.92 | 0.82 |
| 57.5 | 1.36 | 0.18 | 0.92 | 0.82 |
| 58 | 1.36 | 0.18 | 0.92 | 0.82 |
| 58.5 | 1.36 | 0.18 | 0.92 | 0.82 |
| 59 | 1.36 | 0.18 | 0.92 | 0.82 |
| 59.5 | 1.36 | 0.18 | 0.92 | 0.82 |
| 60 | 1.36 | 0.18 | 0.92 | 0.82 |
| 60.5 | 1.36 | 0.18 | 0.92 | 0.82 |
| 61 | 1.36 | 0.18 | 0.92 | 0.82 |
| 61.5 | 1.36 | 0.18 | 0.92 | 0.82 |
| 62 | 1.36 | 0.18 | 0.92 | 0.82 |

TABLE 1I
Average OTR for Polymer Blends 1 through 4

Interpolated OTR

| Day Since | Comparative | Comparative | | |
|---|---|---|---|---|
| Blowing | Polymer | Polymer | Polymer | Polymer |
| Bottle | Blend-1 | Blend-2 | Blend-3 | Blend-4 |
| 10 | 37.06 | 29.16 | 25.90 | 28.38 |
| 10.5 | 36.77 | 29.16 | 25.68 | 27.97 |
| 11 | 36.49 | 29.15 | 25.41 | 27.51 |
| 11.5 | 36.24 | 29.14 | 25.09 | 27.00 |
| 12 | 36.00 | 29.13 | 24.72 | 26.45 |
| 12.5 | 35.77 | 29.12 | 24.27 | 25.84 |
| 13 | 35.56 | 29.11 | 23.74 | 25.19 |
| 13.5 | 35.36 | 29.10 | 23.12 | 24.48 |
| 14 | 35.17 | 29.08 | 22.41 | 23.71 |
| 14.5 | 34.99 | 29.06 | 21.60 | 22.90 |
| 15 | 34.83 | 29.04 | 20.69 | 22.04 |
| 15.5 | 34.67 | 29.01 | 19.67 | 21.14 |
| 16 | 34.53 | 28.97 | 18.56 | 20.20 |
| 16.5 | 34.39 | 28.93 | 17.37 | 19.22 |
| 17 | 34.26 | 28.88 | 16.11 | 18.22 |
| 17.5 | 34.14 | 28.82 | 14.81 | 17.21 |
| 18 | 34.03 | 28.74 | 13.49 | 16.18 |
| 18.5 | 33.92 | 28.66 | 12.18 | 15.16 |
| 19 | 33.82 | 28.55 | 10.91 | 14.14 |
| 19.5 | 33.72 | 28.43 | 9.70 | 13.15 |
| 20 | 33.64 | 28.28 | 8.57 | 12.18 |
| 20.5 | 33.55 | 28.11 | 7.54 | 11.24 |
| 21 | 33.47 | 27.90 | 6.60 | 10.34 |
| 21.5 | 33.40 | 27.66 | 5.77 | 9.49 |
| 22 | 33.33 | 27.37 | 5.04 | 8.69 |
| 22.5 | 33.27 | 27.04 | 4.40 | 7.93 |
| 23 | 33.21 | 26.65 | 3.85 | 7.23 |
| 23.5 | 33.15 | 26.19 | 3.39 | 6.58 |
| 24 | 33.09 | 25.66 | 3.00 | 5.98 |
| 24.5 | 33.04 | 25.06 | 2.67 | 5.44 |
| 25 | 33.00 | 24.38 | 2.39 | 4.94 |
| 25.5 | 32.95 | 23.60 | 2.16 | 4.49 |
| 26 | 32.91 | 22.74 | 1.97 | 4.08 |
| 26.5 | 32.87 | 21.79 | 1.81 | 3.71 |
| 27 | 32.83 | 20.75 | 1.68 | 3.38 |
| 27.5 | 32.80 | 19.63 | 1.58 | 3.09 |
| 28 | 32.77 | 18.44 | 1.49 | 2.82 |
| 28.5 | 32.74 | 17.20 | 1.42 | 2.59 |
| 29 | 32.71 | 15.93 | 1.36 | 2.38 |
| 29.5 | 32.68 | 14.64 | 1.31 | 2.19 |
| 30 | 32.66 | 13.36 | 1.27 | 2.03 |
| 30.5 | 32.63 | 12.11 | 1.24 | 1.88 |
| 31 | 32.61 | 10.91 | 1.21 | 1.76 |
| 31.5 | 32.59 | 9.77 | 1.19 | 1.64 |
| 32 | 32.57 | 8.71 | 1.17 | 1.54 |
| 32.5 | 32.55 | 7.73 | 1.16 | 1.45 |
| 33 | 32.53 | 6.84 | 1.14 | 1.38 |
| 33.5 | 32.52 | 6.04 | 1.13 | 1.31 |
| 34 | 32.50 | 5.33 | 1.13 | 1.25 |
| 34.5 | 32.49 | 4.70 | 1.12 | 1.20 |
| 35 | 32.47 | 4.15 | 1.12 | 1.15 |
| 35.5 | 32.46 | 3.68 | 1.11 | 1.11 |
| 36 | 32.45 | 3.27 | 1.11 | 1.07 |
| 36.5 | 32.44 | 2.92 | 1.10 | 1.04 |
| 37 | 32.43 | 2.62 | 1.10 | 1.01 |
| 37.5 | 32.42 | 2.36 | 1.10 | 0.99 |
| 38 | 32.41 | 2.15 | 1.10 | 0.97 |
| 38.5 | 32.40 | 1.96 | 1.10 | 0.95 |
| 39 | 32.39 | 1.81 | 1.10 | 0.93 |
| 39.5 | 32.38 | 1.68 | 1.10 | 0.92 |
| 40 | 32.38 | 1.57 | 1.10 | 0.91 |
| 40.5 | 32.37 | 1.48 | 1.09 | 0.90 |
| 41 | 32.36 | 1.40 | 1.09 | 0.89 |
| 41.5 | 32.36 | 1.34 | 1.09 | 0.88 |
| 42 | 32.35 | 1.28 | 1.09 | 0.87 |
| 42.5 | 32.35 | 1.24 | 1.09 | 0.86 |
| 43 | 32.34 | 1.20 | 1.09 | 0.86 |
| 43.5 | 32.34 | 1.17 | 1.09 | 0.85 |
| 44 | 32.33 | 1.14 | 1.09 | 0.85 |
| 44.5 | 32.33 | 1.12 | 1.09 | 0.85 |
| 45 | 32.32 | 1.10 | 1.09 | 0.84 |
| 45.5 | 32.32 | 1.09 | 1.09 | 0.84 |
| 46 | 32.32 | 1.08 | 1.09 | 0.84 |
| 46.5 | 32.31 | 1.07 | 1.09 | 0.84 |
| 47 | 32.31 | 1.06 | 1.09 | 0.83 |
| 47.5 | 32.31 | 1.05 | 1.09 | 0.83 |
| 48 | 32.30 | 1.04 | 1.09 | 0.83 |
| 48.5 | 32.30 | 1.04 | 1.09 | 0.83 |
| 49 | 32.30 | 1.03 | 1.09 | 0.83 |
| 49.5 | 32.30 | 1.03 | 1.09 | 0.83 |
| 50 | 32.30 | 1.03 | 1.09 | 0.83 |
| 50.5 | 32.29 | 1.03 | 1.09 | 0.83 |
| 51 | 32.29 | 1.02 | 1.09 | 0.82 |
| 51.5 | 32.29 | 1.02 | 1.09 | 0.82 |
| 52 | 32.29 | 1.02 | 1.09 | 0.82 |
| 52.5 | 32.29 | 1.02 | 1.09 | 0.82 |
| 53 | 32.29 | 1.02 | 1.09 | 0.82 |
| 53.5 | 32.28 | 1.02 | 1.09 | 0.82 |
| 54 | 32.28 | 1.02 | 1.09 | 0.82 |
| 54.5 | 32.28 | 1.02 | 1.09 | 0.82 |
| 55 | 32.28 | 1.02 | 1.09 | 0.82 |
| 55.5 | 32.28 | 1.01 | 1.09 | 0.82 |
| 56 | 32.28 | 1.01 | 1.09 | 0.82 |
| 56.5 | 32.28 | 1.01 | 1.09 | 0.82 |
| 57 | 32.28 | 1.01 | 1.09 | 0.82 |
| 57.5 | 32.28 | 1.01 | 1.09 | 0.82 |
| 58 | 32.28 | 1.01 | 1.09 | 0.82 |
| 58.5 | 32.27 | 1.01 | 1.09 | 0.82 |
| 59 | 32.27 | 1.01 | 1.09 | 0.82 |
| 59.5 | 32.27 | 1.01 | 1.09 | 0.82 |
| 60 | 32.27 | 1.01 | 1.09 | 0.82 |
| 60.5 | 32.27 | 1.01 | 1.09 | 0.82 |
| 61 | 32.27 | 1.01 | 1.09 | 0.82 |
| 61.5 | 32.27 | 1.01 | 1.09 | 0.82 |
| 62 | 32.27 | 1.01 | 1.09 | 0.82 |

TABLE 1J
OxySense Test Results for Polymer Blends 1 through 4

| | pO2 (mbar) | | | pO2 (mbar) | | | pO2 (mbar) | | | pO2 (mbar) | | |
|---|---|---|---|---|---|---|---|---|---|---|---|---|
| | for Polymer Blend-1 | | | for Polymer Blend-2 | | | for Polymer Blend-3 | | | for Polymer Blend-4 | | |
| | | Ampoule | | | Ampoule | | | Ampoule | | | Ampoule | |
| Day | Ampoule 1 | 2 | Average | Ampoule 1 | 2 | Average | Ampoule 1 | 2 | Average | Ampoule 1 | 2 | Average |
| 0 | 216 | 217 | 217 | 217 | 214 | 216 | 215 | 215 | 215 | 223 | 210 | 217 |
| 1 | 216 | 216 | 216 | 221 | 217 | 219 | 221 | 214 | 217 | 222 | 214 | 218 |
| 2 | 220 | 214 | 217 | 225 | 215 | 220 | 217 | 213 | 215 | 219 | 208 | 214 |
| 3 | 217 | 216 | 216 | 220 | 216 | 218 | 219 | 208 | 214 | 220 | 207 | 213 |
| 4 | 215 | 214 | 215 | 214 | 213 | 214 | 218 | 213 | 216 | 217 | 201 | 209 |

TABLE 1K
Days to OTR less than or equal to 5 μl/day for Polymer Blends 1
through 4

| | | | % | | | | |
|---|---|---|---|---|---|---|---|
| | PET | | MXD-6 | | OTR | | |
| | Li/Al/P | | (by ¹H | | Days to 5 μL/day | | |
| Sample | (ppm) | It.V. | NMR) | Co (ppm) | Average | Min | Max |
| Com- | — | 0.80 | 1.28 | 89.2 | >60 | — | — |
| parative | | | | | | | |
| Polymer | | | | | | | |
| Blend-1 | | | | | | | |
| Com- | — | 0.78 | 1.56 | 98.1 | 39.5 | 28.4 | 44.8 |
| parative | | | | | | | |
| Polymer | | | | | | | |
| Blend-2 | | | | | | | |
| Polymer | 9.4/7/51.1 | 0.71 | 1.24 | 46.6 | 22 | 21 | 24.5 |
| Blend-3 | | | | | | | |
| Polymer | 8.3/6.3/48 | 0.70 | 1.16 | 77 | 25 | 21.7 | 29 |
| Blend-4 | | | | | | | |

### Example 2

Below is a description of the PET polymers used to prepare each of Polymer Blends 5 through 8. Polymer Blends 7 and 8 differ even though the same PET polymer was used because different quantities of cobalt were added to the same PET-4 polymer. The metal quantities in Polymer Blends 5 through 8 were determined by Inductively Coupled Plasma Optical Emission Spectroscopy (ICP) and are set forth in Table 2A.

PET-1 is the same as previously described in Example 1.

PET-2 is the same as previously described in Example 1.

PET-4 was a PET copolymer containing residues of terephthalic acid, ethylene glycol, and isophthalic acid, with isophthalic acid residues representing about 2.9 mole % of the dicarboxylic acid residues; contained about 8 to 14 ppm Al, about 6 to 10 ppm Li, and about 52 to 63 ppm phosphorus, provided as a catalyst system; and further contained a reheat additive and red and blue toners. PET-4 was prepared by melt-polymerizing the dicarboxylic acids and diol residues in the presence of the aluminum and lithium catalysts, the reheat additive, and the red and blue toners to an intrinsic viscosity of about 0.75 dL/g. The molten PET was then solidified and pelletized.

The glycol portion of each of the PET polymers also contains low levels (less than 5 mol %) DEG residues, present as a natural byproduct of the melt polymerization process or intentionally added as a modifier, for example to maintain a uniform DEG content.

The cobalt concentrate was the same as previously described in Example 1.

The polyamide used was previously described in Experiment 1.

### Polymer Blend 5 (Comparative)

Polymer Blend 5 was prepared using PET-1 (963 g), MXD-6™ (15 g), and cobalt concentrate (22.5 g), all as previously described in Experiment 1, in the amounts given in Table 2B. Polymer Blend 5 was injection-molded into preforms and blown into bottles, as described for Polymer Blend 1.

### Polymer Blend 6 (Comparative)

Polymer Blend 6 was prepared using PET-2 (963 g), MXD-6™ (15 g), and cobalt concentrate (22.5 g), as described for Polymer Blend 1, in the amounts given in Table 2B. Polymer Blend 2 was injection-molded into preforms and blown into bottles, as described for Polymer Blend 1.

### Polymer Blend 7 (Inventive)

Polymer Blend 7 was prepared using PET-4 (974 g), MXD-6™ (15 g), and cobalt concentrate (11.25 g), as described above in Polymer Blend 1 and Table 2B. Polymer Blend 7 was injection-molded into preforms and blown into bottles, as described for Polymer Blend 1.

### Polymer Blend 8 (Inventive)

Polymer Blend 8 was prepared using PET-4 (963 g), MXD-6™ (15 g), and cobalt concentrate (22.5 g), as described above in Polymer Blend 1, in the amounts given in Table 2B. Polymer Blend 8 was injection-molded into preforms and blown into bottles as described for Polymer Blend 1.

The ability of Polymer Blends 5 through 8 to scavenge oxygen was evaluated using the OxySense Test and the OTR Test.

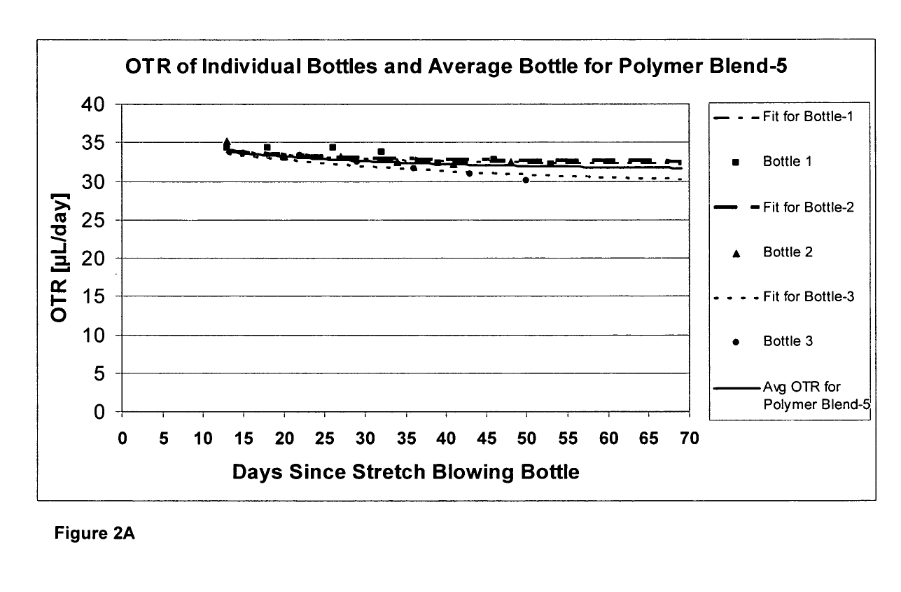

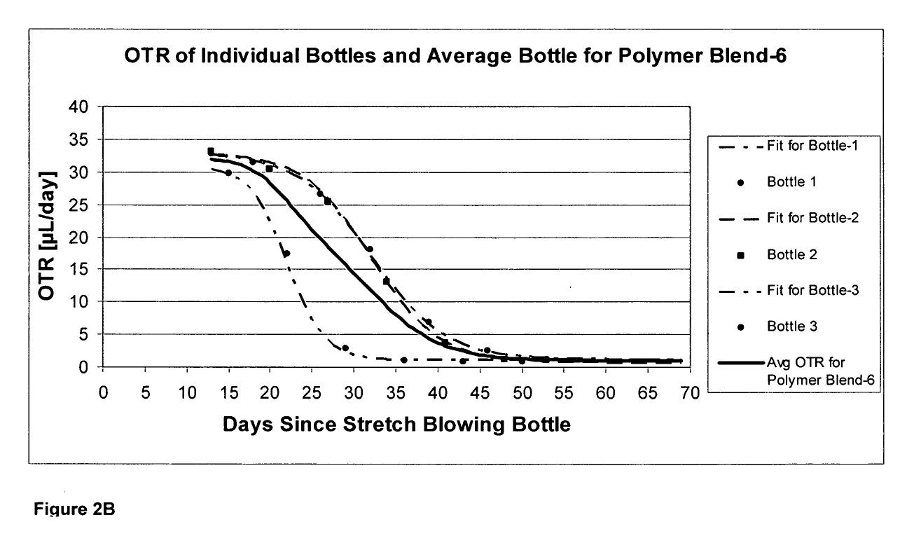

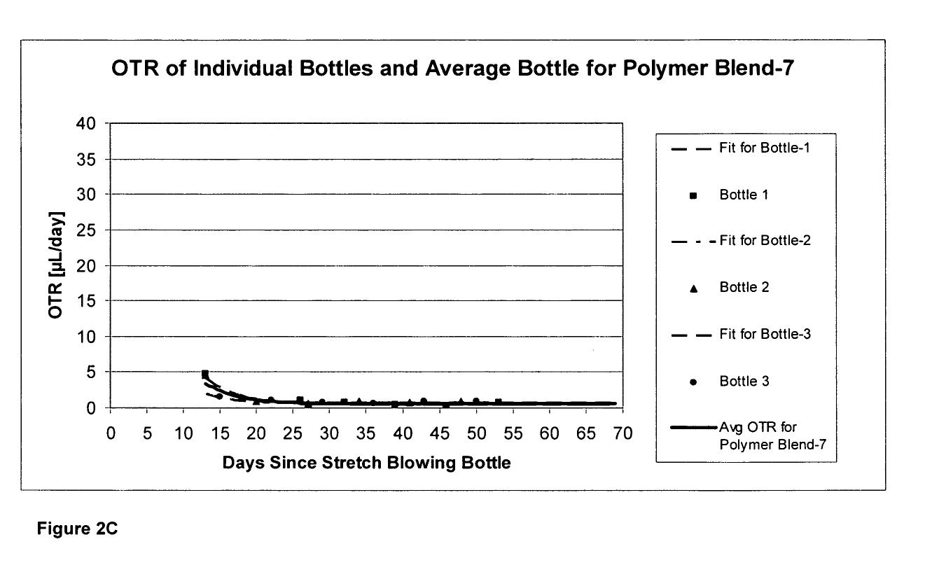

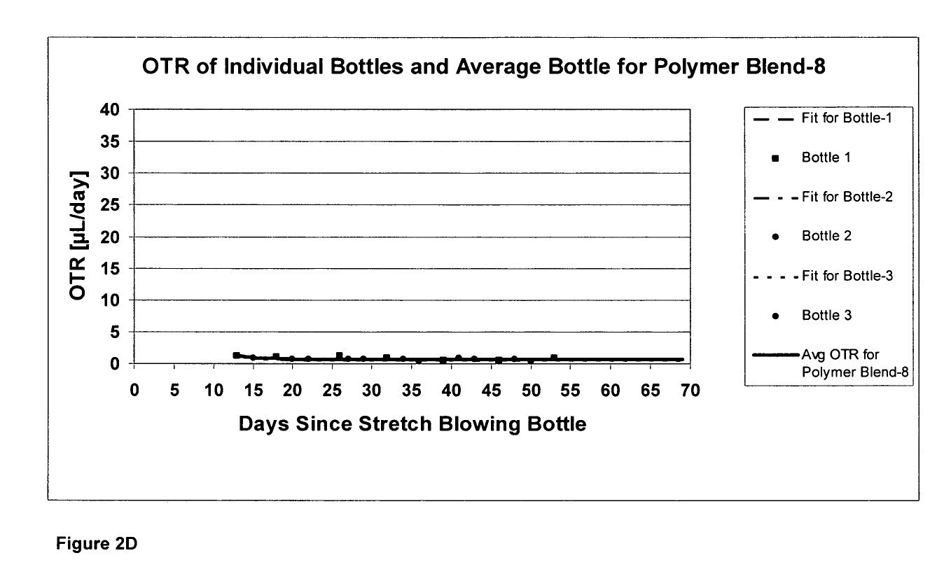

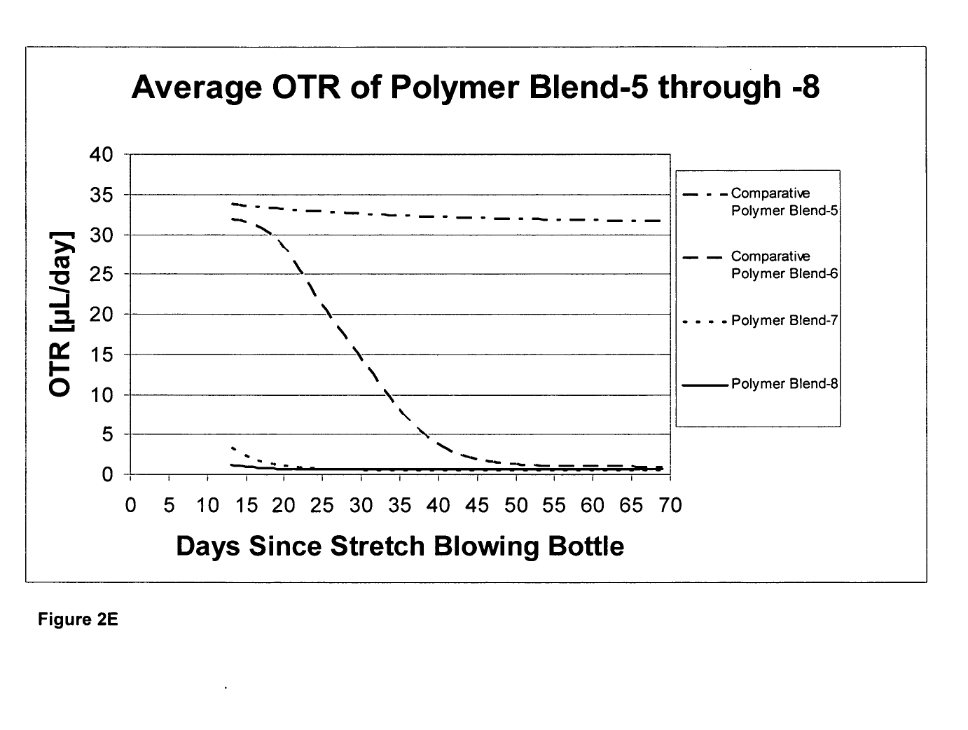

Three stretch-blown bottles prepared using each of the four Polymer Blends 5 through 8 were tested for OTR periodically for approximately 40-days following blow molding (Tables 2C). The OTR results for each set of three bottles for Polymer Blends 5 through 8 are plotted in FIGS. 2A-2D, respectively, and each set of data corresponding to a single bottle has a non-linear curve superimposed over the OTR data. The x- and y-coordinates for the non-linear curves are reported in Tables 2D-2G allowing interpolation of the OTR (i.e., y-coordinates) for all “days-since-blowing” (i.e., x-coordinates) throughout the test period. As described in Example 1, the OTR of the three bottles were mathematically averaged for all days-since-blow-molding (i.e., all x-coordinates) over the entire test period and an average OTR curve was calculated for each of Polymer Blends 5 through 8 (Tables 2D-2G and 2H and FIG. 2E).

Oxygen scavenging of Polymer Blends 5 through 8 was also evaluated by the OxySense Test as already described. Replicate OxySense Test results are reported for each blend in Table 2I.

Inventive Polymer Blends 7 and 8, prepared using PET-4 (an aluminum- and lithium-catalyzed PET polymer prepared by melt-phase-only polymerization), exhibited a shorter induction period than comparative Polymer Blends 5 and 6 (see Table 2J and FIG. 2E). Bottles prepared with the inventive Polymer Blends 7 and 8 reached an OTR of 5 μL/day in less than 6 days, whereas comparative Polymer Blends 5 and 6 required greater than 60 and 38 days, respectively, to achieve the same 5 μL/day OTR (Table 2J and FIG. 2E).

TABLE 2A
Metals analysis of Polymer Blends 5 through 8

| | Metals [ppm] by ICP | | | | | | | | |
|---|---|---|---|---|---|---|---|---|---|
| | Li | Al | Co | Fe | Mn | Ti | Sb | P | Zn |
| Com- | <0.2 | <2 | 90.2 | 18.6 | 52.4 | 19.7 | 216 | 96.3 | 5.6 |
| parative | | | | | | | | | |
| Polymer | | | | | | | | | |
| Blend-5 | | | | | | | | | |
| Com- | <0.2 | <2 | 95.8 | 8.2 | <0.2 | <0.2 | 214 | 76.8 | 62.1 |
| parative | | | | | | | | | |
| Polymer | | | | | | | | | |
| Blend-6 | | | | | | | | | |
| Polymer | 8.3 | 12.3 | 46.5 | 3.9 | 0.3 | 3.9 | 3.2 | 57.1 | 0.9 |
| Blend-7 | | | | | | | | | |
| Polymer | 8.1 | 10.6 | 88.6 | 7.6 | 0.4 | 3.8 | 5.2 | 58.1 | 2.1 |
| Blend-8 | | | | | | | | | |

TABLE 2B
Composition of Polymer Blends 5 through 8

| | | | MXD-6 | Cobalt |
|---|---|---|---|---|
| | PET | PET | 6007 | Concentrate |
| | Polymer | [g] | [g] | [g] |
| Comparative Polymer Blend-5 | PET-1 | 963 | 15 | 22.5 |
| Comparative Polymer Blend-6 | PET-2 | 963 | 15 | 22.5 |
| Polymer Blend-7 | PET-4 | 974 | 15 | 11.25 |
| Polymer Blend-8 | PET-4 | 963 | 15 | 22.5 |

TABLE 2C
Oxygen Transmission Rate (OTR) for Polymer Blends 5 through 8

| | OTR | | | OTR | | | OTR | | | OTR | | |
|---|---|---|---|---|---|---|---|---|---|---|---|---|
| | for Polymer Blend-5 | | | for Polymer Blend-6 | | | for Polymer Blend-7 | | | for Polymer Blend-8 | | |
| Day | Bottle 1 | Bottle 2 | Bottle 3 | Bottle 1 | Bottle 2 | Bottle 3 | Bottle 1 | Bottle 2 | Bottle 3 | Bottle 1 | Bottle 2 | Bottle 3 |
| 13 | 34.29 | 35.13 | | 32.72 | 33.2 | | 4.77 | 4.64 | | 1.13 | 1.26 | |
| 15 | | | 33.68 | | | 29.87 | | | 1.52 | | | 0.89 |
| 18 | 34.37 | | | 31.52 | | | 1.18 | | | 1.01 | | |
| 20 | | 33.19 | | | 30.43 | | | 0.86 | | | 0.75 | |
| 22 | | | 33.35 | | | 17.33 | | | 1.07 | | | 0.7 |
| 26 | 34.31 | | | 26.63 | | | 1.12 | | | 1.17 | | |
| 27 | | 33.24 | | | 25.46 | | | 0.65 | | | 0.63 | |
| 29 | | | 32.5 | | | 2.83 | | | 0.71 | | | 0.68 |
| 32 | 33.8 | | | 18.12 | | | 0.78 | | | 0.93 | | |
| 34 | | 32.54 | | | 13.09 | | | 0.89 | | | 0.69 | |
| 36 | | | 31.61 | | | 1.05 | | | 0.56 | | | 0.38 |
| 39 | 32.28 | | | 6.89 | | | 0.51 | | | 0.46 | | |
| 41 | | 32.25 | | | 3.71 | | | 0.75 | | | 0.86 | |
| 43 | | | 30.94 | | | 0.86 | | | 0.91 | | | 0.61 |
| 46 | 32.73 | | | 2.52 | | | 0.37 | | | 0.45 | | |
| 48 | | 32.55 | | | 1.22 | | | 0.87 | | | 0.73 | |
| 50 | | | 30.06 | | | 0.78 | | | 0.91 | | | 0.41 |
| 53 | 32.26 | | | 1.11 | | | 0.7 | | | 0.82 | | |

TABLE 2D
Interpolated OTR for Polymer Blend 5

Interpolated OTR

| Day Since | | | | Avg OTR |
|---|---|---|---|---|
| Blowing | | | | for Polymer |
| Bottle | Bottle 1 | Bottle 2 | Bottle 3 | Blend-5 |
| 13 | 34.03 | 33.88 | 33.56 | 33.82 |
| 13.5 | 33.98 | 33.83 | 33.50 | 33.77 |
| 14 | 33.93 | 33.80 | 33.44 | 33.72 |
| 14.5 | 33.88 | 33.76 | 33.38 | 33.67 |
| 15 | 33.83 | 33.72 | 33.33 | 33.62 |
| 15.5 | 33.78 | 33.68 | 33.27 | 33.58 |
| 16 | 33.73 | 33.65 | 33.21 | 33.53 |
| 16.5 | 33.69 | 33.61 | 33.16 | 33.49 |
| 17 | 33.64 | 33.58 | 33.10 | 33.44 |
| 17.5 | 33.60 | 33.55 | 33.05 | 33.40 |
| 18 | 33.56 | 33.52 | 33.00 | 33.36 |
| 18.5 | 33.52 | 33.49 | 32.94 | 33.32 |
| 19 | 33.48 | 33.46 | 32.89 | 33.28 |
| 19.5 | 33.44 | 33.43 | 32.84 | 33.24 |
| 20 | 33.40 | 33.40 | 32.79 | 33.20 |
| 20.5 | 33.37 | 33.38 | 32.74 | 33.16 |
| 21 | 33.33 | 33.35 | 32.70 | 33.13 |
| 21.5 | 33.30 | 33.33 | 32.65 | 33.09 |
| 22 | 33.27 | 33.30 | 32.60 | 33.06 |
| 22.5 | 33.24 | 33.28 | 32.55 | 33.02 |
| 23 | 33.21 | 33.25 | 32.51 | 32.99 |
| 23.5 | 33.18 | 33.23 | 32.46 | 32.96 |
| 24 | 33.15 | 33.21 | 32.42 | 32.93 |
| 24.5 | 33.12 | 33.19 | 32.38 | 32.90 |
| 25 | 33.09 | 33.17 | 32.33 | 32.87 |
| 25.5 | 33.07 | 33.15 | 32.29 | 32.84 |
| 26 | 33.04 | 33.13 | 32.25 | 32.81 |
| 26.5 | 33.02 | 33.11 | 32.21 | 32.78 |
| 27 | 32.99 | 33.09 | 32.17 | 32.75 |
| 27.5 | 32.97 | 33.08 | 32.13 | 32.72 |
| 28 | 32.95 | 33.06 | 32.09 | 32.70 |
| 28.5 | 32.92 | 33.04 | 32.05 | 32.67 |
| 29 | 32.90 | 33.03 | 32.01 | 32.65 |
| 29.5 | 32.88 | 33.01 | 31.98 | 32.62 |
| 30 | 32.86 | 33.00 | 31.94 | 32.60 |
| 30.5 | 32.84 | 32.98 | 31.90 | 32.58 |
| 31 | 32.82 | 32.97 | 31.87 | 32.55 |
| 31.5 | 32.80 | 32.95 | 31.83 | 32.53 |
| 32 | 32.79 | 32.94 | 31.80 | 32.51 |
| 32.5 | 32.77 | 32.93 | 31.76 | 32.49 |
| 33 | 32.75 | 32.91 | 31.73 | 32.47 |
| 33.5 | 32.74 | 32.90 | 31.70 | 32.44 |
| 34 | 32.72 | 32.89 | 31.66 | 32.42 |
| 34.5 | 32.70 | 32.88 | 31.63 | 32.40 |
| 35 | 32.69 | 32.87 | 31.60 | 32.39 |
| 35.5 | 32.68 | 32.86 | 31.57 | 32.37 |
| 36 | 32.66 | 32.85 | 31.54 | 32.35 |
| 36.5 | 32.65 | 32.84 | 31.51 | 32.33 |
| 37 | 32.63 | 32.83 | 31.48 | 32.31 |
| 37.5 | 32.62 | 32.82 | 31.45 | 32.30 |
| 38 | 32.61 | 32.81 | 31.42 | 32.28 |
| 38.5 | 32.60 | 32.80 | 31.39 | 32.26 |
| 39 | 32.59 | 32.79 | 31.36 | 32.25 |
| 39.5 | 32.57 | 32.78 | 31.33 | 32.23 |
| 40 | 32.56 | 32.77 | 31.31 | 32.21 |
| 40.5 | 32.55 | 32.76 | 31.28 | 32.20 |
| 41 | 32.54 | 32.76 | 31.25 | 32.18 |
| 41.5 | 32.53 | 32.75 | 31.23 | 32.17 |
| 42 | 32.52 | 32.74 | 31.20 | 32.16 |
| 42.5 | 32.51 | 32.73 | 31.18 | 32.14 |
| 43 | 32.50 | 32.73 | 31.15 | 32.13 |
| 43.5 | 32.49 | 32.72 | 31.13 | 32.11 |
| 44 | 32.49 | 32.71 | 31.10 | 32.10 |
| 44.5 | 32.48 | 32.71 | 31.08 | 32.09 |
| 45 | 32.47 | 32.70 | 31.06 | 32.08 |
| 45.5 | 32.46 | 32.70 | 31.03 | 32.06 |
| 46 | 32.45 | 32.69 | 31.01 | 32.05 |
| 46.5 | 32.45 | 32.68 | 30.99 | 32.04 |
| 47 | 32.44 | 32.68 | 30.96 | 32.03 |
| 47.5 | 32.43 | 32.67 | 30.94 | 32.02 |
| 48 | 32.42 | 32.67 | 30.92 | 32.00 |
| 48.5 | 32.42 | 32.66 | 30.90 | 31.99 |
| 49 | 32.41 | 32.66 | 30.88 | 31.98 |
| 49.5 | 32.41 | 32.65 | 30.86 | 31.97 |
| 50 | 32.40 | 32.65 | 30.84 | 31.96 |
| 50.5 | 32.39 | 32.64 | 30.82 | 31.95 |
| 51 | 32.39 | 32.64 | 30.80 | 31.94 |
| 51.5 | 32.38 | 32.64 | 30.78 | 31.93 |
| 52 | 32.38 | 32.63 | 30.76 | 31.92 |
| 52.5 | 32.37 | 32.63 | 30.74 | 31.91 |
| 53 | 32.37 | 32.62 | 30.72 | 31.90 |
| 53.5 | 32.36 | 32.62 | 30.71 | 31.90 |
| 54 | 32.36 | 32.62 | 30.69 | 31.89 |
| 54.5 | 32.35 | 32.61 | 30.67 | 31.88 |
| 55 | 32.35 | 32.61 | 30.65 | 31.87 |
| 55.5 | 32.34 | 32.61 | 30.64 | 31.86 |
| 56 | 32.34 | 32.60 | 30.62 | 31.85 |
| 56.5 | 32.33 | 32.60 | 30.60 | 31.85 |
| 57 | 32.33 | 32.60 | 30.59 | 31.84 |
| 57.5 | 32.33 | 32.60 | 30.57 | 31.83 |
| 58 | 32.32 | 32.59 | 30.55 | 31.82 |
| 58.5 | 32.32 | 32.59 | 30.54 | 31.82 |
| 59 | 32.32 | 32.59 | 30.52 | 31.81 |
| 59.5 | 32.31 | 32.58 | 30.51 | 31.80 |
| 60 | 32.31 | 32.58 | 30.49 | 31.79 |
| 60.5 | 32.31 | 32.58 | 30.48 | 31.79 |
| 61 | 32.30 | 32.58 | 30.46 | 31.78 |
| 61.5 | 32.30 | 32.57 | 30.45 | 31.77 |
| 62 | 32.30 | 32.57 | 30.43 | 31.77 |
| 62.5 | 32.29 | 32.57 | 30.42 | 31.76 |
| 63 | 32.29 | 32.57 | 30.41 | 31.76 |
| 63.5 | 32.29 | 32.57 | 30.39 | 31.75 |
| 64 | 32.29 | 32.56 | 30.38 | 31.74 |
| 64.5 | 32.28 | 32.56 | 30.37 | 31.74 |
| 65 | 32.28 | 32.56 | 30.35 | 31.73 |
| 65.5 | 32.28 | 32.56 | 30.34 | 31.73 |
| 66 | 32.28 | 32.56 | 30.33 | 31.72 |
| 66.5 | 32.27 | 32.56 | 30.32 | 31.72 |
| 67 | 32.27 | 32.55 | 30.30 | 31.71 |
| 67.5 | 32.27 | 32.55 | 30.29 | 31.70 |
| 68 | 32.27 | 32.55 | 30.28 | 31.70 |
| 68.5 | 32.27 | 32.55 | 30.27 | 31.69 |
| 69 | 32.26 | 32.55 | 30.26 | 31.69 |

TABLE 2E
Interpolated OTR for Polymer Blend 6

Interpolated OTR

| Day Since | | | | Avg OTR |
|---|---|---|---|---|
| Blowing | | | | for Polymer |
| Bottle | Bottle 1 | Bottle 2 | Bottle 3 | Blend-6 |
| 13 | 32.60 | 32.72 | 30.49 | 31.94 |
| 13.5 | 32.56 | 32.69 | 30.36 | 31.87 |
| 14 | 32.50 | 32.65 | 30.20 | 31.78 |
| 14.5 | 32.44 | 32.60 | 30.01 | 31.68 |
| 15 | 32.38 | 32.55 | 29.77 | 31.56 |
| 15.5 | 32.30 | 32.49 | 29.48 | 31.42 |
| 16 | 32.22 | 32.42 | 29.12 | 31.25 |
| 16.5 | 32.13 | 32.34 | 28.68 | 31.05 |
| 17 | 32.02 | 32.26 | 28.15 | 30.81 |
| 17.5 | 31.91 | 32.16 | 27.51 | 30.53 |
| 18 | 31.78 | 32.05 | 26.76 | 30.20 |
| 18.5 | 31.64 | 31.93 | 25.87 | 29.81 |
| 19 | 31.48 | 31.80 | 24.85 | 29.37 |
| 19.5 | 31.30 | 31.64 | 23.67 | 28.87 |
| 20 | 31.11 | 31.47 | 22.36 | 28.31 |
| 20.5 | 30.89 | 31.28 | 20.92 | 27.69 |
| 21 | 30.65 | 31.06 | 19.36 | 27.03 |
| 21.5 | 30.39 | 30.82 | 17.73 | 26.31 |
| 22 | 30.10 | 30.55 | 16.05 | 25.57 |
| 22.5 | 29.79 | 30.25 | 14.38 | 24.81 |
| 23 | 29.44 | 29.92 | 12.75 | 24.04 |
| 23.5 | 29.06 | 29.56 | 11.19 | 23.27 |
| 24 | 28.64 | 29.15 | 9.75 | 22.51 |
| 24.5 | 28.19 | 28.71 | 8.43 | 21.78 |
| 25 | 27.70 | 28.22 | 7.26 | 21.06 |
| 25.5 | 27.18 | 27.69 | 6.24 | 20.37 |
| 26 | 26.61 | 27.11 | 5.35 | 19.69 |
| 26.5 | 26.00 | 26.49 | 4.59 | 19.03 |
| 27 | 25.35 | 25.81 | 3.96 | 18.38 |
| 27.5 | 24.67 | 25.09 | 3.43 | 17.73 |
| 28 | 23.94 | 24.32 | 2.99 | 17.08 |
| 28.5 | 23.18 | 23.50 | 2.63 | 16.44 |
| 29 | 22.38 | 22.64 | 2.34 | 15.79 |
| 29.5 | 21.55 | 21.75 | 2.10 | 15.13 |
| 30 | 20.70 | 20.81 | 1.90 | 14.47 |
| 30.5 | 19.82 | 19.85 | 1.75 | 13.81 |
| 31 | 18.92 | 18.87 | 1.62 | 13.14 |
| 31.5 | 18.02 | 17.87 | 1.52 | 12.47 |
| 32 | 17.10 | 16.86 | 1.44 | 11.80 |
| 32.5 | 16.19 | 15.85 | 1.37 | 11.14 |
| 33 | 15.29 | 14.85 | 1.32 | 10.49 |
| 33.5 | 14.39 | 13.87 | 1.28 | 9.85 |
| 34 | 13.51 | 12.91 | 1.24 | 9.22 |
| 34.5 | 12.66 | 11.97 | 1.22 | 8.62 |
| 35 | 11.83 | 11.08 | 1.19 | 8.03 |
| 35.5 | 11.03 | 10.22 | 1.18 | 7.48 |
| 36 | 10.27 | 9.40 | 1.16 | 6.94 |
| 36.5 | 9.54 | 8.63 | 1.15 | 6.44 |
| 37 | 8.86 | 7.91 | 1.14 | 5.97 |
| 37.5 | 8.21 | 7.23 | 1.14 | 5.53 |
| 38 | 7.60 | 6.61 | 1.13 | 5.11 |
| 38.5 | 7.03 | 6.03 | 1.13 | 4.73 |
| 39 | 6.51 | 5.50 | 1.12 | 4.38 |
| 39.5 | 6.02 | 5.01 | 1.12 | 4.05 |
| 40 | 5.57 | 4.57 | 1.12 | 3.75 |
| 40.5 | 5.15 | 4.16 | 1.12 | 3.48 |
| 41 | 4.77 | 3.80 | 1.11 | 3.23 |
| 41.5 | 4.42 | 3.47 | 1.11 | 3.00 |
| 42 | 4.11 | 3.17 | 1.11 | 2.80 |
| 42.5 | 3.82 | 2.90 | 1.11 | 2.61 |
| 43 | 3.56 | 2.66 | 1.11 | 2.44 |
| 43.5 | 3.32 | 2.44 | 1.11 | 2.29 |
| 44 | 3.10 | 2.25 | 1.11 | 2.15 |
| 44.5 | 2.91 | 2.08 | 1.11 | 2.03 |
| 45 | 2.73 | 1.92 | 1.11 | 1.92 |
| 45.5 | 2.57 | 1.79 | 1.11 | 1.82 |
| 46 | 2.43 | 1.67 | 1.11 | 1.74 |
| 46.5 | 2.30 | 1.56 | 1.11 | 1.66 |
| 47 | 2.19 | 1.46 | 1.11 | 1.59 |
| 47.5 | 2.08 | 1.38 | 1.11 | 1.52 |
| 48 | 1.99 | 1.30 | 1.11 | 1.47 |
| 48.5 | 1.91 | 1.23 | 1.11 | 1.42 |
| 49 | 1.83 | 1.17 | 1.11 | 1.37 |
| 49.5 | 1.77 | 1.12 | 1.11 | 1.33 |
| 50 | 1.71 | 1.07 | 1.11 | 1.30 |
| 50.5 | 1.65 | 1.03 | 1.11 | 1.27 |
| 51 | 1.61 | 1.00 | 1.11 | 1.24 |
| 51.5 | 1.56 | 0.96 | 1.11 | 1.21 |
| 52 | 1.53 | 0.94 | 1.11 | 1.19 |
| 52.5 | 1.49 | 0.91 | 1.11 | 1.17 |
| 53 | 1.46 | 0.89 | 1.11 | 1.15 |
| 53.5 | 1.43 | 0.87 | 1.11 | 1.14 |
| 54 | 1.41 | 0.85 | 1.11 | 1.12 |
| 54.5 | 1.39 | 0.84 | 1.11 | 1.11 |
| 55 | 1.37 | 0.82 | 1.11 | 1.10 |
| 55.5 | 1.35 | 0.81 | 1.11 | 1.09 |
| 56 | 1.34 | 0.80 | 1.11 | 1.08 |
| 56.5 | 1.32 | 0.79 | 1.11 | 1.07 |
| 57 | 1.31 | 0.78 | 1.11 | 1.07 |
| 57.5 | 1.30 | 0.77 | 1.11 | 1.06 |
| 58 | 1.29 | 0.77 | 1.11 | 1.06 |
| 58.5 | 1.28 | 0.76 | 1.11 | 1.05 |
| 59 | 1.27 | 0.76 | 1.11 | 1.05 |
| 59.5 | 1.27 | 0.75 | 1.11 | 1.04 |
| 60 | 1.26 | 0.75 | 1.11 | 1.04 |
| 60.5 | 1.26 | 0.75 | 1.11 | 1.04 |
| 61 | 1.25 | 0.74 | 1.11 | 1.03 |
| 61.5 | 1.25 | 0.74 | 1.11 | 1.03 |
| 62 | 1.24 | 0.74 | 1.11 | 1.03 |
| 62.5 | 1.24 | 0.74 | 1.11 | 1.03 |
| 63 | 1.24 | 0.73 | 1.11 | 1.03 |
| 63.5 | 1.23 | 0.73 | 1.11 | 1.02 |
| 64 | 1.23 | 0.73 | 1.11 | 1.02 |
| 64.5 | 1.23 | 0.73 | 1.11 | 1.02 |
| 65 | 1.23 | 0.73 | 1.11 | 1.02 |
| 65.5 | 1.22 | 0.73 | 1.11 | 1.02 |
| 66 | 1.22 | 0.73 | 1.11 | 1.02 |
| 66.5 | 1.22 | 0.73 | 1.11 | 1.02 |
| 67 | 1.22 | 0.72 | 1.11 | 1.02 |
| 67.5 | 1.22 | 0.72 | 1.11 | 1.02 |
| 68 | 1.22 | 0.72 | 1.11 | 1.02 |
| 68.5 | 1.22 | 0.72 | 1.11 | 1.02 |
| 69 | 1.22 | 0.72 | 1.11 | 1.02 |

TABLE 2F
Interpolated OTR for Polymer Blend 7

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-7 |
| 13 | 4.13 | 4.13 | 2.04 | 3.43 |
| 13.5 | 3.76 | 3.76 | 1.86 | 3.13 |
| 14 | 3.42 | 3.42 | 1.71 | 2.85 |
| 14.5 | 3.11 | 3.11 | 1.58 | 2.60 |
| 15 | 2.84 | 2.84 | 1.46 | 2.38 |
| 15.5 | 2.58 | 2.58 | 1.36 | 2.18 |
| 16 | 2.36 | 2.36 | 1.27 | 1.99 |
| 16.5 | 2.15 | 2.15 | 1.19 | 1.83 |
| 17 | 1.97 | 1.97 | 1.12 | 1.69 |
| 17.5 | 1.81 | 1.81 | 1.06 | 1.56 |
| 18 | 1.66 | 1.66 | 1.01 | 1.45 |
| 18.5 | 1.53 | 1.53 | 0.97 | 1.34 |
| 19 | 1.41 | 1.41 | 0.93 | 1.25 |
| 19.5 | 1.31 | 1.31 | 0.90 | 1.17 |
| 20 | 1.22 | 1.22 | 0.87 | 1.10 |
| 20.5 | 1.14 | 1.14 | 0.85 | 1.04 |
| 21 | 1.06 | 1.06 | 0.83 | 0.98 |
| 21.5 | 1.00 | 1.00 | 0.81 | 0.94 |
| 22 | 0.94 | 0.94 | 0.80 | 0.89 |
| 22.5 | 0.89 | 0.89 | 0.78 | 0.85 |
| 23 | 0.84 | 0.84 | 0.77 | 0.82 |
| 23.5 | 0.80 | 0.80 | 0.76 | 0.79 |
| 24 | 0.77 | 0.77 | 0.75 | 0.76 |
| 24.5 | 0.74 | 0.74 | 0.75 | 0.74 |
| 25 | 0.71 | 0.71 | 0.74 | 0.72 |
| 25.5 | 0.69 | 0.69 | 0.73 | 0.70 |
| 26 | 0.66 | 0.66 | 0.73 | 0.69 |
| 26.5 | 0.64 | 0.64 | 0.72 | 0.67 |
| 27 | 0.63 | 0.63 | 0.72 | 0.66 |
| 27.5 | 0.61 | 0.61 | 0.72 | 0.65 |
| 28 | 0.60 | 0.60 | 0.72 | 0.64 |
| 28.5 | 0.59 | 0.59 | 0.71 | 0.63 |
| 29 | 0.58 | 0.58 | 0.71 | 0.62 |
| 29.5 | 0.57 | 0.57 | 0.71 | 0.62 |
| 30 | 0.56 | 0.56 | 0.71 | 0.61 |
| 30.5 | 0.55 | 0.55 | 0.71 | 0.60 |
| 31 | 0.55 | 0.55 | 0.71 | 0.60 |
| 31.5 | 0.54 | 0.54 | 0.71 | 0.60 |
| 32 | 0.54 | 0.54 | 0.70 | 0.59 |
| 32.5 | 0.53 | 0.53 | 0.70 | 0.59 |
| 33 | 0.53 | 0.53 | 0.70 | 0.59 |
| 33.5 | 0.53 | 0.53 | 0.70 | 0.58 |
| 34 | 0.52 | 0.52 | 0.70 | 0.58 |
| 34.5 | 0.52 | 0.52 | 0.70 | 0.58 |
| 35 | 0.52 | 0.52 | 0.70 | 0.58 |
| 35.5 | 0.52 | 0.52 | 0.70 | 0.58 |
| 36 | 0.51 | 0.51 | 0.70 | 0.58 |
| 36.5 | 0.51 | 0.51 | 0.70 | 0.58 |
| 37 | 0.51 | 0.51 | 0.70 | 0.57 |
| 37.5 | 0.51 | 0.51 | 0.70 | 0.57 |
| 38 | 0.51 | 0.51 | 0.70 | 0.57 |
| 38.5 | 0.51 | 0.51 | 0.70 | 0.57 |
| 39 | 0.51 | 0.51 | 0.70 | 0.57 |
| 39.5 | 0.51 | 0.51 | 0.70 | 0.57 |
| 40 | 0.50 | 0.50 | 0.70 | 0.57 |
| 40.5 | 0.50 | 0.50 | 0.70 | 0.57 |
| 41 | 0.504 | 0.504 | 0.700 | 0.569 |
| 41.5 | 0.50 | 0.50 | 0.70 | 0.57 |
| 42 | 0.50 | 0.50 | 0.70 | 0.57 |
| 42.5 | 0.50 | 0.50 | 0.70 | 0.57 |
| 43 | 0.50 | 0.50 | 0.70 | 0.57 |
| 43.5 | 0.50 | 0.50 | 0.70 | 0.57 |
| 44 | 0.50 | 0.50 | 0.70 | 0.57 |
| 44.5 | 0.50 | 0.50 | 0.70 | 0.57 |
| 45 | 0.50 | 0.50 | 0.70 | 0.57 |
| 45.5 | 0.50 | 0.50 | 0.70 | 0.57 |
| 46 | 0.50 | 0.50 | 0.70 | 0.57 |
| 46.5 | 0.50 | 0.50 | 0.70 | 0.57 |
| 47 | 0.50 | 0.50 | 0.70 | 0.57 |
| 47.5 | 0.50 | 0.50 | 0.70 | 0.57 |
| 48 | 0.50 | 0.50 | 0.70 | 0.57 |
| 48.5 | 0.50 | 0.50 | 0.70 | 0.57 |
| 49 | 0.50 | 0.50 | 0.70 | 0.57 |
| 49.5 | 0.50 | 0.50 | 0.70 | 0.57 |
| 50 | 0.50 | 0.50 | 0.70 | 0.57 |
| 50.5 | 0.50 | 0.50 | 0.70 | 0.57 |
| 51 | 0.50 | 0.50 | 0.70 | 0.57 |
| 51.5 | 0.50 | 0.50 | 0.70 | 0.57 |
| 52 | 0.50 | 0.50 | 0.70 | 0.57 |
| 52.5 | 0.50 | 0.50 | 0.70 | 0.57 |
| 53 | 0.50 | 0.50 | 0.70 | 0.57 |
| 53.5 | 0.50 | 0.50 | 0.70 | 0.57 |
| 54 | 0.50 | 0.50 | 0.70 | 0.57 |
| 54.5 | 0.50 | 0.50 | 0.70 | 0.57 |
| 55 | 0.50 | 0.50 | 0.70 | 0.57 |
| 55.5 | 0.50 | 0.50 | 0.70 | 0.57 |
| 56 | 0.50 | 0.50 | 0.70 | 0.57 |
| 56.5 | 0.50 | 0.50 | 0.70 | 0.57 |
| 57 | 0.50 | 0.50 | 0.70 | 0.57 |
| 57.5 | 0.50 | 0.50 | 0.70 | 0.57 |
| 58 | 0.50 | 0.50 | 0.70 | 0.57 |
| 58.5 | 0.50 | 0.50 | 0.70 | 0.57 |
| 59 | 0.50 | 0.50 | 0.70 | 0.57 |
| 59.5 | 0.50 | 0.50 | 0.70 | 0.57 |
| 60 | 0.50 | 0.50 | 0.70 | 0.57 |
| 60.5 | 0.50 | 0.50 | 0.70 | 0.57 |
| 61 | 0.50 | 0.50 | 0.70 | 0.57 |
| 61.5 | 0.50 | 0.50 | 0.70 | 0.57 |
| 62 | 0.50 | 0.50 | 0.70 | 0.57 |
| 62.5 | 0.50 | 0.50 | 0.70 | 0.57 |
| 63 | 0.50 | 0.50 | 0.70 | 0.57 |
| 63.5 | 0.50 | 0.50 | 0.70 | 0.57 |
| 64 | 0.50 | 0.50 | 0.70 | 0.57 |
| 64.5 | 0.50 | 0.50 | 0.70 | 0.57 |
| 65 | 0.50 | 0.50 | 0.70 | 0.57 |
| 65.5 | 0.50 | 0.50 | 0.70 | 0.57 |
| 66 | 0.50 | 0.50 | 0.70 | 0.57 |
| 66.5 | 0.50 | 0.50 | 0.70 | 0.57 |
| 67 | 0.50 | 0.50 | 0.70 | 0.57 |
| 67.5 | 0.50 | 0.50 | 0.70 | 0.57 |
| 68 | 0.50 | 0.50 | 0.70 | 0.57 |
| 68.5 | 0.50 | 0.50 | 0.70 | 0.57 |
| 69 | 0.50 | 0.50 | 0.70 | 0.57 |

TABLE 2G
Interpolated OTR for Polymer Blend 8

Interpolated OTR

| Day Since | | | | Avg OTR |
|---|---|---|---|---|
| Blowing | | | | for Polymer |
| Bottle | Bottle 1 | Bottle 2 | Bottle 3 | Blend-8 |
| 13 | 1.28 | 1.28 | 1.13 | 1.23 |
| 13.5 | 1.20 | 1.20 | 1.05 | 1.15 |
| 14 | 1.13 | 1.13 | 0.99 | 1.08 |
| 14.5 | 1.07 | 1.07 | 0.93 | 1.02 |
| 15 | 1.02 | 1.02 | 0.87 | 0.97 |
| 15.5 | 0.98 | 0.98 | 0.83 | 0.93 |
| 16 | 0.94 | 0.94 | 0.79 | 0.89 |
| 16.5 | 0.91 | 0.91 | 0.76 | 0.86 |
| 17 | 0.88 | 0.88 | 0.73 | 0.83 |
| 17.5 | 0.85 | 0.85 | 0.70 | 0.80 |
| 18 | 0.83 | 0.83 | 0.68 | 0.78 |
| 18.5 | 0.81 | 0.81 | 0.66 | 0.76 |
| 19 | 0.80 | 0.80 | 0.65 | 0.75 |
| 19.5 | 0.78 | 0.78 | 0.63 | 0.73 |
| 20 | 0.77 | 0.77 | 0.62 | 0.72 |
| 20.5 | 0.76 | 0.76 | 0.61 | 0.71 |
| 21 | 0.75 | 0.75 | 0.60 | 0.70 |
| 21.5 | 0.75 | 0.75 | 0.60 | 0.70 |
| 22 | 0.74 | 0.74 | 0.59 | 0.69 |
| 22.5 | 0.73 | 0.73 | 0.58 | 0.68 |
| 23 | 0.73 | 0.73 | 0.58 | 0.68 |
| 23.5 | 0.73 | 0.73 | 0.58 | 0.68 |
| 24 | 0.72 | 0.72 | 0.57 | 0.67 |
| 24.5 | 0.72 | 0.72 | 0.57 | 0.67 |
| 25 | 0.72 | 0.72 | 0.57 | 0.67 |
| 25.5 | 0.71 | 0.71 | 0.56 | 0.66 |
| 26 | 0.71 | 0.71 | 0.56 | 0.66 |
| 26.5 | 0.71 | 0.71 | 0.56 | 0.66 |
| 27 | 0.71 | 0.71 | 0.56 | 0.66 |
| 27.5 | 0.71 | 0.71 | 0.56 | 0.66 |
| 28 | 0.71 | 0.71 | 0.56 | 0.66 |
| 28.5 | 0.71 | 0.71 | 0.56 | 0.66 |
| 29 | 0.70 | 0.70 | 0.55 | 0.65 |
| 29.5 | 0.70 | 0.70 | 0.55 | 0.65 |
| 30 | 0.70 | 0.70 | 0.55 | 0.65 |
| 30.5 | 0.70 | 0.70 | 0.55 | 0.65 |
| 31 | 0.70 | 0.70 | 0.55 | 0.65 |
| 31.5 | 0.70 | 0.70 | 0.55 | 0.65 |
| 32 | 0.70 | 0.70 | 0.55 | 0.65 |
| 32.5 | 0.70 | 0.70 | 0.55 | 0.65 |
| 33 | 0.70 | 0.70 | 0.55 | 0.65 |
| 33.5 | 0.70 | 0.70 | 0.55 | 0.65 |
| 34 | 0.70 | 0.70 | 0.55 | 0.65 |
| 34.5 | 0.70 | 0.70 | 0.55 | 0.65 |
| 35 | 0.70 | 0.70 | 0.55 | 0.65 |
| 35.5 | 0.70 | 0.70 | 0.55 | 0.65 |
| 36 | 0.70 | 0.70 | 0.55 | 0.65 |
| 36.5 | 0.70 | 0.70 | 0.55 | 0.65 |
| 37 | 0.70 | 0.70 | 0.55 | 0.65 |
| 37.5 | 0.70 | 0.70 | 0.55 | 0.65 |
| 38 | 0.70 | 0.70 | 0.55 | 0.65 |
| 38.5 | 0.70 | 0.70 | 0.55 | 0.65 |
| 39 | 0.70 | 0.70 | 0.55 | 0.65 |
| 39.5 | 0.70 | 0.70 | 0.55 | 0.65 |
| 40 | 0.70 | 0.70 | 0.55 | 0.65 |
| 40.5 | 0.70 | 0.70 | 0.55 | 0.65 |
| 41 | 0.70 | 0.70 | 0.55 | 0.65 |
| 41.5 | 0.70 | 0.70 | 0.55 | 0.65 |
| 42 | 0.70 | 0.70 | 0.55 | 0.65 |
| 42.5 | 0.70 | 0.70 | 0.55 | 0.65 |
| 43 | 0.70 | 0.70 | 0.55 | 0.65 |
| 43.5 | 0.70 | 0.70 | 0.55 | 0.65 |
| 44 | 0.70 | 0.70 | 0.55 | 0.65 |
| 44.5 | 0.70 | 0.70 | 0.55 | 0.65 |
| 45 | 0.70 | 0.70 | 0.55 | 0.65 |
| 45.5 | 0.70 | 0.70 | 0.55 | 0.65 |
| 46 | 0.70 | 0.70 | 0.55 | 0.65 |
| 46.5 | 0.70 | 0.70 | 0.55 | 0.65 |
| 47 | 0.70 | 0.70 | 0.55 | 0.65 |
| 47.5 | 0.70 | 0.70 | 0.55 | 0.65 |
| 48 | 0.70 | 0.70 | 0.55 | 0.65 |
| 48.5 | 0.70 | 0.70 | 0.55 | 0.65 |
| 49 | 0.70 | 0.70 | 0.55 | 0.65 |
| 49.5 | 0.70 | 0.70 | 0.55 | 0.65 |
| 50 | 0.70 | 0.70 | 0.55 | 0.65 |
| 50.5 | 0.70 | 0.70 | 0.55 | 0.65 |
| 51 | 0.70 | 0.70 | 0.55 | 0.65 |
| 51.5 | 0.70 | 0.70 | 0.55 | 0.65 |
| 52 | 0.70 | 0.70 | 0.55 | 0.65 |
| 52.5 | 0.70 | 0.70 | 0.55 | 0.65 |
| 53 | 0.70 | 0.70 | 0.55 | 0.65 |
| 53.5 | 0.70 | 0.70 | 0.55 | 0.65 |
| 54 | 0.70 | 0.70 | 0.55 | 0.65 |
| 54.5 | 0.70 | 0.70 | 0.55 | 0.65 |
| 55 | 0.70 | 0.70 | 0.55 | 0.65 |
| 55.5 | 0.70 | 0.70 | 0.55 | 0.65 |
| 56 | 0.70 | 0.70 | 0.55 | 0.65 |
| 56.5 | 0.70 | 0.70 | 0.55 | 0.65 |
| 57 | 0.70 | 0.70 | 0.55 | 0.65 |
| 57.5 | 0.70 | 0.70 | 0.55 | 0.65 |
| 58 | 0.70 | 0.70 | 0.55 | 0.65 |
| 58.5 | 0.70 | 0.70 | 0.55 | 0.65 |
| 59 | 0.70 | 0.70 | 0.55 | 0.65 |
| 59.5 | 0.70 | 0.70 | 0.55 | 0.65 |
| 60 | 0.70 | 0.70 | 0.55 | 0.65 |
| 60.5 | 0.70 | 0.70 | 0.55 | 0.65 |
| 61 | 0.70 | 0.70 | 0.55 | 0.65 |
| 61.5 | 0.70 | 0.70 | 0.55 | 0.65 |
| 62 | 0.70 | 0.70 | 0.55 | 0.65 |
| 62.5 | 0.70 | 0.70 | 0.55 | 0.65 |
| 63 | 0.70 | 0.70 | 0.55 | 0.65 |
| 63.5 | 0.70 | 0.70 | 0.55 | 0.65 |
| 64 | 0.70 | 0.70 | 0.55 | 0.65 |
| 64.5 | 0.70 | 0.70 | 0.55 | 0.65 |
| 65 | 0.70 | 0.70 | 0.55 | 0.65 |
| 65.5 | 0.70 | 0.70 | 0.55 | 0.65 |
| 66 | 0.70 | 0.70 | 0.55 | 0.65 |
| 66.5 | 0.70 | 0.70 | 0.55 | 0.65 |
| 67 | 0.70 | 0.70 | 0.55 | 0.65 |
| 67.5 | 0.70 | 0.70 | 0.55 | 0.65 |
| 68 | 0.70 | 0.70 | 0.55 | 0.65 |
| 68.5 | 0.70 | 0.70 | 0.55 | 0.65 |
| 69 | 0.70 | 0.70 | 0.55 | 0.65 |

TABLE 2H
Average OTR for Polymer Blends 5 through 8

| Day Since | Comparative | Comparative | | |
|---|---|---|---|---|
| Blowing | Polymer | Polymer | Polymer | Polymer |
| Bottle | Blend-5 | Blend-6 | Blend-7 | Blend-8 |
| 13 | 33.82 | 31.94 | 3.43 | 1.23 |
| 13.5 | 33.77 | 31.87 | 3.13 | 1.15 |
| 14 | 33.72 | 31.78 | 2.85 | 1.08 |
| 14.5 | 33.67 | 31.68 | 2.60 | 1.02 |
| 15 | 33.62 | 31.56 | 2.38 | 0.97 |
| 15.5 | 33.58 | 31.42 | 2.18 | 0.93 |
| 16 | 33.53 | 31.25 | 1.99 | 0.89 |
| 16.5 | 33.49 | 31.05 | 1.83 | 0.86 |
| 17 | 33.44 | 30.81 | 1.69 | 0.83 |
| 17.5 | 33.40 | 30.53 | 1.56 | 0.80 |
| 18 | 33.36 | 30.20 | 1.45 | 0.78 |
| 18.5 | 33.32 | 29.81 | 1.34 | 0.76 |
| 19 | 33.28 | 29.37 | 1.25 | 0.75 |
| 19.5 | 33.24 | 28.87 | 1.17 | 0.73 |
| 20 | 33.20 | 28.31 | 1.10 | 0.72 |
| 20.5 | 33.16 | 27.69 | 1.04 | 0.71 |
| 21 | 33.13 | 27.03 | 0.98 | 0.70 |
| 21.5 | 33.09 | 26.31 | 0.94 | 0.70 |
| 22 | 33.06 | 25.57 | 0.89 | 0.69 |
| 22.5 | 33.02 | 24.81 | 0.85 | 0.68 |
| 23 | 32.99 | 24.04 | 0.82 | 0.68 |
| 23.5 | 32.96 | 23.27 | 0.79 | 0.68 |
| 24 | 32.93 | 22.51 | 0.76 | 0.67 |
| 24.5 | 32.90 | 21.78 | 0.74 | 0.67 |
| 25 | 32.87 | 21.06 | 0.72 | 0.67 |
| 25.5 | 32.84 | 20.37 | 0.70 | 0.66 |
| 26 | 32.81 | 19.69 | 0.69 | 0.66 |
| 26.5 | 32.78 | 19.03 | 0.67 | 0.66 |
| 27 | 32.75 | 18.38 | 0.66 | 0.66 |
| 27.5 | 32.72 | 17.73 | 0.65 | 0.66 |
| 28 | 32.70 | 17.08 | 0.64 | 0.66 |
| 28.5 | 32.67 | 16.44 | 0.63 | 0.66 |
| 29 | 32.65 | 15.79 | 0.62 | 0.65 |
| 29.5 | 32.62 | 15.13 | 0.62 | 0.65 |
| 30 | 32.60 | 14.47 | 0.61 | 0.65 |
| 30.5 | 32.58 | 13.81 | 0.60 | 0.65 |
| 31 | 32.55 | 13.14 | 0.60 | 0.65 |
| 31.5 | 32.53 | 12.47 | 0.60 | 0.65 |
| 32 | 32.51 | 11.80 | 0.59 | 0.65 |
| 32.5 | 32.49 | 11.14 | 0.59 | 0.65 |
| 33 | 32.47 | 10.49 | 0.59 | 0.65 |
| 33.5 | 32.44 | 9.85 | 0.58 | 0.65 |
| 34 | 32.42 | 9.22 | 0.58 | 0.65 |
| 34.5 | 32.40 | 8.62 | 0.58 | 0.65 |
| 35 | 32.39 | 8.03 | 0.58 | 0.65 |
| 35.5 | 32.37 | 7.48 | 0.58 | 0.65 |
| 36 | 32.35 | 6.94 | 0.58 | 0.65 |
| 36.5 | 32.33 | 6.44 | 0.58 | 0.65 |
| 37 | 32.31 | 5.97 | 0.57 | 0.65 |
| 37.5 | 32.30 | 5.53 | 0.57 | 0.65 |
| 38 | 32.28 | 5.11 | 0.57 | 0.65 |
| 38.5 | 32.26 | 4.73 | 0.57 | 0.65 |
| 39 | 32.25 | 4.38 | 0.57 | 0.65 |
| 39.5 | 32.23 | 4.05 | 0.57 | 0.65 |
| 40 | 32.21 | 3.75 | 0.57 | 0.65 |
| 40.5 | 32.20 | 3.48 | 0.57 | 0.65 |
| 41 | 32.18 | 3.23 | 0.57 | 0.65 |
| 41.5 | 32.17 | 3.00 | 0.57 | 0.65 |
| 42 | 32.16 | 2.80 | 0.57 | 0.65 |
| 42.5 | 32.14 | 2.61 | 0.57 | 0.65 |
| 43 | 32.13 | 2.44 | 0.57 | 0.65 |
| 43.5 | 32.11 | 2.29 | 0.57 | 0.65 |
| 44 | 32.10 | 2.15 | 0.57 | 0.65 |
| 44.5 | 32.09 | 2.03 | 0.57 | 0.65 |
| 45 | 32.08 | 1.92 | 0.57 | 0.65 |
| 45.5 | 32.06 | 1.82 | 0.57 | 0.65 |
| 46 | 32.05 | 1.74 | 0.57 | 0.65 |
| 46.5 | 32.04 | 1.66 | 0.57 | 0.65 |
| 47 | 32.03 | 1.59 | 0.57 | 0.65 |
| 47.5 | 32.02 | 1.52 | 0.57 | 0.65 |
| 48 | 32.00 | 1.47 | 0.57 | 0.65 |
| 48.5 | 31.99 | 1.42 | 0.57 | 0.65 |
| 49 | 31.98 | 1.37 | 0.57 | 0.65 |
| 49.5 | 31.97 | 1.33 | 0.57 | 0.65 |
| 50 | 31.96 | 1.30 | 0.57 | 0.65 |
| 50.5 | 31.95 | 1.27 | 0.57 | 0.65 |
| 51 | 31.94 | 1.24 | 0.57 | 0.65 |
| 51.5 | 31.93 | 1.21 | 0.57 | 0.65 |
| 52 | 31.92 | 1.19 | 0.57 | 0.65 |
| 52.5 | 31.91 | 1.17 | 0.57 | 0.65 |
| 53 | 31.90 | 1.15 | 0.57 | 0.65 |
| 53.5 | 31.90 | 1.14 | 0.57 | 0.65 |
| 54 | 31.89 | 1.12 | 0.57 | 0.65 |
| 54.5 | 31.88 | 1.11 | 0.57 | 0.65 |
| 55 | 31.87 | 1.10 | 0.57 | 0.65 |
| 55.5 | 31.86 | 1.09 | 0.57 | 0.65 |
| 56 | 31.85 | 1.08 | 0.57 | 0.65 |
| 56.5 | 31.85 | 1.07 | 0.57 | 0.65 |
| 57 | 31.84 | 1.07 | 0.57 | 0.65 |
| 57.5 | 31.83 | 1.06 | 0.57 | 0.65 |
| 58 | 31.82 | 1.06 | 0.57 | 0.65 |
| 58.5 | 31.82 | 1.05 | 0.57 | 0.65 |
| 59 | 31.81 | 1.05 | 0.57 | 0.65 |
| 59.5 | 31.80 | 1.04 | 0.57 | 0.65 |
| 60 | 31.79 | 1.04 | 0.57 | 0.65 |
| 60.5 | 31.79 | 1.04 | 0.57 | 0.65 |
| 61 | 31.78 | 1.03 | 0.57 | 0.65 |
| 61.5 | 31.77 | 1.03 | 0.57 | 0.65 |
| 62 | 31.77 | 1.03 | 0.57 | 0.65 |
| 62.5 | 31.76 | 1.03 | 0.57 | 0.65 |
| 63 | 31.76 | 1.03 | 0.57 | 0.65 |
| 63.5 | 31.75 | 1.02 | 0.57 | 0.65 |
| 64 | 31.74 | 1.02 | 0.57 | 0.65 |
| 64.5 | 31.74 | 1.02 | 0.57 | 0.65 |
| 65 | 31.73 | 1.02 | 0.57 | 0.65 |
| 65.5 | 31.73 | 1.02 | 0.57 | 0.65 |
| 66 | 31.72 | 1.02 | 0.57 | 0.65 |
| 66.5 | 31.72 | 1.02 | 0.57 | 0.65 |
| 67 | 31.71 | 1.02 | 0.57 | 0.65 |
| 67.5 | 31.70 | 1.02 | 0.57 | 0.65 |
| 68 | 31.70 | 1.02 | 0.57 | 0.65 |
| 68.5 | 31.69 | 1.02 | 0.57 | 0.65 |
| 69 | 31.69 | 1.02 | 0.57 | 0.65 |

TABLE 2I
OxySense Test Results for Polymer Blends 5 through 8

| | | | | | OTR | | |
|---|---|---|---|---|---|---|---|
| | PET Li/Al/P | | % MXD-6 | | Days to 5 μL/day | | |
| Sample | (ppm) | It. V. | (by ¹H NMR) | Co (ppm) | Average | Min | Max |
| Comparative Polymer Blend-5 | — | 0.704 | 1.45 | 90.2 | >60 | — | — |
| Comparative Polymer Blend-6 | — | 0.698 | 1.33 | 95.8 | 38 | 26 | 41 |
| Polymer Blend-7 | 8.3/12.3/57.1 | 0.714 | 1.18 | 46.5 | <6 | <6 | <6 |
| Polymer Blend-8 | 8.1/10.6/55.1 | 0.68 | 1.24 | 88.6 | <6 | <6 | <6 |

TABLE 2J
Days to OTR less than or equal to 5 μl/day for Polymer Blends 5 through 8

| | pO2 (mbar) | | | pO2 (mbar) | | | pO2 (mbar) | | | pO2 (mbar) | | |
|---|---|---|---|---|---|---|---|---|---|---|---|---|
| | for Polymer Blend 5 | | | for Polymer Blend 6 | | | for Polymer Blend 7 | | | for Polymer Blend 8 | | |
| | Ampoule | | | Ampoule | | | Ampoule | | | Ampoule | | |
| Day | 1 | Ampoule 2 | Average | 1 | Ampoule 2 | Average | 1 | Ampoule 2 | Average | 1 | Ampoule 2 | Average |
| 0 | 210 | 206 | 208 | 199 | 203 | 201 | 209 | 204 | 206 | 209 | 211 | 210 |
| 1 | 221 | 222 | 222 | 215 | 213 | 214 | 222 | 219 | 220 | 218 | 213 | 216 |
| 2 | 222 | 221 | 221 | 212 | 214 | 213 | 221 | 217 | 219 | 213 | 211 | 212 |
| 3 | 218 | 214 | 216 | 215 | 216 | 215 | 223 | 219 | 221 | 207 | 202 | 205 |
| 4 | 217 | 212 | 214 | 212 | 212 | 212 | 217 | 219 | 218 | 203 | 195 | 199 |

### Example 3

Below is a description of the PET polymers used to prepare each of Polymer Blends 9 through 16. Comparative Polymer Blends 9 and 16 and comparative Blends 10 and 15 differ in the carrier resin used to introduce the cobalt (Table 3A). Also, Polymer Blends 12 and 13 differ, even though the same PET polymer was used, because different quantities of cobalt were added to the same PET-5 polymer. The metal quantities in Polymer Blends 9 through 16 were determined by Inductively Coupled Plasma Optical Emission Spectroscopy (ICP) and are set forth in Table 3A.

PET-1 is the same as previously described in Example 1.

PET-2 is the same as previously described in Example 1.

PET-3 is the same as previously described in Example 1.

PET-4 is the same as previously described in Example 2.

The cobalt concentrate is the same as previously described in Example 1.

The “Alternative” cobalt concentrate was a solid concentrate prepared by melt-blending 2.22 wt percent cobalt neodecanoate (sold as “22.5% TEN-CEM cobalt” by OMG Americas, Westlake, Ohio) with 97.78 wt percent polyethylene terephthalate polymer (sold as “PET 9921” by Eastman Chemical Company). X-ray analysis confirmed the cobalt concentrate to contain 5100 ppm cobalt metal.

The polyamide used was as previously described in Example 1.

### Polymer Blend 9 (Comparative)

Comparative Polymer Blend 9 was prepared by separately grinding PET-1 (96.25 g) and MXD-6 (1.5 g) to pass through a 3 mm screen, cryogenically pulverizing the cobalt concentrate (2.25 g) (Table 3B), and then combining and drying the three components at 60° C. for 3 days in a vacuum oven with nitrogen purge. The dry-mixed blend was introduced into the feed hopper of a DACA MicroCompounder (DACA Instruments, Goleta, Calif.), and the melt extruded into a strand and pelletized. Processing conditions for the twin-screw DACA MicroCompounder are given in Table 3C.

### Polymer Blend 10 (Comparative)

Comparative Polymer Blend 10 was prepared as described for Polymer Blend 9 using PET-2 (96.25 g) and MXD-6 (1.5 g), cobalt concentrate (2.25 g), and extruded into pellets (Table 3B).

### Polymer Blend 11 (Inventive)

Polymer Blend 11 was prepared as described for Polymer Blend 9 using PET-4 (96.25 g) and MXD-6 (1.5 g), cobalt concentrate (2.25 g) and extruded into pellets (Table 3B).

### Polymer Blend 12 (Inventive)

Polymer Blend 12 was prepared as described for Polymer Blend 9 using PET-4 (97.38 g) and MXD-6 (1.5 g), cobalt concentrate (1.125 g) and extruded into pellets (Table 3B).

### Polymer Blend 13 (Inventive)

Polymer Blend 13 was prepared as described for Polymer Blend 9 using PET-3 (96.25 g) and MXD-6 (1.5 g), cobalt concentrate (2.25 g) and extruded into pellets (Table 3B).

### Polymer Blend 14 (Inventive)

Polymer Blend 14 was prepared as described for Polymer Blend 9 using PET-4 (96.25 g) and MXD-6 (1.5 g), the Alternative Cobalt Concentrate (2.25 g) and extruded into pellets (Table 3B).

### Polymer Blend 15 (Comparative)

Polymer Blend 15 was prepared as described for Polymer Blend 9 using PET-2 (96.25 g) and MXD-6 (1.5 g), the Alternative Cobalt Concentrate (2.25 g) and extruded into pellets (Table 3B).

### Polymer Blend 16 (Comparative)

Polymer Blend 16 was prepared as described for Polymer Blend 9 using PET-1 (96.25 g) and MXD-6 (1.5 g), the Alternative Cobalt Concentrate (2.25 g) and extruded into pellets (Table 3B).

The oxygen scavenging effect of Polymer Blends 9 through 16 were evaluated using oxygen absorption uptake measurements obtained by means of the OxySense Test, as already described. One gram of pellets extruded by the DACA Microcompounder for each of Polymer Blends 9 through 16 were pulverized and introduced in glass ampoules as described for Example 1. Replicate OxySense Test results are reported for each blend in Table 3D.

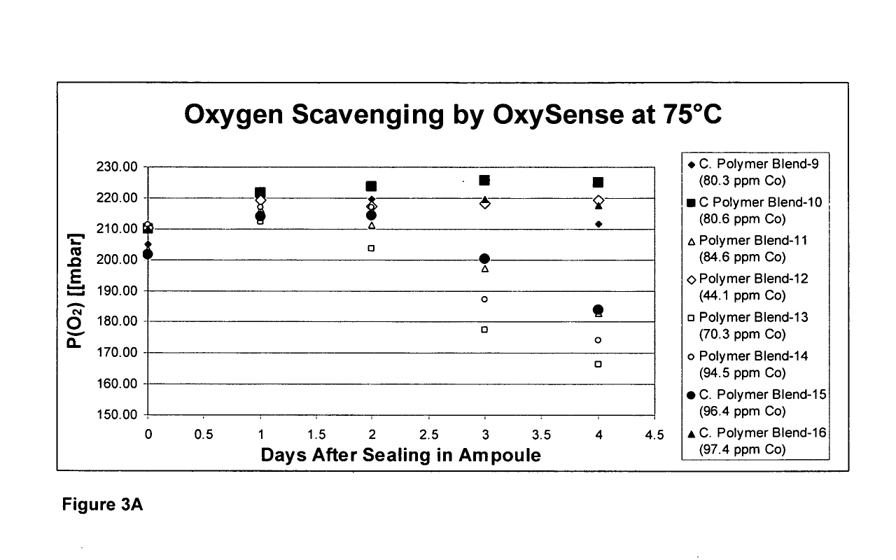

The oxygen scavenging, as measured by the OxySense Test, for inventive Polymer Blends 11, 13, and 14 (Table 3D and FIG. 3A), prepared using PET-4, PET-3, and PET-4, respectively (both prepared using aluminum and lithium catalysts by melt-phase-only polymerization), suggest the inventive blends do exhibit oxygen scavenging effect. These oxygen scavenging effects, although qualitative, are consistent with the quantitative OTR results for inventive Polymer Blends 7 and 8 of Example 2 also prepared using PET-3 and PET-4, respectively. However, comparison of inventive Polymer Blends 11 to 12 suggests a sensitivity of oxygen scavenging effect to the cobalt loading as demonstrated by the reduced oxygen uptake by Polymer Blend 12 with a reduced cobalt loading of 44.1 ppm (FIG. 3A), whereas Polymer Blend 11 with a higher cobalt loading of 84.6 ppm cobalt exhibits an oxygen uptake within four days (FIG. 3A). Further, comparison of oxygen-scavenging uptake for inventive Polymer Blends 11 (prepared with Cobalt Concentrate) and Polymer Blend 14 (prepared with Alternative Cobalt Concentrate) suggest the oxygen scavenging effect of the inventive Polymer Blends may be insensitive to the carrier resin used to introduce the cobalt.

TABLE 3A
Metals analysis of Polymer Blends 9 through 16

| | Metals [ppm] by ICP | | | | | | | | | % MXD-6 |
|---|---|---|---|---|---|---|---|---|---|---|
| | Li | Al | Co | Fe | Mn | Ti | Sb | P | Zn | by 1H NMR |
| Comparative | <0.2 | <2 | 80.3 | 16.6 | 50.7 | 18.5 | 216 | 94.3 | 3.1 | 1.43 |
| Polymer Blend-9 | | | | | | | | | | |
| Comparative | <0.2 | <2 | 80.6 | 4.5 | <0.2 | <0.2 | 214 | 76.8 | 59.4 | 1.37 |
| Polymer Blend-10 | | | | | | | | | | |
| Polymer Blend-11 | 8 | 9.9 | 84.6 | 2.2 | 0.4 | 4.8 | 9.2 | 59.7 | 21.1 | 1.25 |
| Polymer Blend-12 | 8.2 | 12.1 | 44.1 | 1.1 | 0.3 | 3.7 | 5 | 57.4 | 1.2 | 1.19 |
| Polymer Blend-13 | 10.7 | 16.1 | 70.3 | 1.5 | <0.2 | 6.8 | 6.8 | 52.4 | 1.6 | 1.18 |
| Polymer Blend-14 | 8.1 | 13 | 94.5 | 0.6 | 1.3 | 1.9 | 7.8 | 55 | 0.8 | 1.29 |
| Polymer Blend-15 | <0.2 | <2 | 96.4 | 5.1 | 1.1 | 0.7 | 218 | 77.1 | 59.6 | 1.31 |
| Polymer Blend-16 | <0.2 | <2 | 97.4 | 15.5 | 51.7 | 19 | 213 | 94.6 | 1 | 1.44 |

TABLE 3B
Composition of Polymer Blends 9 through 16

| | | | | | Alternative |
|---|---|---|---|---|---|
| | | | MXD-6 | Cobalt | Cobalt |
| | PET | PET | 6007 | Concentrate | Concentrate |
| | Polymer | [g] | [g] | [g] | [g] |
| Comparative | PET-1 | 96.25 | 1.5 | 2.25 | — |
| Polymer Blend-9 | | | | | |
| Comparative | PET-2 | 96.25 | 1.5 | 2.25 | — |
| Polymer Blend-10 | | | | | |
| Polymer Blend-11 | PET-4 | 96.25 | 1.5 | 2.25 | — |
| Polymer Blend-12 | PET-4 | 97.38 | 1.5 | 1.125 | — |
| Polymer Blend-13 | PET-3 | 96.25 | 1.5 | 2.25 | — |
| Polymer Blend-14 | PET-4 | 96.25 | 1.5 | — | 2.25 |
| Polymer Blend-15 | PET-2 | 96.25 | 1.5 | — | 2.25 |
| Polymer Blend-16 | PET-1 | 96.25 | 1.5 | — | 2.25 |

TABLE 3C
DACA Mini-Injector Extrusion Parameters

| Machine Parameter | Setting |
|---|---|
| Heating Block | 285 |
| Temperature (° C.) | |
| Screw Speed (RPM) | 120 |

TABLE 3D
OxySense Test Results for Polymer Blends 9 through 16

| | pO2 (mbar) | | | pO2 (mbar) | | | pO2 (mbar) | | | pO2 (mbar) | | |
|---|---|---|---|---|---|---|---|---|---|---|---|---|
| | for Polymer Blend 9 | | | for Polymer Blend 10 | | | for Polymer Blend 11 | | | for Polymer Blend 12 | | |
| | Ampoule | | | Ampoule | | | Ampoule | | | Ampoule | | |
| Day | 1 | Ampoule 2 | Average | 1 | Ampoule 2 | Average | 1 | Ampoule 2 | Average | 1 | Ampoule 2 | Average |
| 0 | 211 | 198 | 205 | 215 | 204 | 210 | 198 | 208 | 203 | 215 | 206 | 210 |
| 1 | 218 | 209 | 214 | 223 | 220 | 222 | 212 | 221 | 216 | 220 | 219 | 219 |
| 2 | 223 | 217 | 220 | 230 | 218 | 224 | 207 | 216 | 211 | 219 | 215 | 217 |
| 3 | 222 | 216 | 219 | 230 | 221 | 226 | 192 | 203 | 197 | 219 | 217 | 218 |
| 4 | 215 | 208 | 212 | 230 | 220 | 225 | 179 | 187 | 183 | 222 | 216 | 219 |
| | pO2 (mbar) | | | pO2 (mbar) | | | pO2 (mbar) | | | pO2 (mbar) | | |
| | for Polymer Blend 13 | | | for Polymer Blend 14 | | | for Polymer Blend 15 | | | for Polymer Blend 16 | | |
| | Ampoule | | | Ampoule | | | Ampoule | | | Ampoule | | |
| Day | 1 | Ampoule 2 | Average | 1 | Ampoule 2 | Average | 1 | Ampoule 2 | Average | 1 | Ampoule 2 | Average |
| 0 | 204 | 198 | 201 | 219 | 204 | 211 | 200 | 193 | 201 | 211 | 208 | 210 |
| 1 | 213 | 211 | 212 | 223 | 211 | 217 | 214 | 211 | 214 | 216 | 214 | 215 |
| 2 | 213 | 194 | 204 | 223 | 211 | 217 | 216 | 211 | 214 | 216 | 214 | 215 |
| 3 | 178 | 177 | 178 | 192 | 182 | 187 | 212 | 201 | 200 | 222 | 217 | 219 |
| 4 | 167 | 166 | 166 | 177 | 172 | 174 | 191 | 186 | 184 | 216 | 219 | 218 |

### Example 4

Below is a description of the PET polymers used to prepare each of Polymer Blends 17 through 20. Polymer Blends 19 and 20 differ, even though the same PET polymer was used, because different quantities of cobalt were added to the same PET-4 polymer. The metal quantities in Polymer Blends 17 through 20 were determined by Inductively Coupled Plasma Optical Emission Spectroscopy (ICP), and are set forth in Table 4A.

PET-1 was the same as previously described in Example 1.

PET-2 was the same as previously described in Example 1.

PET-5 was a PET copolymer having residues of terephthalic acid, ethylene glycol, and isophthalic acid, with isophthalic acid residues representing about 2.9 mole % of the dicarboxylic acid residues. The polymer further contained about 10 to 15 ppm Al, about 7 to 10 ppm Li, and about 45 to 55 ppm phosphorous, all provided as a catalyst system, and further contained a reheat additive and red and blue toners. PET-5 was prepared by melt polymerizing the dicarboxylic acids and diol residues in the presence of the aluminum and lithium catalysts, the reheat additive, and the red and blue toners to an intrinsic viscosity of about 0.82 dL/g. The molten PET was then solidified and pelletized.

The glycol portion of each of the PET polymers also contained low levels (less than 5 mol %) of DEG residues, either present as a natural byproduct of the melt polymerization process and or intentionally added as a modifier, for example to maintain a consistent amount of DEG residues.

The cobalt concentrate was the same as previously described in Example 1.

The polyamide used was previously described in Example 1.

### Polymer Blend 17 (Comparative)

Polymer Blend 17 was prepared using PET-1 (963 g), MXD-6™ (15 g), and cobalt concentrate (22.5 g), as previously described in Example 1, in the amounts given in Table 4B. Polymer Blend 17 was injection-molded into preforms and blown into bottles as described for Polymer Blend 1.

### Polymer Blend 18 (Comparative)

Polymer Blend was prepared using PET-2 (963 g), MXD-6™ (15 g), and cobalt concentrate (22.5 g), as described for Polymer Blend 1 in the amounts give in Table 4B. Polymer Blend 18 was injection-molded into preforms and blown into bottles, as described for Polymer Blend 1.

### Polymer Blend 19 (Inventive)

Polymer Blend 17 was prepared using PET-5 (974 g), MXD-6™ (15 g), and cobalt concentrate (11.25 g) as described above for Polymer Blend 1, in the amounts given in Table 4B. Polymer Blend 19 was injection-molded into preforms and blown into bottles, as described for Polymer Blend 1.

### Polymer Blend 20 (Inventive)

Polymer Blend 20 was prepared using PET-4 (963 g), MXD-6™ (15 g), and cobalt concentrate (22.5 g) as described above for Polymer Blend 1, in the amounts given in Table 4B. Polymer Blend 19 was injection-molded into preforms and blown into bottles, as described for Polymer Blend 1.

The ability of Polymer Blends 17 through 20 to scavenge oxygen was evaluated using the OxySense Test and the OTR Test.

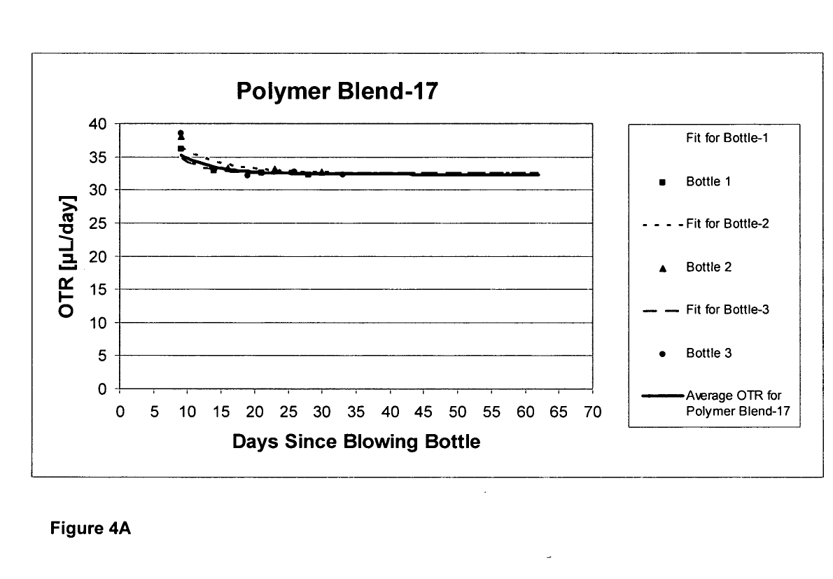

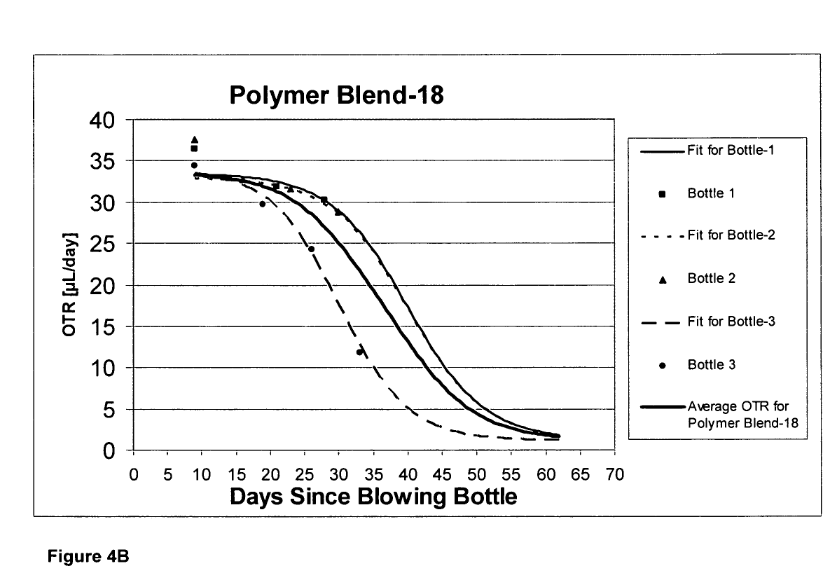

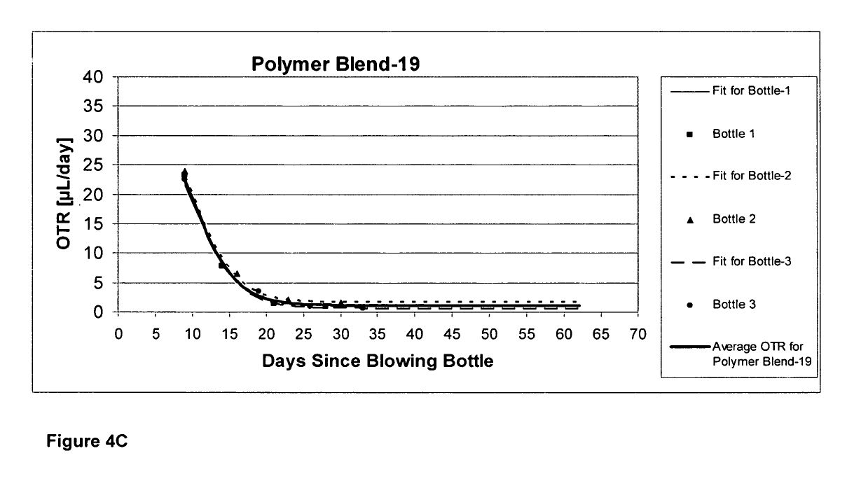

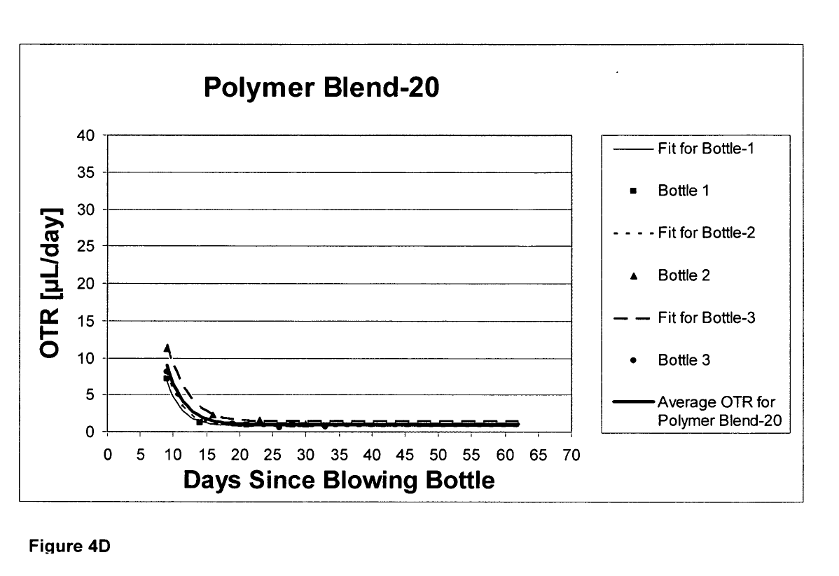

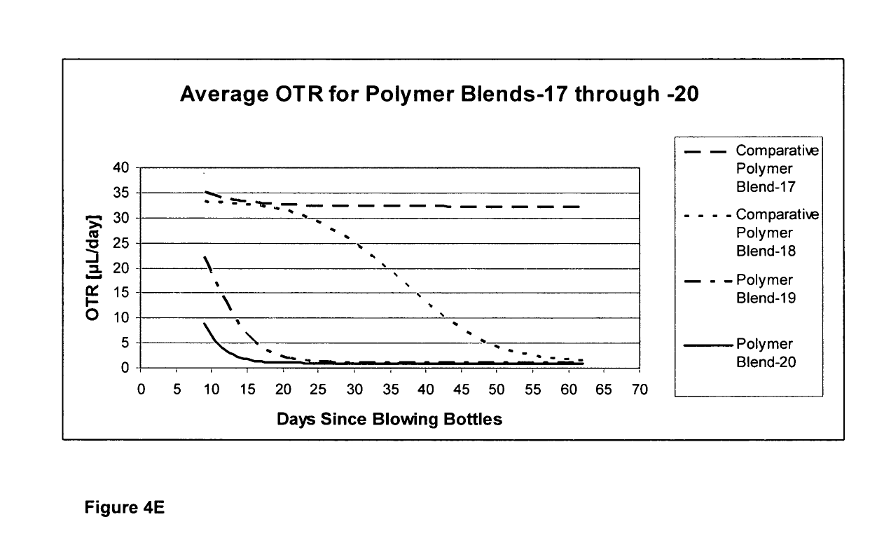

Three stretch-blown bottles prepared using each of the four Polymer Blends 17 through 20 were tested for OTR periodically for approximately 33-days following blow molding (Tables 4C). The OTR for each set of three bottles for Polymer Blends 17 through 20 are plotted in FIGS. 4A-4D, respectively, and each set of data corresponding to a single bottle has a non-linear curve superimposed over the OTR data. The x- and y-coordinates for the non-linear curves are reported in Tables 4D-4G allowing interpolation of the OTR (i.e., y-coordinates) for all “days-since-blowing” (i.e., x-coordinates) throughout the test period. As described in Example 1, the OTR of the three bottles were mathematically averaged for all days-since-blow-molding (i.e., all x-coordinates) over the entire test period and an average OTR curve was calculated for each of Polymer Blends 17 through 20 (Tables 4D-4G and 4H and FIG. 4E).

Oxygen scavenging was also evaluated, by the OxySense Test, of Polymer Blends 17 through 20, as described above in Example 1. Replicate OxySense Test results are reported for each blend in Table 4.

Inventive Polymer Blends 19 and 20, prepared using PET-5 (an aluminum- and lithium-catalyzed PET polymer prepared by melt-phase-only polymerization), exhibited shorter induction periods than comparative Polymer Blends 17 and 18 (see Table 4J and FIG. 4E). Bottles prepared with inventive Polymer Blends 19 and 20 reach an OTR of 5 μL/day in 16 and 12 days, respectively, whereas comparative Polymer Blends 17 and 18 required greater than 60 and 49 days, respectively, to achieve the same 5 μL/day (Table 4J and FIG. 4E).

TABLE 4A
Metals analysis of Polymer Blends 17 through 20

| | Metals [ppm] by ICP | | | | | | | | |
|---|---|---|---|---|---|---|---|---|---|
| | Li | Al | Co | Fe | Mn | Ti | Sb | P | Zn |
| Comparative Polymer | <0.2 | 2^{†} | 88.2 | 19.3 | 53 | 19.4 | 220 | 97.6 | 2.2 |
| Blend-17 | | | | | | | | | |
| Comparative Polymer | <0.2 | 2.1^{†} | 80.1 | 5.5 | 0.6 | 0.4 | 214 | 75.8 | 59.4 |
| Blend-18 | | | | | | | | | |
| Polymer Blend-19 | 8.8 | 13.2 | 32.1 | 0.8 | 0.4 | 5.2 | 2.6 | 48.7 | 0.7 |
| Polymer Blend-20 | 8.6 | 11.7 | 85.6 | 1.1 | 0.3 | 5.2 | 5.4 | 51.8 | 1.5 |

^{†}Although both Comparative Blends-17 and -18 are reported to have low levels of aluminum, neither sample was prepared with aluminum. Comparative Blends-17 and -18 were retested and found to be less than the detectable limit of 2 ppm aluminum.

TABLE 4B
Composition of Polymer Blends 17 through 20

| | | | | Cobalt |
|---|---|---|---|---|
| | PET | PET | MXD-6 6007 | Concentrate |
| | Polymer | [g] | [g] | [g] |
| Comparative Polymer | PET-1 | 963 | 15 | 22.5 |
| Blend-17 | | | | |
| Comparative Polymer | PET-2 | 963 | 15 | 22.5 |
| Blend-18 | | | | |
| Polymer Blend-19 | PET-5 | 974 | 15 | 11.25 |
| Polymer Blend-20 | PET-5 | 963 | 15 | 22.5 |

TABLE 4C
Oxygen Transmission Rate (OTR) for Polymer Blends 17 through 20

| | OTR for | | | OTR for | | | OTR for | | | OTR for | | |
|---|---|---|---|---|---|---|---|---|---|---|---|---|
| | Sample 17 | | | Sample 18 | | | Sample 19 | | | Sample 20 | | |
| Day | Bottle 1 | Bottle 2 | Bottle 3 | Bottle 1 | Bottle 2 | Bottle 3 | Bottle 1 | Bottle 2 | Bottle 3 | Bottle 1 | Bottle 2 | Bottle 3 |
| 9 | 36.16 | 38.09 | 38.52 | 36.42 | 37.57 | 34.4 | 23.3 | 23.85 | 22.47 | 7.1 | 11.24 | 8.02 |
| 14 | 32.89 | | | 32.9 | | | 7.82 | | | 1.24 | | |
| 16 | | 33.29 | | | 32.74 | | | 6.57 | | | 2.21 | |
| 19 | | | 32.16 | | | 29.69 | | | 3.49 | | | 1.11 |
| 21 | 32.57 | | | 31.81 | | | 1.38 | | | 0.9 | | |
| 23 | | 33.18 | | | 31.56 | | | 2.12 | | | 1.63 | |
| 26 | | | 32.67 | | | 24.24 | | | 0.88 | | | 0.57 |
| 28 | 32.23 | | | 30.16 | | | 1.03 | | | 0.93 | | |
| 30 | | 32.64 | | | 28.85 | | | 1.52 | | | 1.11 | |
| 33 | | | 32.3 | | | 11.78 | | | 0.69 | | | 0.72 |

TABLE 4D
Interpolated OTR for Polymer Blend 17

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-17 |
| 9 | 34.64 | 36.39 | 34.83 | 35.29 |
| 9.5 | 34.39 | 36.11 | 34.53 | 35.01 |
| 10 | 34.17 | 35.85 | 34.26 | 34.76 |
| 10.5 | 33.96 | 35.61 | 34.03 | 34.53 |
| 11 | 33.77 | 35.38 | 33.83 | 34.33 |
| 11.5 | 33.60 | 35.17 | 33.66 | 34.15 |
| 12 | 33.45 | 34.98 | 33.51 | 33.98 |
| 12.5 | 33.31 | 34.80 | 33.38 | 33.83 |
| 13 | 33.19 | 34.63 | 33.26 | 33.69 |
| 13.5 | 33.08 | 34.48 | 33.16 | 33.57 |
| 14 | 32.97 | 34.34 | 33.08 | 33.46 |
| 14.5 | 32.88 | 34.20 | 33.00 | 33.36 |
| 15 | 32.80 | 34.08 | 32.93 | 33.27 |
| 15.5 | 32.72 | 33.97 | 32.88 | 33.19 |
| 16 | 32.65 | 33.86 | 32.83 | 33.11 |
| 16.5 | 32.59 | 33.76 | 32.79 | 33.05 |
| 17 | 32.53 | 33.67 | 32.75 | 32.98 |
| 17.5 | 32.48 | 33.59 | 32.72 | 32.93 |
| 18 | 32.44 | 33.51 | 32.69 | 32.88 |
| 18.5 | 32.40 | 33.44 | 32.66 | 32.83 |
| 19 | 32.36 | 33.37 | 32.64 | 32.79 |
| 19.5 | 32.32 | 33.30 | 32.62 | 32.75 |
| 20 | 32.29 | 33.25 | 32.61 | 32.72 |
| 20.5 | 32.27 | 33.19 | 32.59 | 32.68 |
| 21 | 32.24 | 33.14 | 32.58 | 32.65 |
| 21.5 | 32.22 | 33.10 | 32.57 | 32.63 |
| 22 | 32.20 | 33.05 | 32.56 | 32.60 |
| 22.5 | 32.18 | 33.01 | 32.55 | 32.58 |
| 23 | 32.16 | 32.98 | 32.55 | 32.56 |
| 23.5 | 32.15 | 32.94 | 32.54 | 32.54 |
| 24 | 32.13 | 32.91 | 32.53 | 32.53 |
| 24.5 | 32.12 | 32.88 | 32.53 | 32.51 |
| 25 | 32.11 | 32.85 | 32.53 | 32.50 |
| 25.5 | 32.10 | 32.83 | 32.52 | 32.48 |
| 26 | 32.09 | 32.80 | 32.52 | 32.47 |
| 26.5 | 32.08 | 32.78 | 32.52 | 32.46 |
| 27 | 32.07 | 32.76 | 32.52 | 32.45 |
| 27.5 | 32.07 | 32.74 | 32.51 | 32.44 |
| 28 | 32.06 | 32.72 | 32.51 | 32.43 |
| 28.5 | 32.05 | 32.71 | 32.51 | 32.42 |
| 29 | 32.05 | 32.69 | 32.51 | 32.42 |
| 29.5 | 32.04 | 32.68 | 32.51 | 32.41 |
| 30 | 32.04 | 32.67 | 32.51 | 32.40 |
| 30.5 | 32.04 | 32.65 | 32.51 | 32.40 |
| 31 | 32.03 | 32.64 | 32.50 | 32.39 |
| 31.5 | 32.03 | 32.63 | 32.50 | 32.39 |
| 32 | 32.03 | 32.62 | 32.50 | 32.38 |
| 32.5 | 32.02 | 32.61 | 32.50 | 32.38 |
| 33 | 32.02 | 32.61 | 32.50 | 32.38 |
| 33.5 | 32.02 | 32.60 | 32.50 | 32.37 |
| 34 | 32.02 | 32.59 | 32.50 | 32.37 |
| 34.5 | 32.02 | 32.58 | 32.50 | 32.37 |
| 35 | 32.01 | 32.58 | 32.50 | 32.36 |
| 35.5 | 32.01 | 32.57 | 32.50 | 32.36 |
| 36 | 32.01 | 32.57 | 32.50 | 32.36 |
| 36.5 | 32.01 | 32.56 | 32.50 | 32.36 |
| 37 | 32.01 | 32.56 | 32.50 | 32.36 |
| 37.5 | 32.01 | 32.55 | 32.50 | 32.35 |
| 38 | 32.01 | 32.55 | 32.50 | 32.35 |
| 38.5 | 32.01 | 32.55 | 32.50 | 32.35 |
| 39 | 32.01 | 32.54 | 32.50 | 32.35 |
| 39.5 | 32.01 | 32.54 | 32.50 | 32.35 |
| 40 | 32.01 | 32.54 | 32.50 | 32.35 |
| 40.5 | 32.00 | 32.53 | 32.50 | 32.35 |
| 41 | 32.00 | 32.53 | 32.50 | 32.35 |
| 41.5 | 32.00 | 32.53 | 32.50 | 32.34 |
| 42 | 32.00 | 32.53 | 32.50 | 32.34 |
| 42.5 | 32.00 | 32.53 | 32.50 | 32.34 |
| 43 | 32.00 | 32.52 | 32.50 | 32.34 |
| 43.5 | 32.00 | 32.52 | 32.50 | 32.34 |
| 44 | 32.00 | 32.52 | 32.50 | 32.34 |
| 44.5 | 32.00 | 32.52 | 32.50 | 32.34 |
| 45 | 32.00 | 32.52 | 32.50 | 32.34 |
| 45.5 | 32.00 | 32.52 | 32.50 | 32.34 |
| 46 | 32.00 | 32.52 | 32.50 | 32.34 |
| 46.5 | 32.00 | 32.51 | 32.50 | 32.34 |
| 47 | 32.00 | 32.51 | 32.50 | 32.34 |
| 47.5 | 32.00 | 32.51 | 32.50 | 32.34 |
| 48 | 32.00 | 32.51 | 32.50 | 32.34 |
| 48.5 | 32.00 | 32.51 | 32.50 | 32.34 |
| 49 | 32.00 | 32.51 | 32.50 | 32.34 |
| 49.5 | 32.00 | 32.51 | 32.50 | 32.34 |
| 50 | 32.00 | 32.51 | 32.50 | 32.34 |
| 50.5 | 32.00 | 32.51 | 32.50 | 32.34 |
| 51 | 32.00 | 32.51 | 32.50 | 32.34 |
| 51.5 | 32.00 | 32.51 | 32.50 | 32.34 |
| 52 | 32.00 | 32.51 | 32.50 | 32.34 |
| 52.5 | 32.00 | 32.51 | 32.50 | 32.34 |
| 53 | 32.00 | 32.51 | 32.50 | 32.34 |
| 53.5 | 32.00 | 32.50 | 32.50 | 32.34 |
| 54 | 32.00 | 32.50 | 32.50 | 32.33 |
| 54.5 | 32.00 | 32.50 | 32.50 | 32.33 |
| 55 | 32.00 | 32.50 | 32.50 | 32.33 |
| 55.5 | 32.00 | 32.50 | 32.50 | 32.33 |
| 56 | 32.00 | 32.50 | 32.50 | 32.33 |
| 56.5 | 32.00 | 32.50 | 32.50 | 32.33 |
| 57 | 32.00 | 32.50 | 32.50 | 32.33 |
| 57.5 | 32.00 | 32.50 | 32.50 | 32.33 |
| 58 | 32.00 | 32.50 | 32.50 | 32.33 |
| 58.5 | 32.00 | 32.50 | 32.50 | 32.33 |
| 59 | 32.00 | 32.50 | 32.50 | 32.33 |
| 59.5 | 32.00 | 32.50 | 32.50 | 32.33 |
| 60 | 32.00 | 32.50 | 32.50 | 32.33 |
| 60.5 | 32.00 | 32.50 | 32.50 | 32.33 |
| 61 | 32.00 | 32.50 | 32.50 | 32.33 |
| 61.5 | 32.00 | 32.50 | 32.50 | 32.33 |
| 62 | 32.00 | 32.50 | 32.50 | 32.33 |

TABLE 4E
Interpolated OTR for Polymer Blend 18

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-18 |
| 9 | 33.38 | 32.88 | 33.52 | 33.26 |
| 9.5 | 33.37 | 32.87 | 33.46 | 33.23 |
| 10 | 33.35 | 32.86 | 33.41 | 33.21 |
| 10.5 | 33.34 | 32.84 | 33.35 | 33.18 |
| 11 | 33.33 | 32.83 | 33.28 | 33.15 |
| 11.5 | 33.31 | 32.81 | 33.21 | 33.11 |
| 12 | 33.29 | 32.80 | 33.13 | 33.07 |
| 12.5 | 33.27 | 32.78 | 33.04 | 33.03 |
| 13 | 33.25 | 32.76 | 32.94 | 32.98 |
| 13.5 | 33.23 | 32.73 | 32.83 | 32.93 |
| 14 | 33.20 | 32.71 | 32.71 | 32.88 |
| 14.5 | 33.18 | 32.68 | 32.59 | 32.81 |
| 15 | 33.15 | 32.65 | 32.44 | 32.75 |
| 15.5 | 33.11 | 32.62 | 32.29 | 32.67 |
| 16 | 33.08 | 32.58 | 32.12 | 32.59 |
| 16.5 | 33.04 | 32.54 | 31.93 | 32.50 |
| 17 | 32.99 | 32.50 | 31.73 | 32.41 |
| 17.5 | 32.95 | 32.46 | 31.51 | 32.30 |
| 18 | 32.90 | 32.41 | 31.27 | 32.19 |
| 18.5 | 32.84 | 32.35 | 31.01 | 32.07 |
| 19 | 32.78 | 32.29 | 30.73 | 31.93 |
| 19.5 | 32.71 | 32.23 | 30.42 | 31.79 |
| 20 | 32.64 | 32.15 | 30.09 | 31.63 |
| 20.5 | 32.56 | 32.08 | 29.73 | 31.46 |
| 21 | 32.48 | 31.99 | 29.34 | 31.27 |
| 21.5 | 32.38 | 31.90 | 28.93 | 31.07 |
| 22 | 32.28 | 31.80 | 28.49 | 30.86 |
| 22.5 | 32.17 | 31.69 | 28.01 | 30.63 |
| 23 | 32.05 | 31.58 | 27.51 | 30.38 |
| 23.5 | 31.92 | 31.45 | 26.97 | 30.11 |
| 24 | 31.78 | 31.31 | 26.40 | 29.83 |
| 24.5 | 31.63 | 31.16 | 25.80 | 29.53 |
| 25 | 31.47 | 31.00 | 25.17 | 29.21 |
| 25.5 | 31.29 | 30.82 | 24.51 | 28.87 |
| 26 | 31.10 | 30.63 | 23.82 | 28.52 |
| 26.5 | 30.89 | 30.43 | 23.11 | 28.14 |
| 27 | 30.66 | 30.21 | 22.37 | 27.75 |
| 27.5 | 30.42 | 29.97 | 21.61 | 27.33 |
| 28 | 30.16 | 29.71 | 20.83 | 26.90 |
| 28.5 | 29.88 | 29.44 | 20.03 | 26.45 |
| 29 | 29.58 | 29.14 | 19.22 | 25.98 |
| 29.5 | 29.26 | 28.83 | 18.41 | 25.50 |
| 30 | 28.92 | 28.49 | 17.59 | 25.00 |
| 30.5 | 28.55 | 28.13 | 16.77 | 24.48 |
| 31 | 28.17 | 27.75 | 15.95 | 23.96 |
| 31.5 | 27.75 | 27.34 | 15.14 | 23.41 |
| 32 | 27.31 | 26.91 | 14.35 | 22.86 |
| 32.5 | 26.85 | 26.46 | 13.57 | 22.29 |
| 33 | 26.36 | 25.98 | 12.81 | 21.72 |
| 33.5 | 25.85 | 25.47 | 12.07 | 21.13 |
| 34 | 25.31 | 24.94 | 11.35 | 20.54 |
| 34.5 | 24.75 | 24.39 | 10.66 | 19.93 |
| 35 | 24.17 | 23.81 | 10.00 | 19.33 |
| 35.5 | 23.56 | 23.21 | 9.37 | 18.71 |
| 36 | 22.93 | 22.59 | 8.77 | 18.10 |
| 36.5 | 22.28 | 21.95 | 8.21 | 17.48 |
| 37 | 21.61 | 21.30 | 7.67 | 16.86 |
| 37.5 | 20.93 | 20.62 | 7.16 | 16.24 |
| 38 | 20.23 | 19.94 | 6.69 | 15.62 |
| 38.5 | 19.52 | 19.24 | 6.25 | 15.00 |
| 39 | 18.80 | 18.53 | 5.83 | 14.39 |
| 39.5 | 18.08 | 17.82 | 5.45 | 13.78 |
| 40 | 17.35 | 17.10 | 5.09 | 13.18 |
| 40.5 | 16.63 | 16.39 | 4.76 | 12.59 |
| 41 | 15.91 | 15.68 | 4.45 | 12.01 |
| 41.5 | 15.19 | 14.97 | 4.17 | 11.44 |
| 42 | 14.48 | 14.27 | 3.91 | 10.89 |
| 42.5 | 13.78 | 13.59 | 3.67 | 10.35 |
| 43 | 13.10 | 12.91 | 3.45 | 9.82 |
| 43.5 | 12.43 | 12.26 | 3.24 | 9.31 |
| 44 | 11.78 | 11.62 | 3.06 | 8.82 |
| 44.5 | 11.15 | 11.00 | 2.89 | 8.35 |
| 45 | 10.54 | 10.40 | 2.73 | 7.89 |
| 45.5 | 9.96 | 9.82 | 2.59 | 7.46 |
| 46 | 9.40 | 9.27 | 2.46 | 7.04 |
| 46.5 | 8.86 | 8.74 | 2.34 | 6.65 |
| 47 | 8.35 | 8.23 | 2.24 | 6.27 |
| 47.5 | 7.86 | 7.75 | 2.14 | 5.92 |
| 48 | 7.39 | 7.30 | 2.05 | 5.58 |
| 48.5 | 6.96 | 6.87 | 1.97 | 5.26 |
| 49 | 6.54 | 6.46 | 1.89 | 4.97 |
| 49.5 | 6.16 | 6.08 | 1.83 | 4.69 |
| 50 | 5.79 | 5.72 | 1.77 | 4.43 |
| 50.5 | 5.45 | 5.38 | 1.71 | 4.18 |
| 51 | 5.13 | 5.07 | 1.66 | 3.95 |
| 51.5 | 4.83 | 4.77 | 1.62 | 3.74 |
| 52 | 4.55 | 4.50 | 1.57 | 3.54 |
| 52.5 | 4.29 | 4.24 | 1.54 | 3.36 |
| 53 | 4.05 | 4.00 | 1.50 | 3.18 |
| 53.5 | 3.82 | 3.78 | 1.47 | 3.03 |
| 54 | 3.61 | 3.58 | 1.44 | 2.88 |
| 54.5 | 3.42 | 3.39 | 1.42 | 2.74 |
| 55 | 3.24 | 3.21 | 1.40 | 2.62 |
| 55.5 | 3.08 | 3.05 | 1.38 | 2.50 |
| 56 | 2.93 | 2.90 | 1.36 | 2.39 |
| 56.5 | 2.79 | 2.76 | 1.34 | 2.30 |
| 57 | 2.66 | 2.63 | 1.32 | 2.20 |
| 57.5 | 2.54 | 2.52 | 1.31 | 2.12 |
| 58 | 2.43 | 2.41 | 1.30 | 2.04 |
| 58.5 | 2.33 | 2.31 | 1.29 | 1.97 |
| 59 | 2.23 | 2.22 | 1.28 | 1.91 |
| 59.5 | 2.15 | 2.13 | 1.27 | 1.85 |
| 60 | 2.07 | 2.06 | 1.26 | 1.79 |
| 60.5 | 2.00 | 1.98 | 1.25 | 1.74 |
| 61 | 1.93 | 1.92 | 1.24 | 1.70 |
| 61.5 | 1.87 | 1.86 | 1.24 | 1.66 |
| 62 | 1.81 | 1.80 | 1.23 | 1.62 |

TABLE 4F
Interpolated OTR for Polymer Blend 19

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-19 |
| 9 | 21.45 | 22.91 | 22.49 | 22.28 |
| 9.5 | 19.98 | 21.39 | 20.93 | 20.77 |
| 10 | 18.50 | 19.85 | 19.35 | 19.23 |
| 10.5 | 17.02 | 18.31 | 17.77 | 17.70 |
| 11 | 15.55 | 16.79 | 16.21 | 16.19 |
| 11.5 | 14.13 | 15.32 | 14.69 | 14.72 |
| 12 | 12.77 | 13.91 | 13.24 | 13.31 |
| 12.5 | 11.48 | 12.57 | 11.87 | 11.97 |
| 13 | 10.28 | 11.32 | 10.59 | 10.73 |
| 13.5 | 9.17 | 10.17 | 9.40 | 9.58 |
| 14 | 8.15 | 9.11 | 8.32 | 8.53 |
| 14.5 | 7.23 | 8.16 | 7.34 | 7.58 |
| 15 | 6.41 | 7.31 | 6.46 | 6.73 |
| 15.5 | 5.68 | 6.55 | 5.68 | 5.97 |
| 16 | 5.03 | 5.88 | 4.99 | 5.30 |
| 16.5 | 4.46 | 5.29 | 4.39 | 4.71 |
| 17 | 3.97 | 4.77 | 3.86 | 4.20 |
| 17.5 | 3.54 | 4.33 | 3.40 | 3.76 |
| 18 | 3.16 | 3.94 | 3.01 | 3.37 |
| 18.5 | 2.84 | 3.61 | 2.66 | 3.04 |
| 19 | 2.57 | 3.33 | 2.37 | 2.76 |
| 19.5 | 2.33 | 3.08 | 2.12 | 2.51 |
| 20 | 2.13 | 2.87 | 1.90 | 2.30 |
| 20.5 | 1.96 | 2.69 | 1.72 | 2.13 |
| 21 | 1.81 | 2.54 | 1.57 | 1.97 |
| 21.5 | 1.69 | 2.41 | 1.43 | 1.85 |
| 22 | 1.58 | 2.30 | 1.32 | 1.74 |
| 22.5 | 1.49 | 2.21 | 1.22 | 1.64 |
| 23 | 1.42 | 2.13 | 1.14 | 1.56 |
| 23.5 | 1.35 | 2.06 | 1.07 | 1.50 |
| 24 | 1.30 | 2.01 | 1.02 | 1.44 |
| 24.5 | 1.25 | 1.96 | 0.97 | 1.39 |
| 25 | 1.21 | 1.92 | 0.93 | 1.35 |
| 25.5 | 1.18 | 1.89 | 0.89 | 1.32 |
| 26 | 1.15 | 1.86 | 0.86 | 1.29 |
| 26.5 | 1.13 | 1.83 | 0.84 | 1.27 |
| 27 | 1.11 | 1.81 | 0.81 | 1.25 |
| 27.5 | 1.09 | 1.79 | 0.80 | 1.23 |
| 28 | 1.08 | 1.78 | 0.78 | 1.21 |
| 28.5 | 1.07 | 1.77 | 0.77 | 1.20 |
| 29 | 1.06 | 1.76 | 0.76 | 1.19 |
| 29.5 | 1.05 | 1.75 | 0.75 | 1.18 |
| 30 | 1.04 | 1.74 | 0.74 | 1.17 |
| 30.5 | 1.03 | 1.73 | 0.74 | 1.17 |
| 31 | 1.03 | 1.73 | 0.73 | 1.16 |
| 31.5 | 1.03 | 1.72 | 0.72 | 1.16 |
| 32 | 1.02 | 1.72 | 0.72 | 1.15 |
| 32.5 | 1.02 | 1.72 | 0.72 | 1.15 |
| 33 | 1.02 | 1.71 | 0.71 | 1.15 |
| 33.5 | 1.01 | 1.71 | 0.71 | 1.15 |
| 34 | 1.01 | 1.71 | 0.71 | 1.14 |
| 34.5 | 1.01 | 1.71 | 0.71 | 1.14 |
| 35 | 1.01 | 1.71 | 0.71 | 1.14 |
| 35.5 | 1.01 | 1.71 | 0.71 | 1.14 |
| 36 | 1.01 | 1.71 | 0.71 | 1.14 |
| 36.5 | 1.01 | 1.70 | 0.70 | 1.14 |
| 37 | 1.01 | 1.70 | 0.70 | 1.14 |
| 37.5 | 1.01 | 1.70 | 0.70 | 1.14 |
| 38 | 1.00 | 1.70 | 0.70 | 1.14 |
| 38.5 | 1.00 | 1.70 | 0.70 | 1.14 |
| 39 | 1.00 | 1.70 | 0.70 | 1.14 |
| 39.5 | 1.00 | 1.70 | 0.70 | 1.14 |
| 40 | 1.00 | 1.70 | 0.70 | 1.14 |
| 40.5 | 1.00 | 1.70 | 0.70 | 1.14 |
| 41 | 1.00 | 1.70 | 0.70 | 1.13 |
| 41.5 | 1.00 | 1.70 | 0.70 | 1.13 |
| 42 | 1.00 | 1.70 | 0.70 | 1.13 |
| 42.5 | 1.00 | 1.70 | 0.70 | 1.13 |
| 43 | 1.00 | 1.70 | 0.70 | 1.13 |
| 43.5 | 1.00 | 1.70 | 0.70 | 1.13 |
| 44 | 1.00 | 1.70 | 0.70 | 1.13 |
| 44.5 | 1.00 | 1.70 | 0.70 | 1.13 |
| 45 | 1.00 | 1.70 | 0.70 | 1.13 |
| 45.5 | 1.00 | 1.70 | 0.70 | 1.13 |
| 46 | 1.00 | 1.70 | 0.70 | 1.13 |
| 46.5 | 1.00 | 1.70 | 0.70 | 1.13 |
| 47 | 1.00 | 1.70 | 0.70 | 1.13 |
| 47.5 | 1.00 | 1.70 | 0.70 | 1.13 |
| 48 | 1.00 | 1.70 | 0.70 | 1.13 |
| 48.5 | 1.00 | 1.70 | 0.70 | 1.13 |
| 49 | 1.00 | 1.70 | 0.70 | 1.13 |
| 49.5 | 1.00 | 1.70 | 0.70 | 1.13 |
| 50 | 1.00 | 1.70 | 0.70 | 1.13 |
| 50.5 | 1.00 | 1.70 | 0.70 | 1.13 |
| 51 | 1.00 | 1.70 | 0.70 | 1.13 |
| 51.5 | 1.00 | 1.70 | 0.70 | 1.13 |
| 52 | 1.00 | 1.70 | 0.70 | 1.13 |
| 52.5 | 1.00 | 1.70 | 0.70 | 1.13 |
| 53 | 1.00 | 1.70 | 0.70 | 1.13 |
| 53.5 | 1.00 | 1.70 | 0.70 | 1.13 |
| 54 | 1.00 | 1.70 | 0.70 | 1.13 |
| 54.5 | 1.00 | 1.70 | 0.70 | 1.13 |
| 55 | 1.00 | 1.70 | 0.70 | 1.13 |
| 55.5 | 1.00 | 1.70 | 0.70 | 1.13 |
| 56 | 1.00 | 1.70 | 0.70 | 1.13 |
| 56.5 | 1.00 | 1.70 | 0.70 | 1.13 |
| 57 | 1.00 | 1.70 | 0.70 | 1.13 |
| 57.5 | 1.00 | 1.70 | 0.70 | 1.13 |
| 58 | 1.00 | 1.70 | 0.70 | 1.13 |
| 58.5 | 1.00 | 1.70 | 0.70 | 1.13 |
| 59 | 1.00 | 1.70 | 0.70 | 1.13 |
| 59.5 | 1.00 | 1.70 | 0.70 | 1.13 |
| 60 | 1.00 | 1.70 | 0.70 | 1.13 |
| 60.5 | 1.00 | 1.70 | 0.70 | 1.13 |
| 61 | 1.00 | 1.70 | 0.70 | 1.13 |
| 61.5 | 1.00 | 1.70 | 0.70 | 1.13 |
| 62 | 1.00 | 1.70 | 0.70 | 1.13 |

TABLE 4G
Interpolated OTR for Polymer Blend 20

Interpolated OTR

| | | | | Avg OTR |
|---|---|---|---|---|
| Day Since | | | | for |
| Blowing | | | | Polymer |
| Bottle | Bottle 1 | Bottle 2 | Bottle 3 | Blend-20 |
| 9 | 6.86 | 8.19 | 11.82 | 8.96 |
| 9.5 | 5.72 | 6.86 | 10.44 | 7.67 |
| 10 | 4.76 | 5.72 | 9.18 | 6.55 |
| 10.5 | 3.97 | 4.76 | 8.05 | 5.59 |
| 11 | 3.32 | 3.97 | 7.04 | 4.78 |
| 11.5 | 2.79 | 3.32 | 6.17 | 4.09 |
| 12 | 2.37 | 2.79 | 5.41 | 3.52 |
| 12.5 | 2.04 | 2.37 | 4.75 | 3.06 |
| 13 | 1.77 | 2.04 | 4.19 | 2.67 |
| 13.5 | 1.56 | 1.77 | 3.72 | 2.35 |
| 14 | 1.40 | 1.56 | 3.33 | 2.10 |
| 14.5 | 1.27 | 1.40 | 2.99 | 1.89 |
| 15 | 1.16 | 1.27 | 2.72 | 1.72 |
| 15.5 | 1.08 | 1.16 | 2.49 | 1.58 |
| 16 | 1.02 | 1.08 | 2.29 | 1.47 |
| 16.5 | 0.97 | 1.02 | 2.14 | 1.38 |
| 17 | 0.94 | 0.97 | 2.00 | 1.30 |
| 17.5 | 0.91 | 0.94 | 1.90 | 1.25 |
| 18 | 0.88 | 0.91 | 1.81 | 1.20 |
| 18.5 | 0.86 | 0.88 | 1.73 | 1.16 |
| 19 | 0.85 | 0.86 | 1.67 | 1.13 |
| 19.5 | 0.84 | 0.85 | 1.62 | 1.10 |
| 20 | 0.83 | 0.84 | 1.58 | 1.08 |
| 20.5 | 0.82 | 0.83 | 1.55 | 1.07 |
| 21 | 0.82 | 0.82 | 1.52 | 1.06 |
| 21.5 | 0.81 | 0.82 | 1.50 | 1.04 |
| 22 | 0.81 | 0.81 | 1.48 | 1.04 |
| 22.5 | 0.81 | 0.81 | 1.47 | 1.03 |
| 23 | 0.81 | 0.81 | 1.46 | 1.02 |
| 23.5 | 0.81 | 0.81 | 1.45 | 1.02 |
| 24 | 0.80 | 0.81 | 1.44 | 1.02 |
| 24.5 | 0.80 | 0.80 | 1.43 | 1.01 |
| 25 | 0.80 | 0.80 | 1.43 | 1.01 |
| 25.5 | 0.80 | 0.80 | 1.42 | 1.01 |
| 26 | 0.80 | 0.80 | 1.42 | 1.01 |
| 26.5 | 0.80 | 0.80 | 1.41 | 1.01 |
| 27 | 0.80 | 0.80 | 1.41 | 1.00 |
| 27.5 | 0.80 | 0.80 | 1.41 | 1.00 |
| 28 | 0.80 | 0.80 | 1.41 | 1.00 |
| 28.5 | 0.80 | 0.80 | 1.41 | 1.00 |
| 29 | 0.80 | 0.80 | 1.41 | 1.00 |
| 29.5 | 0.80 | 0.80 | 1.40 | 1.00 |
| 30 | 0.80 | 0.80 | 1.40 | 1.00 |
| 30.5 | 0.80 | 0.80 | 1.40 | 1.00 |
| 31 | 0.80 | 0.80 | 1.40 | 1.00 |
| 31.5 | 0.80 | 0.80 | 1.40 | 1.00 |
| 32 | 0.80 | 0.80 | 1.40 | 1.00 |
| 32.5 | 0.80 | 0.80 | 1.40 | 1.00 |
| 33 | 0.80 | 0.80 | 1.40 | 1.00 |
| 33.5 | 0.80 | 0.80 | 1.40 | 1.00 |
| 34 | 0.80 | 0.80 | 1.40 | 1.00 |
| 34.5 | 0.80 | 0.80 | 1.40 | 1.00 |
| 35 | 0.80 | 0.80 | 1.40 | 1.00 |
| 35.5 | 0.80 | 0.80 | 1.40 | 1.00 |
| 36 | 0.80 | 0.80 | 1.40 | 1.00 |
| 36.5 | 0.80 | 0.80 | 1.40 | 1.00 |
| 37 | 0.80 | 0.80 | 1.40 | 1.00 |
| 37.5 | 0.80 | 0.80 | 1.40 | 1.00 |
| 38 | 0.80 | 0.80 | 1.40 | 1.00 |
| 38.5 | 0.80 | 0.80 | 1.40 | 1.00 |
| 39 | 0.80 | 0.80 | 1.40 | 1.00 |
| 39.5 | 0.80 | 0.80 | 1.40 | 1.00 |
| 40 | 0.80 | 0.80 | 1.40 | 1.00 |
| 40.5 | 0.80 | 0.80 | 1.40 | 1.00 |
| 41 | 0.80 | 0.80 | 1.40 | 1.00 |
| 41.5 | 0.80 | 0.80 | 1.40 | 1.00 |
| 42 | 0.80 | 0.80 | 1.40 | 1.00 |
| 42.5 | 0.80 | 0.80 | 1.40 | 1.00 |
| 43 | 0.80 | 0.80 | 1.40 | 1.00 |
| 43.5 | 0.80 | 0.80 | 1.40 | 1.00 |
| 44 | 0.80 | 0.80 | 1.40 | 1.00 |
| 44.5 | 0.80 | 0.80 | 1.40 | 1.00 |
| 45 | 0.80 | 0.80 | 1.40 | 1.00 |
| 45.5 | 0.80 | 0.80 | 1.40 | 1.00 |
| 46 | 0.80 | 0.80 | 1.40 | 1.00 |
| 46.5 | 0.80 | 0.80 | 1.40 | 1.00 |
| 47 | 0.80 | 0.80 | 1.40 | 1.00 |
| 47.5 | 0.80 | 0.80 | 1.40 | 1.00 |
| 48 | 0.80 | 0.80 | 1.40 | 1.00 |
| 48.5 | 0.80 | 0.80 | 1.40 | 1.00 |
| 49 | 0.80 | 0.80 | 1.40 | 1.00 |
| 49.5 | 0.80 | 0.80 | 1.40 | 1.00 |
| 50 | 0.80 | 0.80 | 1.40 | 1.00 |
| 50.5 | 0.80 | 0.80 | 1.40 | 1.00 |
| 51 | 0.80 | 0.80 | 1.40 | 1.00 |
| 51.5 | 0.80 | 0.80 | 1.40 | 1.00 |
| 52 | 0.80 | 0.80 | 1.40 | 1.00 |
| 52.5 | 0.80 | 0.80 | 1.40 | 1.00 |
| 53 | 0.80 | 0.80 | 1.40 | 1.00 |
| 53.5 | 0.80 | 0.80 | 1.40 | 1.00 |
| 54 | 0.80 | 0.80 | 1.40 | 1.00 |
| 54.5 | 0.80 | 0.80 | 1.40 | 1.00 |
| 55 | 0.80 | 0.80 | 1.40 | 1.00 |
| 55.5 | 0.80 | 0.80 | 1.40 | 1.00 |
| 56 | 0.80 | 0.80 | 1.40 | 1.00 |
| 56.5 | 0.80 | 0.80 | 1.40 | 1.00 |
| 57 | 0.80 | 0.80 | 1.40 | 1.00 |
| 57.5 | 0.80 | 0.80 | 1.40 | 1.00 |
| 58 | 0.80 | 0.80 | 1.40 | 1.00 |
| 58.5 | 0.80 | 0.80 | 1.40 | 1.00 |
| 59 | 0.80 | 0.80 | 1.40 | 1.00 |
| 59.5 | 0.80 | 0.80 | 1.40 | 1.00 |
| 60 | 0.80 | 0.80 | 1.40 | 1.00 |
| 60.5 | 0.80 | 0.80 | 1.40 | 1.00 |
| 61 | 0.80 | 0.80 | 1.40 | 1.00 |
| 61.5 | 0.80 | 0.80 | 1.40 | 1.00 |
| 62 | 0.80 | 0.80 | 1.40 | 1.00 |

TABLE 4H
Average OTR for Polymer Blends 17 through 20

| | Interpolated OTR | | | |
|---|---|---|---|---|
| Day Since | Comparative | Comparative | | |
| Blowing | Polymer | Polymer | Polymer | Polymer |
| Bottle | Blend-17 | Blend-18 | Blend-19 | Blend-20 |
| 9 | 35.29 | 33.26 | 22.28 | 8.96 |
| 9.5 | 35.01 | 33.23 | 20.77 | 7.67 |
| 10 | 34.76 | 33.21 | 19.23 | 6.55 |
| 10.5 | 34.53 | 33.18 | 17.70 | 5.59 |
| 11 | 34.33 | 33.15 | 16.19 | 4.78 |
| 11.5 | 34.15 | 33.11 | 14.72 | 4.09 |
| 12 | 33.98 | 33.07 | 13.31 | 3.52 |
| 12.5 | 33.83 | 33.03 | 11.97 | 3.06 |
| 13 | 33.69 | 32.98 | 10.73 | 2.67 |
| 13.5 | 33.57 | 32.93 | 9.58 | 2.35 |
| 14 | 33.46 | 32.88 | 8.53 | 2.10 |
| 14.5 | 33.36 | 32.81 | 7.58 | 1.89 |
| 15 | 33.27 | 32.75 | 6.73 | 1.72 |
| 15.5 | 33.19 | 32.67 | 5.97 | 1.58 |
| 16 | 33.11 | 32.59 | 5.30 | 1.47 |
| 16.5 | 33.05 | 32.50 | 4.71 | 1.38 |
| 17 | 32.98 | 32.41 | 4.20 | 1.30 |
| 17.5 | 32.93 | 32.30 | 3.76 | 1.25 |
| 18 | 32.88 | 32.19 | 3.37 | 1.20 |
| 18.5 | 32.83 | 32.07 | 3.04 | 1.16 |
| 19 | 32.79 | 31.93 | 2.76 | 1.13 |
| 19.5 | 32.75 | 31.79 | 2.51 | 1.10 |
| 20 | 32.72 | 31.63 | 2.30 | 1.08 |
| 20.5 | 32.68 | 31.46 | 2.13 | 1.07 |
| 21 | 32.65 | 31.27 | 1.97 | 1.06 |
| 21.5 | 32.63 | 31.07 | 1.85 | 1.04 |
| 22 | 32.60 | 30.86 | 1.74 | 1.04 |
| 22.5 | 32.58 | 30.63 | 1.64 | 1.03 |
| 23 | 32.56 | 30.38 | 1.56 | 1.02 |
| 23.5 | 32.54 | 30.11 | 1.50 | 1.02 |
| 24 | 32.53 | 29.83 | 1.44 | 1.02 |
| 24.5 | 32.51 | 29.53 | 1.39 | 1.01 |
| 25 | 32.50 | 29.21 | 1.35 | 1.01 |
| 25.5 | 32.48 | 28.87 | 1.32 | 1.01 |
| 26 | 32.47 | 28.52 | 1.29 | 1.01 |
| 26.5 | 32.46 | 28.14 | 1.27 | 1.01 |
| 27 | 32.45 | 27.75 | 1.25 | 1.00 |
| 27.5 | 32.44 | 27.33 | 1.23 | 1.00 |
| 28 | 32.43 | 26.90 | 1.21 | 1.00 |
| 28.5 | 32.42 | 26.45 | 1.20 | 1.00 |
| 29 | 32.42 | 25.98 | 1.19 | 1.00 |
| 29.5 | 32.41 | 25.50 | 1.18 | 1.00 |
| 30 | 32.40 | 25.00 | 1.17 | 1.00 |
| 30.5 | 32.40 | 24.48 | 1.17 | 1.00 |
| 31 | 32.39 | 23.96 | 1.16 | 1.00 |
| 31.5 | 32.39 | 23.41 | 1.16 | 1.00 |
| 32 | 32.38 | 22.86 | 1.15 | 1.00 |
| 32.5 | 32.38 | 22.29 | 1.15 | 1.00 |
| 33 | 32.38 | 21.72 | 1.15 | 1.00 |
| 33.5 | 32.37 | 21.13 | 1.15 | 1.00 |
| 34 | 32.37 | 20.54 | 1.14 | 1.00 |
| 34.5 | 32.37 | 19.93 | 1.14 | 1.00 |
| 35 | 32.36 | 19.33 | 1.14 | 1.00 |
| 35.5 | 32.36 | 18.71 | 1.14 | 1.00 |
| 36 | 32.36 | 18.10 | 1.14 | 1.00 |
| 36.5 | 32.36 | 17.48 | 1.14 | 1.00 |
| 37 | 32.36 | 16.86 | 1.14 | 1.00 |
| 37.5 | 32.35 | 16.24 | 1.14 | 1.00 |
| 38 | 32.35 | 15.62 | 1.14 | 1.00 |
| 38.5 | 32.35 | 15.00 | 1.14 | 1.00 |
| 39 | 32.35 | 14.39 | 1.14 | 1.00 |
| 39.5 | 32.35 | 13.78 | 1.14 | 1.00 |
| 40 | 32.35 | 13.18 | 1.14 | 1.00 |
| 40.5 | 32.35 | 12.59 | 1.14 | 1.00 |
| 41 | 32.35 | 12.01 | 1.13 | 1.00 |
| 41.5 | 32.34 | 11.44 | 1.13 | 1.00 |
| 42 | 32.34 | 10.89 | 1.13 | 1.00 |
| 42.5 | 32.34 | 10.35 | 1.13 | 1.00 |
| 43 | 32.34 | 9.82 | 1.13 | 1.00 |
| 43.5 | 32.34 | 9.31 | 1.13 | 1.00 |
| 44 | 32.34 | 8.82 | 1.13 | 1.00 |
| 44.5 | 32.34 | 8.35 | 1.13 | 1.00 |
| 45 | 32.34 | 7.89 | 1.13 | 1.00 |
| 45.5 | 32.34 | 7.46 | 1.13 | 1.00 |
| 46 | 32.34 | 7.04 | 1.13 | 1.00 |
| 46.5 | 32.34 | 6.65 | 1.13 | 1.00 |
| 47 | 32.34 | 6.27 | 1.13 | 1.00 |
| 47.5 | 32.34 | 5.92 | 1.13 | 1.00 |
| 48 | 32.34 | 5.58 | 1.13 | 1.00 |
| 48.5 | 32.34 | 5.26 | 1.13 | 1.00 |
| 49 | 32.34 | 4.97 | 1.13 | 1.00 |
| 49.5 | 32.34 | 4.69 | 1.13 | 1.00 |
| 50 | 32.34 | 4.43 | 1.13 | 1.00 |
| 50.5 | 32.34 | 4.18 | 1.13 | 1.00 |
| 51 | 32.34 | 3.95 | 1.13 | 1.00 |
| 51.5 | 32.34 | 3.74 | 1.13 | 1.00 |
| 52 | 32.34 | 3.54 | 1.13 | 1.00 |
| 52.5 | 32.34 | 3.36 | 1.13 | 1.00 |
| 53 | 32.34 | 3.18 | 1.13 | 1.00 |
| 53.5 | 32.34 | 3.03 | 1.13 | 1.00 |
| 54 | 32.33 | 2.88 | 1.13 | 1.00 |
| 54.5 | 32.33 | 2.74 | 1.13 | 1.00 |
| 55 | 32.33 | 2.62 | 1.13 | 1.00 |
| 55.5 | 32.33 | 2.50 | 1.13 | 1.00 |
| 56 | 32.33 | 2.39 | 1.13 | 1.00 |
| 56.5 | 32.33 | 2.30 | 1.13 | 1.00 |
| 57 | 32.33 | 2.20 | 1.13 | 1.00 |
| 57.5 | 32.33 | 2.12 | 1.13 | 1.00 |
| 58 | 32.33 | 2.04 | 1.13 | 1.00 |
| 58.5 | 32.33 | 1.97 | 1.13 | 1.00 |
| 59 | 32.33 | 1.91 | 1.13 | 1.00 |
| 59.5 | 32.33 | 1.85 | 1.13 | 1.00 |
| 60 | 32.33 | 1.79 | 1.13 | 1.00 |
| 60.5 | 32.33 | 1.74 | 1.13 | 1.00 |
| 61 | 32.33 | 1.70 | 1.13 | 1.00 |
| 61.5 | 32.33 | 1.66 | 1.13 | 1.00 |
| 62 | 32.33 | 1.62 | 1.13 | 1.00 |

TABLE 4I
OxySense Test Results for Polymer Blends 17 through 20

| | pO2 (mbar) | | | pO2 (mbar) | | | pO2 (mbar) | | | pO2 (mbar) | | |
|---|---|---|---|---|---|---|---|---|---|---|---|---|
| | for Sample 17 | | | for Sample 18 | | | for Sample 19 | | | for Sample 20 | | |
| | Ampoule | | | Ampoule | | | Ampoule | | | Ampoule | | |
| Day | 1 | Ampoule 2 | Average | 1 | Ampoule 2 | Average | 1 | Ampoule 2 | Average | 1 | Ampoule 2 | Average |
| 0 | 191 | 217 | 204 | 199 | 210 | 204 | 196 | 200 | 198 | 205 | 194 | 199 |
| 1 | 192 | 205 | 198 | 198 | 211 | 205 | 192 | 198 | 195 | 198 | 188 | 193 |
| 2 | 189 | 205 | 197 | 197 | 212 | 204 | 193 | 196 | 194 | 192 | 186 | 189 |
| 3 | 184 | 195 | 190 | 194 | 207 | 201 | 189 | 192 | 191 | 182 | 177 | 179 |
| 4 | 176 | 188 | 182 | 195 | 204 | 200 | 190 | 194 | 192 | 178 | 175 | 177 |

### Example 5

Below is a description of the PET polymers used to prepare each of Polymer Blends 21 through 24. Polymer Blends 23 and 24 differ, even though the same PET polymer was used, because different quantities of cobalt metal were added to the same PET-5 polymer. Metal quantities in Polymer Blends 21 through 24 were determined by Inductively Coupled Plasma Optical Emission Spectrometry (ICP) and are set forth in Table 5A.

PET-1 was the same as previously described in Example 1.

PET-2 was the same as previously described in Example 1.

PET-5 was the same as previously described in Example 4.

The glycol portion of each of the PET polymers also contained low levels (less than 5 mol %) of DEG residues, present either as a natural byproduct of the melt polymerization process or intentionally added as a modifier, for example to maintain a consistent amount of DEG residues.

Cobalt Concentrate was the same as previously described in Example 1

The polyamide used was previously described in Example 1.

### Polymer Blend 21 (Comparative)

Polymer Blend 21 was prepared by separately grinding PET-1 (96.25 g) and MXD-6 (1.5 g) to pass through a 3 mm screen, cryogenically pulverizing the cobalt concentrate (2.25 g) (Table 5B), and then combining and drying the three components at 60° C. for 3 days in a vacuum oven with nitrogen purge. The dry-mixed blend was introduced into the feed hopper of a DACA MicroCompounder (DACA Instruments, Goleta, Calif.) and the melt extruded into a strand and pelletized. Processing conditions for the twin-screw DACA MicroCompounder were as described in Experiment 3.

### Polymer Blend 22 (Comparative)

Polymer Blend 22 was prepared as described in Polymer Blend 21 using PET-2 (96.25 g) and MXD-6 (1.5 g) and cobalt concentrate (2.25 g), and extruded into pellets (Table 5B).

### Polymer Blend 23 (Inventive)

Polymer Blend 23 was prepared as described in Polymer Blend 21 using PET-5 (97.375 g) and MXD-6 (1.5 g), and cobalt concentrate (1.125 g), and extruded into pellets (Table 5B).

### Polymer Blend 24 (Inventive)

Polymer Blend 24 was prepared as described in Polymer Blend 21 using PET-5 (96.25 g) MXD-6 (1.5 g), and cobalt concentrate (2.25 g), and extruded into pellets (Table 5B).

The oxygen scavenging effect of Polymer Blends 21 through 24 were evaluated using the OxySense Test, as described in Example 1. One gram pellets extruded by the DACA Microcompounder for each of the four Polymer Blends 21 through 24 were pulverized and introduced in glass ampoules. Replicate OxySense Test results are reported for each blend in Table 5C.

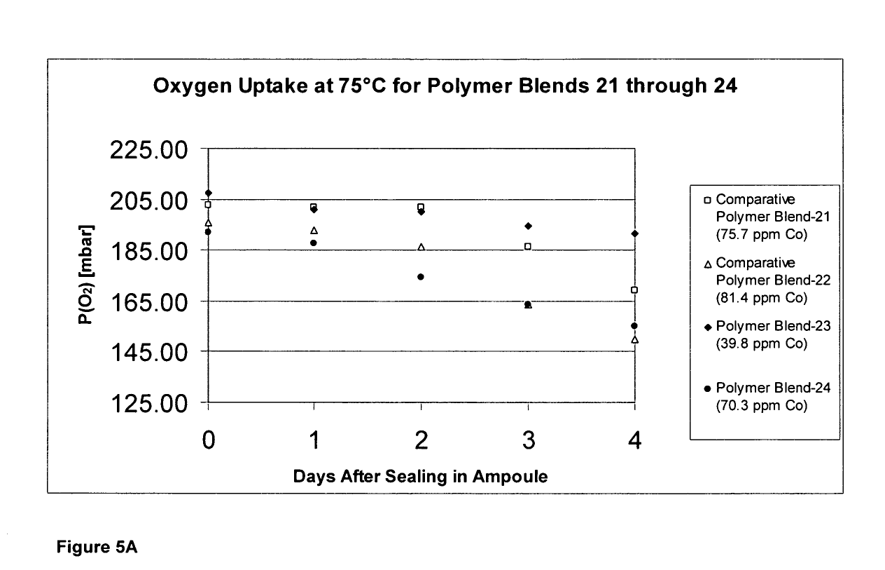

Inventive Polymer Blends 23 and 24, were prepared with PET-3 (an aluminum- and lithium-catalyzed PET polymer prepared by melt-phase-only polymerization) and the OxySense results suggest that these inventive blends scavenge oxygen. See Table 5C and FIG. 5A. This is consistent with the OTR results from Polymer Blends 19 and 20 of Example 4, having the same composition.

TABLE 5A
Metals and MXD-6 Analysis of Polymer Blends 21 through 24

| | Metals [ppm] by ICP | | | | | | | | |
|---|---|---|---|---|---|---|---|---|---|
| | Li | Al | Co | Fe | Mn | Ti | Sb | P | Zn |
| Comparative Polymer Blend-21 | <0.2 | 1.2 | 75.7 | 14.9 | 50.2 | 18.1 | 214 | 95.2 | 3.7 |
| Comparative Polymer Blend-22 | <0.2 | 1.8 | 81.4 | 4.4 | 0.4 | 0.2 | 214 | 75.2 | 62.2 |
| Polymer Blend-23 | 8.6 | 15.8 | 39.8 | 1 | 0.2 | 5.4 | 6.1 | 49.7 | 2.6 |
| Polymer Blend-24 | 8.6 | 10.9 | 70.3 | 1.4 | 0.4 | 5.1 | 8.4 | 51.2 | 4 |

^{†}The reported value of aluminum for Polymer Blend 23 was and average of replicate test results, 17.1 ppm and 14.6, respectively.
^{††}The reported value of aluminum for Polymer Blend 24 was and average of replicate test results, 11.5 ppm and 10.3, respectively.

TABLE 5B
Composition of Polymer Blends 21 through 24

| | | | | Cobalt |
|---|---|---|---|---|
| | PET | PET | MXD-6 6007 | Concentrate |
| | Polymer | [g] | [g] | [g] |
| Comparative Polymer | PET-1 | 96.25 | 1.5 | 2.25 |
| Blend-21 | | | | |
| Comparative Polymer | PET-2 | 96.25 | 1.5 | 2.25 |
| Blend-22 | | | | |
| Polymer Blend-23 | PET-5 | 97.375 | 1.5 | 1.125 |
| Polymer Blend-24 | PET-5 | 96.25 | 1.5 | 2.25 |

TABLE 5C
OxySense Test Results for Polymer Blends 21 through 24

| | pO2 (mbar) | | | pO2 (mbar) | | | pO2 (mbar) | | | pO2 (mbar) | | |
|---|---|---|---|---|---|---|---|---|---|---|---|---|
| | for Sample 21 | | | for Sample 22 | | | for Sample 23 | | | for Sample 24 | | |
| | Ampoule | | | Ampoule | | | Ampoule | | | Ampoule | | |
| Day | 1 | Ampoule 2 | Average | 1 | Ampoule 2 | Average | 1 | Ampoule 2 | Average | 1 | Ampoule 2 | Average |
| 0 | 207 | 198 | 203 | 196 | 195 | 196 | 205 | 209 | 207 | 194 | 190 | 192 |
| 1 | 206 | 197 | 202 | 193 | 193 | 193 | 198 | 204 | 201 | 188 | 187 | 187 |
| 2 | 204 | 199 | 202 | 186 | 187 | 186 | 197 | 204 | 200 | 174 | 175 | 174 |
| 3 | 190 | 183 | 187 | 163 | 164 | 164 | 191 | 198 | 195 | 163 | 165 | 164 |
| 4 | 171 | 168 | 169 | 149 | 151 | 150 | 188 | 195 | 191 | 154 | 156 | 155 |

1. A polymer blend having oxygen-scavenging effect, comprising:
one or more polyamide homopolymers or copolymers comprising at least 50 mole percent residues of one or more amine monomers containing a benzylic hydrogen, based on the total amount of amine residues comprising 100 mole percent;
one or more polyethylene terephthalate homopolymers or copolymers obtained by a melt phase polymerization using a catalyst system comprising aluminum atoms in an amount from about 3 ppm to about 60 ppm and one or more alkaline earth metal atoms, alkali metal atoms, or alkali compound residues in an amount from about 1 ppm to about 25 ppm, in each case based on the weight of the one or more polyethylene terephthalate homopolymers or copolymers; and
one or more transition metal atoms in an amount from about 10 ppm to about 1,000 ppm metal, based on the total weight of the polymer blend.

2. The polymer blend of claim 1, wherein the one or more polyamide homopolymers or copolymers are present in an amount from about 0.20 weight percent to about 10 weight percent, based on the total weight of the polymer blend.

3. (canceled)

4. The polymer blend of claim 1, wherein the one or more polyamide homopolymers or copolymers are present in an amount from 1 weight percent to 3 weight percent, based on the total weight of the polymer blend of the invention.

5. The polymer blend of claim 1, wherein the one or more polyamide homopolymers or copolymers are comprised of at least 80 percent amide linkages, based on the total number of condensation linkages of the one or more polyamide homopolymers or copolymers comprising 100 percent.

6. (canceled)

7. The polymer blend of claim 1, wherein the one or more polyamide homopolymers or copolymers are comprised of at least 95 percent amide linkages, based on the total number of condensation linkages of the one or more polyamide homopolymers or copolymers comprising 100 percent.

8. The polymer blend of claim 1, wherein the one or more polyamide homopolymers or copolymers comprise at least 60 mole percent amine residues having a benzylic hydrogen group, based on the total amount of amine residues comprising 100 mole percent.

9. The polymer blend of claim 1, wherein the one or more polyamide homopolymers or copolymers comprise at least 50 mole percent m-xylylenediamine residues, based on the total amount of amine residues comprising 100 mole percent.

10. (canceled)

11. The polymer blend of claim 1, wherein the one or more polyamide homopolymers or copolymers comprise at least 95 mole percent m-xylylenediamine residues, based on the total amount of amine residues comprising 100 mole percent.

12. (canceled)

13. The polymer blend of claim 1, wherein the one or more polyamide homopolymers or copolymers comprise repeating units of m-xylylene adipamide in an amount of at least 85 mole percent, based on the total moles of acid/amine units in the polyamide composition comprising 100 mole percent.

14. The polymer blend of claim 1, wherein the one or more polyamide homopolymers or copolymers comprise repeating units of m-xylylene adipamide in an amount of at least 96 mole percent, based on the total moles of acid/amine units in the polyamide composition comprising 100 mole percent.

15. The polymer blend of claim 1, wherein the one or more polyamide homopolymers or copolymers comprise a m-xylylene adipamide homopolymer.

16. The polymer blend of claim 1, wherein the one or more polyamide homopolymers or copolymers are provided as a polyamide concentrate, in which the polyamide is present in an amount from about 1 weight percent to about 40 weight percent, based on the total weight of the concentrate.

17-24. (canceled)

25. The polymer blend of claim 1, wherein the one or more transition metal atoms comprise cobalt in an amount of from 50 ppm to 250 ppm, based on the weight of the cobalt with respect to the weight of the polymer blend.

26-27. (canceled)

28. The polymer blend of claim 1, wherein the aluminum atoms are present in the one or more polyethylene terephthalate homopolymers or copolymers in an amount from 5 ppm to 25 ppm, based on the weight of the one or more polyethylene terephthalate homopolymers or copolymers.

29-31. (canceled)

32. The polymer blend of claim 1, wherein the one or more polyethylene terephthalate homopolymers or copolymers comprise lithium atoms, present in an amount ranging from 7 ppm to 15 ppm, based on the weight of the one or more polyethylene terephthalate homopolymers or copolymers.

33-34. (canceled)

35. The polymer blend of claim 1, wherein the one or more polyethylene terephthalate homopolymers or copolymers further comprise phosphorus atoms in an amount from 10 ppm to 115 ppm, based on the weight of the one or more polyethylene terephthalate homopolymers or copolymers.

36-37. (canceled)

38. The polymer blend of claim 1, wherein the one or more polyethylene terephthalate homopolymers or copolymers further comprise phosphorus atoms such that the ratio of moles of phosphorus to the total moles of aluminum, alkaline earth metals, and alkali metals is from 0.5 to 15.

39. (canceled)

40. The polymer blend of claim 1, wherein the one or more polyethylene terephthalate homopolymers or copolymers have an intrinsic viscosity of at least 0.70 dL/g obtained through a melt phase polymerization.

41-45. (canceled)

46. The polymer blend of claim 1, wherein the one or more polyethylene terephthalate homopolymers or copolymers comprise:
(a) at least 92 mole percent residues of terephthalic acid, based on the total amount of dicarboxylic acid residues comprising 100 mole percent; and
(b) at least 92 mole percent residues of ethylene glycol, based on the total amount of diol residues comprising 100 mole percent; and wherein the amount of aluminum atoms in the one or more polyethylene terephthalate homopolymers or copolymers is from 5 ppm to 25 ppm, based on the weight of the one or more polyethylene terephthalate homopolymers or copolymers, and wherein phosphorus atoms are present in the one or more polyethylene terephthalate homopolymers or copolymers in an amount from 10 ppm to 70 ppm.

47. A polymer blend having oxygen-scavenging effect, comprising: one or more polyamide homopolymers or copolymers comprising at least 50 mole percent m-xylylenediamine residues, based on the total amount of amine residues comprising 100 mole percent;
one or more polyethylene terephthalate homopolymers or copolymers having an intrinsic viscosity of at least 0.65 dL/g obtained through a melt phase polymerization using a catalyst system comprising aluminum atoms in an amount from 5 ppm to 25 ppm and lithium atoms in an amount from 5 ppm to 18 ppm, in each case based on the weight of the one or more polyethylene terephthalate homopolymers or copolymers; and
one or more transition metal atoms in an amount from 25 ppm to about 500 ppm metal, based on the total weight of the polymer blend.

48. The polymer blend of claim 1, wherein the one or more polyethylene terephthalate homopolymers or copolymers comprise:
(i) at least 90 mole percent terephthalic acid residues, based on the total amount of dicarboxylic acid residues in the one or more polyethylene terephthalate homopolymers or copolymers comprising 100 mole percent;
(ii) at least 90 mole% residues of ethylene glycol, based on the total amount of diol residues in the one or more polyethylene terephthalate homopolymers or copolymers comprising 100 mole percent;
(iii) aluminum atoms in an amount from 5 ppm to 60 ppm, based on the weight of the one or more polyethylene terephthalate homopolymers or copolymers;
(iv) lithium atoms in an amount such that the molar ratio of lithium atoms to aluminum atoms is from 0.1 to 75; and
(v) phosphorus atoms in an amount such that the molar ratio of phosphorus atoms to the total moles of aluminum atoms and lithium atoms is from 0.1 to 3.

49. The polymer blend of claim 1, in the form of a bottle preform.

50. (canceled)

51. The polymer blend of claim 1, wherein the one or more polyethylene terephthalate homopolymers or copolymers comprise no more than 40 ppm antimony.

52. The polymer blend of claim 1, wherein the one or more polyethylene terephthalate homopolymers or copolymers comprise no more than 20 ppm antimony.

53. The polymer blend of claim 1, wherein antimony is absent from the one or more polyethylene terephthalate homopolymers or copolymers.
